(19) United States
(12) Patent Application Publication
(10) Pub. No.: US 2015/0212546 A1
(43) Pub. Date: Jul. 30, 2015

(54) Multiple Monitor Display Apparatus

(71) Applicant: PRANIL RAM, MAKATI CITY (PH)

(72) Inventor: PRANIL RAM, MAKATI CITY (PH)

(21) Appl. No.: 14/558,849

(22) Filed: Dec. 3, 2014

Related U.S. Application Data
(63) Continuation of application No. 13/342,345, filed on Jan. 3, 2012, now abandoned.
Application No. 13/342,345 is a continuation of application No. 12/342,265, filed on Dec. 23, 2008, now abandoned.
Application No. 12/342,265 is a continuation of application No. 11/163,457, filed on Oct. 19, 2005, now abandoned.
(60) Provisional application No. 60/635,434, filed on Dec. 14, 2004.
(60) Provisional application No. 60/619,841, filed on Oct. 19, 2004.

(51) Int. Cl. G06F 1/16

(52) U.S. Cl. CPC G06F 1/1647; G06F 1/1616; G06F 1/162

(57) ABSTRACT

A multiple monitor apparatus in the form of a laptop PC, a desktop monitor, a mobile device, and the like. In dual screen mode, the additional monitor is typically presented displaying different content and centered to the user. In single screen mode, the additional display enclosures are retracted and stored in such a manner that they do not present themselves to the user. A guiderail assembly is used to center both display enclosures relative to the user. The guiderail assembly may be motorized or manually effected and may be located above or below the primary enclosure hinge. The secondary enclosure may be extended and retracted from the primary enclosure by the use of slider arms. The secondary enclosure may also be hinged to the primary enclosure, utilize pegs, ride on its own guiderail, and detach from the primary enclosure or the apparatus. Independent guiderails may also be employed to center two or more displays relative to a user. In one embodiment, the monitor may be rotated from landscape to portrait view.

This application is a continuation of and claims priority to U.S. patent application Ser. No. 12/342,265 entitled, “Multiple Monitor Display Apparatus,” filed on Dec. 23, 2008 which claims priority to U.S. patent application Ser. No. 11/163,457 entitled, “Multiple Monitor Display Apparatus,” filed on Oct. 19, 2005 which claims priority to U.S. Provisional Patent Appl'n Ser. No. 60/635,434 entitled, “Dual screen display apparatus,” filed Dec. 14, 2004, and U.S. Provisional Patent Appl'n Ser. No. 60/619,841 entitled, “Dual screen display apparatus,” filed Oct. 19, 2004. The entire contents of which are incorporated herein by reference.

### FIELD OF THE INVENTION

This invention relates generally to electronic display apparatuses such as LCD monitors and laptop computers and more particularly to electronic display apparatuses which incorporate multiple display screens.

### BACKGROUND OF THE INVENTION

Many professionals utilize two or more computers monitors at the office. Such professionals include securities traders, architects, computer programmers, marketing or sales representatives, and the like. Similarly, professionals who utilize multiple monitors at the office may desire similar features when they travel or visit a client's premises. As the price of computer monitors such as LCD monitors fall, and new thinner display technologies such as OLEDs become technically viable, more and more professionals will see the need to work or monitor data on multiple display screens.

For some professionals, there may only be an occasional need for using multiple monitor displays, for example, during certain tasks, or during certain times of the day. However, setting up two or more monitors and storing them later after their intended use is time consuming and inconvenient. Multiple monitors require space, and use precious desktop surface area. Furthermore, multiple monitors may impede vision or increase clutter around a desk.

Thus, a need exists to provide professionals with a multiple monitor display apparatus incorporating one or more additional monitors which is convenient to use when required and yet, easily stored when not required.

### SUMMARY OF THE INVENTION

A multiple monitor display apparatus is disclosed. One aspect of the present invention according to a first preferred embodiment is the use of a guiderail assembly to center the primary and secondary enclosures relative to the user in dual screen mode. A second aspect of the present invention according to a first preferred embodiment is the use of slider arms to secure the secondary enclosure to the primary enclosure. A further aspect of the present invention according to a first preferred embodiment is to store the secondary enclosure within the primary enclosure in single screen mode.

One aspect of the present invention according to a second preferred embodiment is to rotatably attach the secondary enclosure to the primary enclosure using a hinge. A further aspect of the present invention according to a second preferred embodiment is to utilize a guiderail assembly to center the primary and secondary enclosures relative to the user in dual screen mode.

One aspect of the present invention according to a third preferred embodiment is to utilize 2 or more guiderails to effect a dual screen mode, one guiderail for each of the primary, secondary, and tertiary enclosures. A further aspect of the present invention according to a third preferred embodiment is the ability to rotate the display from a landscape view to a portrait view. A further aspect of the present invention is to present the guiderail assembly above or below the primary enclosure hinge.

One aspect of the present invention according to a fourth preferred embodiment is to use detachable primary and secondary enclosures incorporating pegs which when arranged into a dual screen mode, center the displays with respect to the user without the need for a guiderail assembly.

One aspect of the present invention according to a fifth preferred embodiment is the ability to detach the secondary enclosure from the primary enclosure. A further aspect of the present invention according to a fifth preferred embodiment is the ability to transmit a video signal and receive data from said detached secondary enclosure wirelessly.

A further aspect of the present invention is the use of a motorized mechanism to extend and retract the guiderail assembly and the secondary enclosure so the user may quickly enter and exit dual screen mode.

A further aspect of the present invention is the use of a motorized mechanism to extend and retract the guiderail assembly and the secondary enclosure into the primary enclosure so that the user may quickly enter and exit dual screen mode. A further aspect of the present invention is to allow the user to switch between single screen mode and dual screen mode in a convenient and intuitive manner.

A further aspect of the present invention is to incorporate the multiple monitor display apparatus into tablet PC apparatus, television apparatus, mobile phone apparatus, PDA/smart phone apparatus, desktop pedestal apparatus, wall mounted apparatus, and the like. A further aspect of the present invention is to permit new display technologies such as OLED technology to be utilized within the primary and secondary enclosures.

It is a further aspect of the invention that one or more of the display screens may be a touch sensitive display screen. It is a further aspect of the invention that one or more of the display screens may be of similar or different dimensions, and to utilize similar or distinct display technology (for example, e-Ink displays, or OLED displays) for each display screen.

In one embodiment, the invention provides a multiple monitor display apparatus having a secondary enclosure housed within the primary enclosure. The secondary enclosure may be exited from the primary enclosure by extending along slider arms, telescopic arms assembly, support arms, or an enclosure hinge. The two display enclosures may be moved manually or mechanically from left to right in-line via a motorized guiderail assembly that may also serve as a curved guiderail assembly that provides a natural turning for symmetrical viewing in either a single screen or double screen mode.

The additional display enclosures of the multiple monitor display apparatus may be moved from a single screen mode to a double screen mode. In display enclosures may also be oriented to landscape or portrait views by using a guiderail assembly with a rotating hinge or swivel hinge.

### BRIEF DESCRIPTION OF THE DRAWINGS

FIGS. 1-11 show a dual screen apparatus having a primary enclosure, a secondary enclosure that is stored within the primary enclosure, slider arms, and a guiderail assembly that is located below both the primary enclosure.

FIGS. 12-15 show an alternative example of a dual screen display apparatus in which the guiderail assembly is located above the primary enclosure hinge.

FIGS. 16-18 show a further alternative example of a dual screen apparatus without a guiderail assembly.

FIG. 19 shows a schematic cross sectional view of a primary enclosure and a secondary enclosure of a dual screen apparatus taken along line 19-19 of FIG. 6.

FIG. 20 shows a schematic cross sectional view of an upper slider arm, a lower slider arm and a secondary enclosure taken along line 20-20 of FIG. 7.

FIGS. 21-30 are schematic cross sectional views of further arrangements of select components within the primary and secondary enclosures.

FIGS. 31-40 are partial schematic cross sectional views of further arrangements of select components near the guiderail assembly area of the dual screen apparatus.

FIGS. 41-62 are schematic views of the hinge arrangements and their variations which are mounted to the primary and secondary enclosure of the dual screen apparatus.

FIGS. 63-64 show an example of a dual screen apparatus having a curved guiderail assembly.

FIGS. 65-66 are isometric views of a multiple monitor apparatus having three display screens.

FIGS. 67-71 illustrate the use of a telescopic arms assembly to extend or retract the secondary enclosure.

FIG. 72 shows an exploded view of the guiderail motor assembly components.

FIGS. 73-80 depict the relative positions of the guiderail motor assembly, the primary enclosure motor, and the secondary enclosure motor.

FIGS. 81-84 illustrate an example of a dual screen slate-style tablet PC apparatus with an integrated but extendable secondary display enclosure, keyboard enclosure, scanner enclosure, or solar panel enclosure all stored within the primary enclosure.

FIG. 85 shows an example of a dual screen mobile phone apparatus.

FIG. 86 shows an example of a dual screen PDA/smart phone apparatus.

FIGS. 87-88 illustrate an example of a dual screen desktop pedestal apparatus.

FIGS. 89-96 illustrate an example of a dual screen wall mounted apparatus.

FIG. 97-98 illustrate an example of a dual screen apparatus as applied to a dashboard of a vehicle.

FIGS. 98-99 illustrate an example of a dual screen apparatus having a secondary enclosure stored within the primary enclosure that may be exited without slider arms, hinge, or support arms.

FIGS. 100-109 show examples of a dual screen apparatus with a guiderail assembly and a secondary enclosure that is not enclosed by the primary enclosure, in accordance with the second preferred embodiment of the present invention.

FIGS. 110-113 illustrate an alternative example of a dual screen apparatus having two independent display enclosures connected by secondary enclosure hinge.

FIGS. 114-117 illustrate an example of a triple screen apparatus incorporating a second display enclosure with two display screens and first display enclosure with one display screen.

FIGS. 118-122 illustrate an example of a dual screen apparatus with two independent display enclosures, the secondary enclosure connected to the primary enclosure via a secondary enclosure hinge that also functions as the pivot point.

FIGS. 123-134 illustrate examples of a dual screen apparatus with two independent display enclosures and two adjacent guiderails, in accordance with the third preferred embodiment of the present invention.

FIG. 135 shows a partial isometric view showing the relationship of the enclosure swivel hinges and associated guiderail components.

FIG. 136 shows a schematic cross sectional view of a primary enclosure and a secondary enclosure of a dual screen apparatus taken along line 136-136 of FIG. 137.

FIGS. 137-139 illustrate an example of a dual screen apparatus having enclosure swivel hinges rotatably attached to enclosure slides in single screen and dual screen modes.

FIG. 140 shows a direct drive variation of the guiderail motor assembly shown in FIG. 72

FIG. 141 shows a schematic side view of a dual screen apparatus having two independent display enclosures in a closed position; the secondary enclosure mounted to a plunger style slide hinge.

FIG. 142 is a schematic side view of dual screen apparatus of FIG. 141 in an open position.

FIG. 143 shows a schematic cross sectional view of a multiple monitor apparatus with three display enclosures; a variation of the enclosure arrangement depicted in FIG. 136.

FIG. 144 shows an example of an apparatus having three display enclosures with a stationary secondary enclosure and both primary enclosure and tertiary enclosure extendable via slider arms.

FIG. 145 shows an example of a dual screen apparatus having a combination of a primary enclosure with a primary enclosure slide hinge and a secondary enclosure incorporating slider arms.

FIGS. 146-147 illustrate an example of a dual screen desktop apparatus having a pedestal and a guiderail assembly with guiderail openings and shafts.

FIGS. 148-149 illustrate an example of a dual screen wall mounted apparatus.

FIGS. 150-151 illustrate an example of a dual screen desktop apparatus.

FIGS. 152-153 illustrate an alternative example of a dual screen wall mounted apparatus and a dual screen desktop apparatus having a ball and socket joint for pivoting the display enclosures.

FIGS. 154-186 illustrate examples of a multiple monitor apparatus and a multiple monitor pedestal apparatus in which the primary enclosure and the secondary enclosure are independent of each other and may be adjusted to a single screen, dual screen, or triple screen modes using pegs, peg holes, or peg slots in accordance with the fourth embodiment of the present invention.

FIGS. 187-192 illustrate examples of a dual screen apparatus and a dual screen slate style apparatus in which the primary enclosure and the secondary enclosure are independent of each other, the secondary enclosure detachable or separated from the main unit, in accordance with the fifth preferred embodiment of the present invention.

FIGS. 193-194 illustrate partial isometric views of a dual screen apparatus showing a side mounted hinge and a top mounted hinge which permit an extended secondary enclosure to pivot toward the user.

FIG. 195 is a side view of the dual screen apparatus of FIGS. 187-188 as the detachable secondary enclosure docks to the back of the primary enclosure.

FIG. 196 is a side view of the detachable secondary enclosure of FIGS. 189-192 shown removably attached to an enclosure cradle.

FIGS. 197-202 illustrate partial top, front views of the side mounted and top mounted hinge areas shown in FIGS. 193-194 respectively.

FIGS. 203-204 are perspective views of a dual screen apparatus in a partially open and in a closed position respectively.

FIGS. 205-206 show an isometric view of an exemplary signal connection means from the base electronics housing to the secondary enclosure of the dual screen apparatus.

FIGS. 207-208 show partial schematic cross sectional views of further variations of the guiderail assembly and primary enclosure areas shown in FIGS. 31 and 37 respectively.

FIGS. 209-210 are top views of a typical dual screen apparatus showing a modified hinge area different from the hinge area shown in FIGS. 110-111 respectively.

### DETAILED DESCRIPTION OF THE INVENTION

A multiple monitor apparatus, typically in the form of a dual screen display apparatus, is disclosed along showing numerous variations in the arrangement of the apparatus components within the scope of the invention. Such an apparatus is suited for applications where dual screens or multiple display screens are preferred or occasionally required in a portable housing and that the additional display screen(s) may be readily accessed, operated, and then stored in a quick and efficient manner. Access implies opening or extending the associated display; Storing implies closing or retracting the associated display.

The dual screen display apparatus of the present invention may be described as similar to a conventional laptop computer but comprised of two display screens: a primary display screen fixedly attached to a primary enclosure and a secondary display screen fixedly attached to a secondary enclosure. The primary display screen may be used as a typical display screen while the secondary display screen may be an identical display screen or a specialized display screen. The second display screen may be used simultaneously, concurrently, and in complementary fashion with the activities of the first display screen or the second display screen may be used as a distinct, separated, or specialized separate display unit.

As will be explained hereafter, there are other examples of dual screen display apparatuses consistent with the present invention mentioned such as a dual screen slate style table PC apparatus, dual screen mobile phone apparatus, dual screen PDA/smart phone apparatus, dual screen wall mount apparatus, dual screen desktop apparatus, or simply dual screen apparatus. The terms “dual screen display apparatus” and “dual screen apparatus” are used interchangeably to refer to the present invention.

The first preferred embodiment concerns a dual screen display apparatus comprising an extendable secondary enclosure housed within the primary enclosure. The secondary enclosure may be exited beyond or outside of the primary enclosure via slider arms, support arms, hinges or telescopic arms.

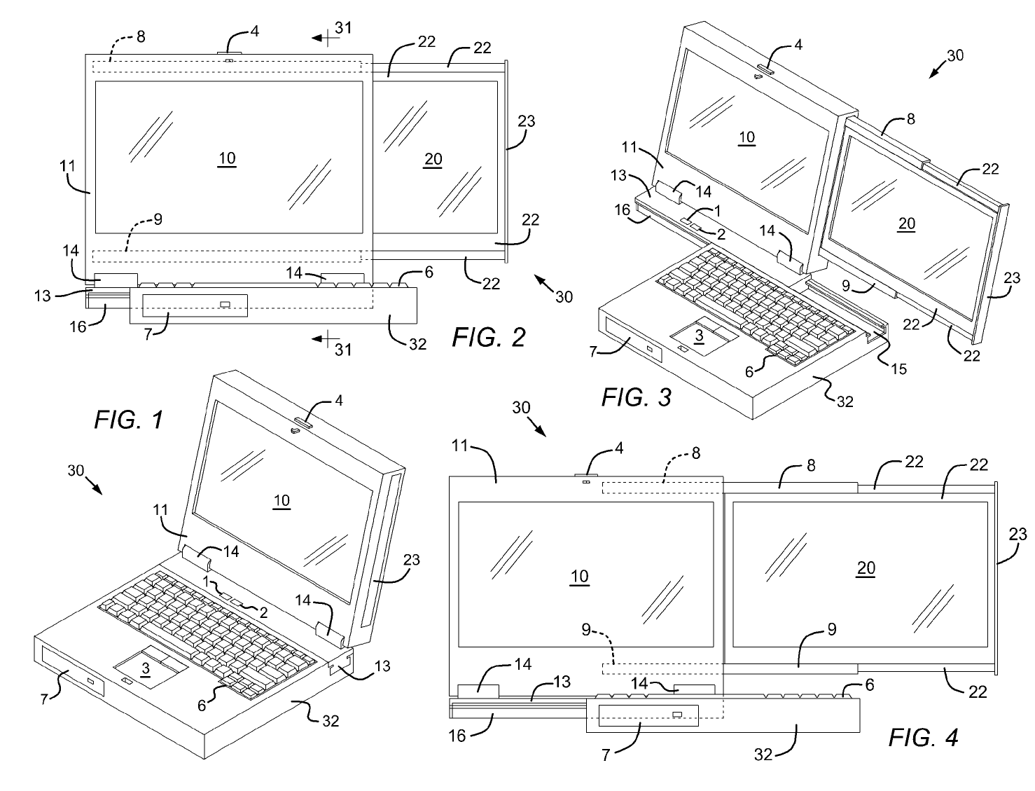

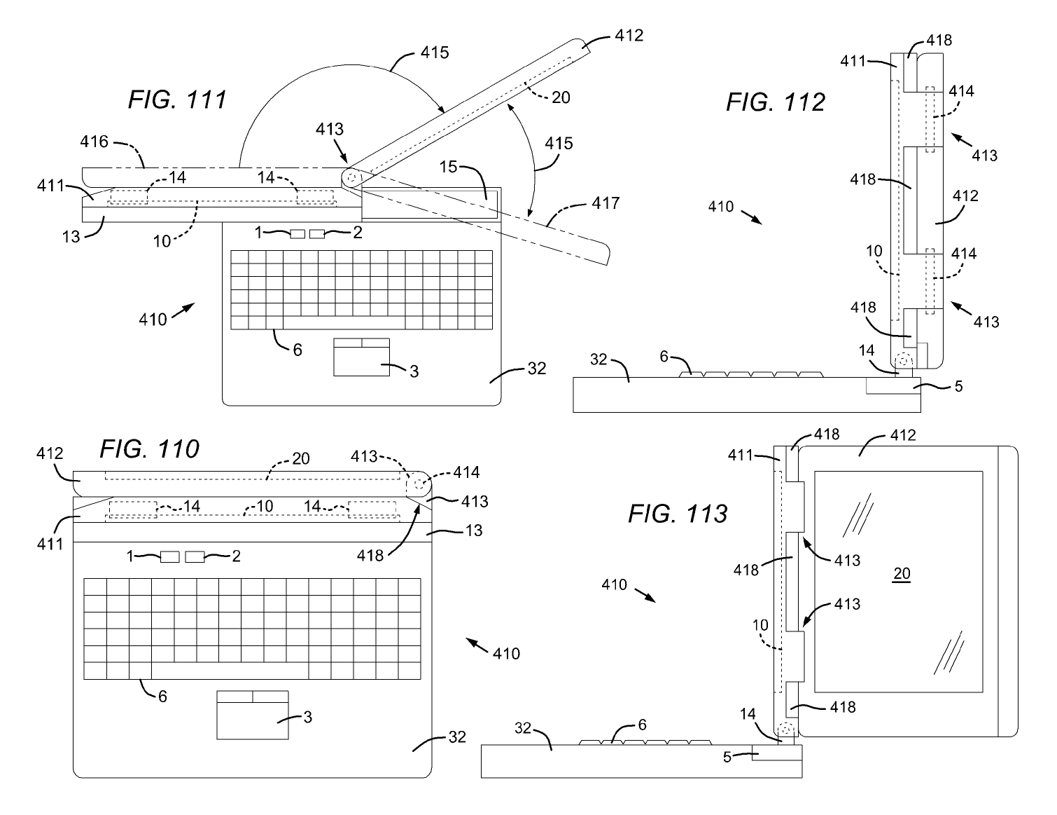

Accordingly, FIG. 1 is an isometric view of dual screen apparatus 30 incorporating guiderail assembly 5 located below primary enclosure hinge 14, single screen mode, in accordance with the first preferred embodiment of the present invention. In a single screen mode, as depicted in FIG. 1, the user generally relies on utilizing only primary display screen 10 while secondary display screen 20 (not shown) is stored within primary enclosure 11. A single screen mode also includes secondary display screen 20 facing the rear while primary display screen 10 is facing the user such as that shown in FIG. 110. When dual screen apparatus 30 is opened, primary display screen 10 is the first display screen visible to the user. It is always visible in other alternative embodiments as in the case of a display screen mounted on a wall, desktop stand, partition, or pedestal. Primary enclosure 11 is pivotally attached to guiderail assembly 5 via primary enclosure hinge 14 and is pivotable between a closed position (not shown) and an open position as shown in FIG. 1. In a closed position, primary enclosure 11 is folded in parallel proximity with base electronics housing 32 with primary display screen 10 in a face-to-face relation with keyboard 6. Primary display screen 10 may be recessed so as not to touch keyboard 6 when in a closed position. To effect a single screen mode, primary enclosure 11 is pivoted to an upright, essentially upright orientation such that it is visible to a user of the laptop computer. Primary enclosure 11 encapsulates secondary enclosure 22 as shown in FIG. 2. Primary enclosure cavity 19 located within primary enclosure 11 as shown in FIG. 6 receives secondary enclosure 22. Primary display screen 10 may function alone as a typical display screen associated with a laptop computer which may be turned on to display images, open program applications, open data file, open external and internal storage devices, among others. Shown in its first or stationary position is guiderail assembly 5 flushed with the top surface and the right (shown), left and rear sides of base electronics housing 32. Guiderail assembly 5 may either be attached to base electronics housing 32 pivotably attached to primary enclosure 11 via and below primary enclosure hinge 14 as shown in FIG. 1 or attached to the bottom of primary enclosure 11 pivotably attached to base electronics housing 32 via and above primary enclosure hinge 14 as shown in FIG. 12. In an alternative example, such as in FIG. 16, primary enclosure 11 is pivotally attached to base electronics housing 32 via primary enclosure hinge 14 without a guiderail assembly. The guiderail assembly of the present invention is a motorized or manually operated unit of the dual screen apparatus that functions to slide smoothly as it moves the primary enclosure and the secondary enclosure laterally to a convenient viewing angle relative to the user such as moving the two display enclosures to an essentially centered position for the dual screen mode. The guiderail assembly is generally elongated; alternatively, it may also be curved such as that shown in FIGS. 63-64.

As will be described hereafter, guiderail assembly 5 is typically comprised of three parts: the first part referred to as rail 15 being the stationary part typically located at the lower portion of the assembly, the second part referred to as slide 16 which is slidably received by rail 15 as it maintains continuous contact in back and forth motion when slid to effectively move display enclosures 11, 22, and the third part referred to as guiderail cover 13 which functions as protective covering for slide 16 and or rail 15. Guiderail assembly 5 may have a detent mechanism that permits slide 16 to stop discretely at certain points along rail 15. The adjacent surfaces of the rail and slide slide in a typically linear fashion with respect to each other. The remaining surfaces of the rail and slide are fixedly attached to their supporting structures. For example, rail 15 of guiderail assembly 5 is fixedly attached to the base electronics housing 32 as shown in FIG. 3. Similarly, slide 16 of guiderail assembly 5 is fixedly attached to guiderail cover 13 which is pivotably attached to primary enclosure 11 via primary enclosure hinges 14.

Guiderail assembly 5 permits centering display screens 10, 20 to effect a dual screen mode when secondary enclosure 22 is extended to an open position as shown in FIG. 3. Visible in base electronics housing 32 of dual screen apparatus 30 are keyboard 6, touchpad 3, apparatus power button 1 side by side with secondary display power button 2, and CD-RW unit 7 located on the front left side of dual screen apparatus 30. Touchpad 3, with its associated hardware and software components, functions both as a cursor-pointing device and a scroll control device. Base electronics housing 32 may also hold a processor unit, data storage devices, and other peripherals. It is generally adapted for placement on a horizontal surface such as a table or lap and may have a more robust structure than the base electronics housing of a conventional laptop computer to firmly support the two display enclosures. Shown flushed and inconspicuous with the side surface of secondary enclosure 22 is secondary enclosure cover 23 which seals the former and protects it against dirt and dust. The latching mechanism of primary enclosure 11 consists of primary enclosure latch 4 which secures primary enclosure 11 against base electronics housing 32 similar to a hook and slot latching mechanism. Many other prior art latching devices may be adapted to releasably secure primary enclosure 11 against base electronics housing 32. The dual display screen technology of the present invention may be adapted for subcompact laptop computers which ordinarily may have a single small screen generally in the 8-inch and 13-inch sizes. By utilizing a multiple monitor apparatus, larger and more texts may be displayed on each successive monitor with just a minimal weight added to the entire unit.

FIG. 2 is a front view of dual screen apparatus 30 of FIG. 1 showing secondary enclosure 22 partially extended. In a partially extended position when essentially halfway of secondary enclosure 22 is extended out of primary enclosure 11, the latter has also moved towards the left via guiderail assembly 5 and continues to move in the same direction until secondary enclosure 22 is fully extended and the two display enclosures are essentially centered such as in a dual screen mode as shown in FIG. 3. In hidden outline are slider arms 12 comprised of upper slider arm 8 and lower slider arm 9 still within primary enclosure 11. Slider arms 8, 9 need not be located at the top or bottom portions as it may be located inside or hidden in the display enclosure. Fixedly attached to secondary enclosure 22 is secondary display screen 20 which is principally intended to double the available visible content displayed on primary display screen 10. A second monitor available on demand in a mobile package will find a number of applications within various professions such as CAD/CAM, architecture, marketing, software development, medical diagnostics, engineering and scientific pursuits, monitoring applications, and the like.

The second monitor may also be used as a redundant or backup display, as a specialized display to watch multimedia or DVD movies or streaming video programming at higher resolutions such as HDTV resolutions; a screen to display more information or images; a screen to view one or more TV oriented video channels; and a screen to monitor additional channels different from primary display screen 10, for examples, weather channels or stock quotes, monitor video from a household security system, or to surf the Internet.

The open and close functions of secondary enclosure 22 may be accomplished manually by applying power to the display enclosure or via an electromechanical motor similar to how CD-ROMs and DVD disk trays are opened and closed via remote control or electrically via a switch or through software. For example, a user may press secondary display power button 2 or a remote control device (not shown) to extend secondary enclosure 22 and apply a video signal and power to the unit. Similarly, pressing the button again will cause secondary enclosure 22 to retract inside primary enclosure 11. Alternatively, linear actuators provide a powerful but safe opening and closing of secondary enclosure 22. A linear guide system with low friction, smooth movement, and low noise provides fast and precise transportation of secondary enclosure 22 when it is extended. The linear guide system may be made tailor fit to any specific size and weight. The sliding actuator may be a motor using a belt drive to pull and push secondary enclosure 22; a motor solenoid to push or pull secondary enclosure 22; secondary enclosure 22 with pulleys to add leverage or movement distance; or actuators using gears, rods, rods with worm gear markings, slider assemblies; and slider assemblies with linear gear markings in one direction. Another alternative for opening and closing secondary enclosure 22 is through software controls accessible via a mouse cursor operating on a software interface displayed on the screen or keyboard. Connecting power or signals to one or more display screens may be carried through via wired or wireless connection to base electronics housing 32 which permits the display enclosures to receive and transmit signals such as the video display data and indicator, sensor, control, and diagnostic signals. Alternatively, optical or radio frequency means may connect any detached display assembly. Wireless connection may also provide and receive data from any of the display enclosures or display screens which may have a remote control device.

FIG. 3 is an isometric view of dual screen apparatus 30 as display enclosures 11, 22 are essentially centered in a dual screen mode. Guiderail assembly 5 permits primary enclosure 11 and secondary enclosure 22 to be essentially centered relative to base electronics housing 32 and symmetrical about the user. In a dual screen mode, primary display screen 10 may be used in combination with secondary display screen 20 such as for example, when a user opens a Microsoft Word program in primary display screen 10 and a Microsoft Excel program in secondary display screen 20 simultaneously. The two display screens may also be used as one large display screen such as when a user prefers to view an image on a large scale or for group presentation purpose. The user may also prefer to store secondary enclosure 22 into primary enclosure 11 and have an off centered primary display screen 10 in order to have an unobstructed view of the areas on the user's right side. This is done in instances where an activity is being monitored such as in factories or assembly lines simultaneous with using the laptop computer. In a dual screen mode, as depicted in FIG. 3, the user utilizes an additional screen available, such as when secondary enclosure 22 is fully extended and along with primary enclosure 11 are moved to an essentially centered orientation facing the user via guiderail assembly 5. The two display screens may be moved off center towards the right or left still in a dual screen mode when the user wants to monitor an activity at his side such as in an assembly line or factory. In an alternative example of the present invention, a dual screen mode also includes three display screens operating simultaneously but only two displays screens are facing the user. For example, a triple screen apparatus may still have a dual screen mode when the primary display screen and secondary display screen face the user and a tertiary display screen faces the rear such as that shown in FIG. 115.

The present invention also encompasses a triple screen mode in which three display screens face the user and other multi-screen modes in which multiple combinations of display screens, for example 20 display screens, are operating simultaneously. When secondary enclosure 22 is extended as in FIG. 3, upper slider arm 8 and lower slider arm 9 have essentially exited halfway of primary enclosure 11. The slider arms prevent secondary enclosure 22 from falling off. Secondary enclosure 22 and/or guiderail assembly 5 may have a motorized mechanism for extending and closing secondary enclosure 22 and for moving guiderail assembly 5. The motorized mechanism may be activated automatically upon opening primary enclosure 11 or the laptop computer, or manually by a press of a button or software interface by clicking or by remote control. Movement of guiderail assembly 5 may be done through direct contact of the slide with the rail. The rotational force applied to the rubber coated plastic wheel and the friction and grip of the rubber on the slide permit it to move in the direction of the rotation until it reaches its stop position. Alternatively, a toothed spur gear assembly may be applied to move the slide along the rail. The movement mechanism for guiderail assembly 5 may be similar to the portage mechanism of the typewriter carriage. In the case of guiderail assembly 5, the ribbon and cable mechanism is attached underneath the assembly and allows signals, power, and information to transfer to the display enclosure or data from the display enclosure such as when display is a touch screen. A flexile plastic rod as a pull and push device may also be used to slide guiderail assembly 5 from right to left to properly center display enclosures 11, 22 relative to base electronics housing 32. A similar plastic push and pull rod may be adapted to fully extend or close secondary enclosure 22. The flexile plastic rod may need to ride along a slotted guide to keep the rod from flexing or buckling while it is pushing secondary enclosure 22 or the guiderail assembly which may be located either above or below the primary enclosure hinge. Motors, actuators, and solenoids may be applied to effectuate a push and/or pull operation on all moving assemblies in dual screen apparatus 30. Supplying a suitable tension or torque to the guiderail assembly mechanism may be accomplished via springs, pulleys, and gear trains. Grease application or anti-friction devices such as ball bearings, plastic sleeves, polymer strips, dry lubricants or Teflon may be used to reduce friction and ensure fast, quiet and smooth movement during opening and closing of secondary enclosure 22 and sliding of guiderail assembly 5. Apparatus power button 1 and secondary display power button 2 located at the left portion of guiderail assembly 5, may be alternatively located on base electronics housing 32 such as adjacent to touchpad 3.

FIG. 4 is a front view of dual screen apparatus 30 of FIG. 3. Essentially half of upper slider arm 8 and lower slider arm 9 are slidably positioned to secondary enclosure 22 and the other half inside primary enclosure 11 (shown in hidden outline) as they prevent secondary enclosure 22 from falling off. Also shown in hidden outline is the portion of slide 16 resting on rail 15 (not shown) of guiderail assembly 5.

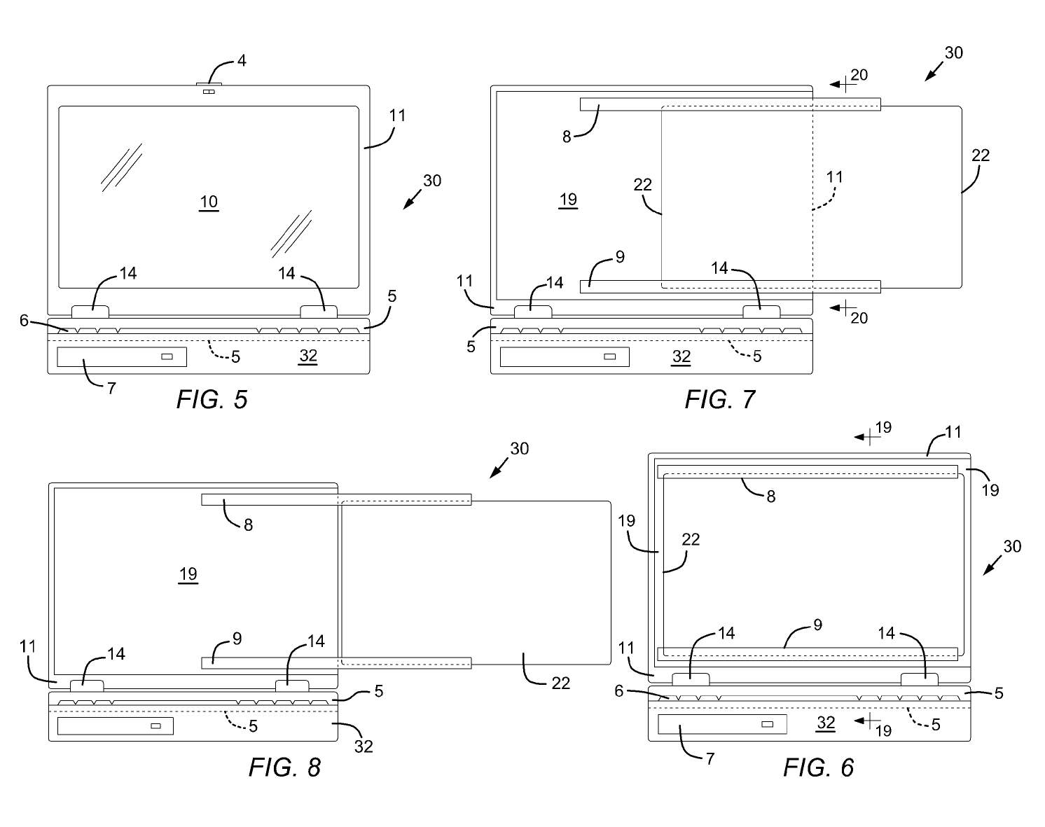

FIGS. 5-9 illustrate a schematic front view progression of secondary enclosure 22 as it is moved from a closed (stored) position within primary enclosure 11, to a partially open (partially extended) position, to an open (extended) position, then to an essentially centered position of display enclosures 11, 22 with respect to base electronics housing 32. In the schematic representations of FIGS. 5-11, guiderail assembly 5 is raised to show clearly the details associated with primary enclosure 11 and secondary enclosure 22. Guiderail assembly 5 is normally flushed with the top surface of base electronics housing 32.

Accordingly, FIG. 5 is a schematic front view of dual screen apparatus 30 of FIG. 1. In a single screen mode, such as in FIG. 5, primary display screen 10 is functional and faces the user while secondary enclosure 22 which contains secondary display screen 20 is in its closed position within primary enclosure 11. The hidden outline represents guiderail assembly 5 of dual screen apparatus 30, which for the purpose of illustration, is elevated. Display screens 10, 20 have been removed in FIGS. 6-11 in the schematic representation to depict the mechanism of secondary enclosure 22 as it resides inside primary enclosure 11 and as it is extended via slider arms 8, 9. FIGS. 5-11 as shown, depict guiderail cover 13, rail 15, and slide 16 as one mechanism of guiderail assembly 5.

FIG. 6 is a schematic front view of dual screen apparatus 30 of FIG. 5 showing the positions of slider arms 12 and secondary enclosure 22 within primary enclosure 11. Slider arms 12 is comprised of upper slider arm 8 and lower slider arm 9 represented in hidden outline resting on upper edge and lower edge of secondary enclosure 22 respectively within primary enclosure 11. Primary enclosure cavity 19 receives secondary enclosure 22 in the latter's stored or closed position. Secondary enclosure 22 and movable slider arms 8, 9 are not visible when secondary enclosure 22 is in a closed position or inside primary enclosure 11. Essentially, portions of slider arms 8, 9 are visible when secondary enclosure 22 is extended as in FIG. 7. Slider arms 8, 9 also function as a detent mechanism that prevents secondary enclosure 22 from falling off. The entire portion of secondary enclosure 22 may be extended as slider arms 8, 9 prevent secondary enclosure 22 from falling off. Also shown in FIG. 6 is secondary enclosure 22 received by primary enclosure cavity 19 within primary enclosure 11.

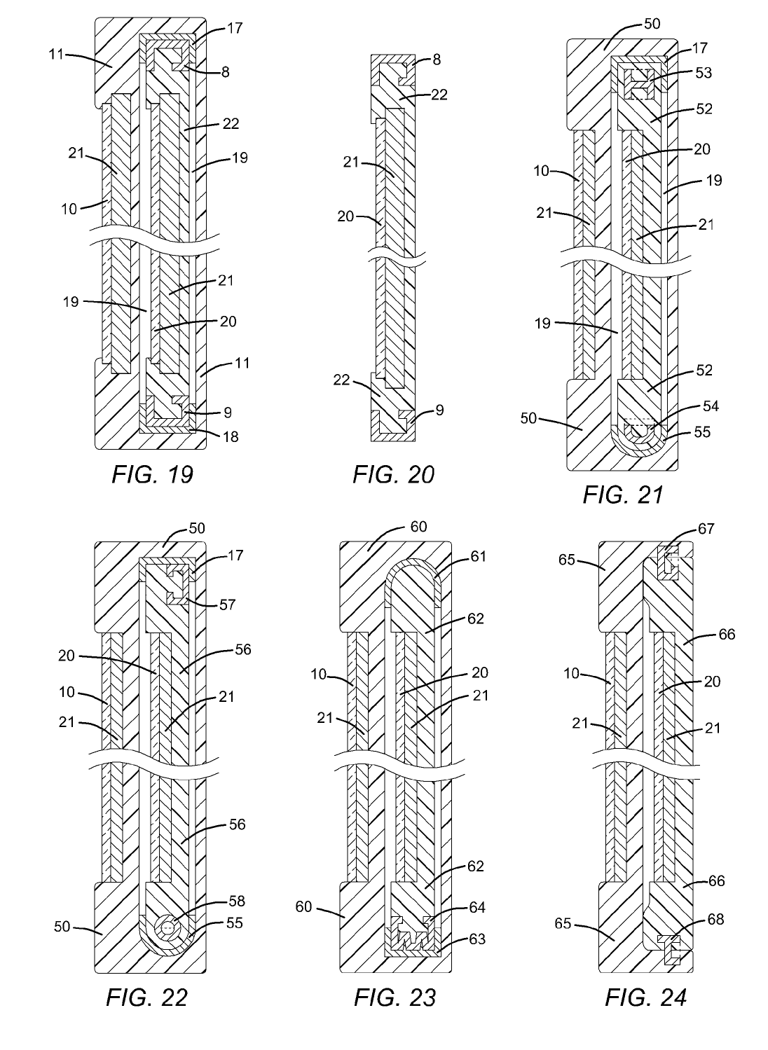

FIG. 7 is a schematic front view of dual screen apparatus 30 of FIG. 2. Portions of slider arms 8, 9 are visible when secondary enclosure 22 is partially extended. Slider arms 8, 9 permit the entire area of secondary enclosure 22 to be out of primary enclosure 11 as shown in FIG. 8 and prevent it from falling off. Slider arms 8, 9 operate independently from primary enclosure 11 and secondary enclosure 22 such that in a partially extended position of secondary enclosure 22 as shown in FIG. 7, slider arms 8, 9 may be slid back inside primary enclosure 11. Slider arms 8, 9 may be slidably positioned with their respective upper friction sleeve 17 and lower friction sleeve 18 (both not shown) attached along primary enclosure 11 and secondary enclosure 22 as depicted in the cross sectional view in FIG. 19. The outline or shape of upper slider arm may be the same or different from that of lower slider arm as illustrated in the various examples in FIGS. 21-30. The slider arms may be made of plastic and formed, cut, or preferably molded. A slider arm made of plastic may generate lower noise, be self-lubricating, have reduced weight and inertia, and have increased drive efficiency. In a partially extended position of secondary enclosure 22, as shown in FIG. 7, primary enclosure 11 remains stationary.

FIG. 8 is a schematic front view of dual screen apparatus 30 showing secondary enclosure 22 extended and primary enclosure 11 stationary in a dual screen mode. From the partially extended position in FIG. 7, secondary enclosure 22 is fully extended and functional with slider arms 8, 9 essentially midway out of secondary enclosure 22. As explained earlier, when secondary enclosure 22 is fully extended, the two display screens may operate as one in a dual screen mode. The separating edge between primary enclosure 11 and secondary enclosure 22 may have a minimal pixel to pixel gap such as 3-10 mm, thus, permitting the two display screens to function as one. In a dual screen mode when secondary enclosure 22 is fully extended, as shown in FIG. 8, primary enclosure 11 remains stationary.

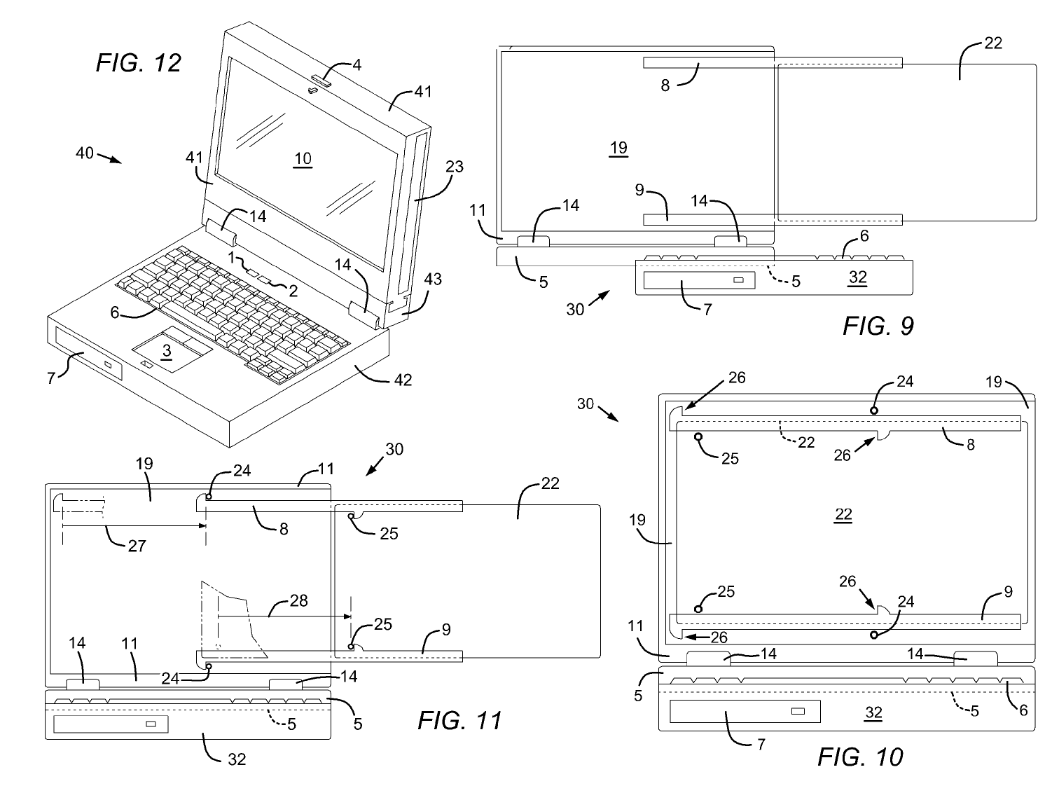

FIG. 9 is a schematic front view of dual screen apparatus 30 of FIGS. 3-4. From the original position in FIG. 8 where it is stationary, primary enclosure 11 is moved towards the left by guiderail assembly 5 to arrange display enclosures 11, 22 to an essentially centered position relative to base electronics housing 32. In a dual screen mode, primary display screens 10, 20 may be used as one display screen or both may be used separately at the same time.

FIG. 10 is a schematic front view of dual screen apparatus 30 showing details of enclosure stop pins 24, 25 and slider arm stop 26. Slider arms 8, 9 are shown flanked by primary enclosure stop pins 24 and secondary enclosure stop pins 25 positioned in a way that slider arm stop 26 catches enclosure stop pins 24, 25 as secondary enclosure 22 exits primary enclosure 11. For purpose of illustration, enclosure stop pins 24, 25 and slider arm stop 26 are not shown in other examples of slider arms.

FIG. 11 is a schematic front view of dual screen apparatus 30 showing how slider arms 8, 9 and secondary enclosure 22 are prevented from falling off the unit. Slider arms 8, 9 are precisely positioned so as to catch primary enclosure stop pins 24 and secondary enclosure stop pins 25 respectively when secondary enclosure 22 is exited from primary enclosure 11. As slider arm stop 26 catches primary enclosure stop pins 24 it stops the motion of slider arms 8, 9 to prevent them from falling off the unit. Slider arm stop 26 also catches secondary enclosure stop pins 25 to prevent secondary enclosure 22 from being detached from the unit. Partial phantom line representation of upper slider arm 8 and lower partial phantom line representation of secondary enclosure 22 are shown associated with movement arrows 27, 28 respectively. Movement arrow 27 indicates movement of slider arms 8, 9 from a stored position in FIG. 10 to an extended position as in FIG. 11. Movement arrow 28 indicates movement of secondary enclosure 22 with respect to lower slider arm 9 as it is moved from its stored position in FIG. 10 to its extended position as shown in FIG. 11.

FIG. 12 is an isometric view of dual screen apparatus 40 incorporating guiderail assembly 35 attached at bottom of primary enclosure 41 and above primary enclosure hinge 14. Guiderail assembly 35 of FIG. 12 is comprised of guiderail cover 43 which protects the former from dust and dirt, rail 45 or the stationary portion, and slide 46 which is slidably positioned along rail 45. Guiderail assembly 35 is distinguished from guiderail assembly 5 of FIG. 1 by its location which is at bottom of primary enclosure 41 and above primary enclosure hinge 14. Guiderail assembly 35 is functionally similar to guiderail assembly 5 as described in FIG. 1 in respect to rail portion which are both stationary and slide portion which are both attached to the lower portion of primary enclosure 41.

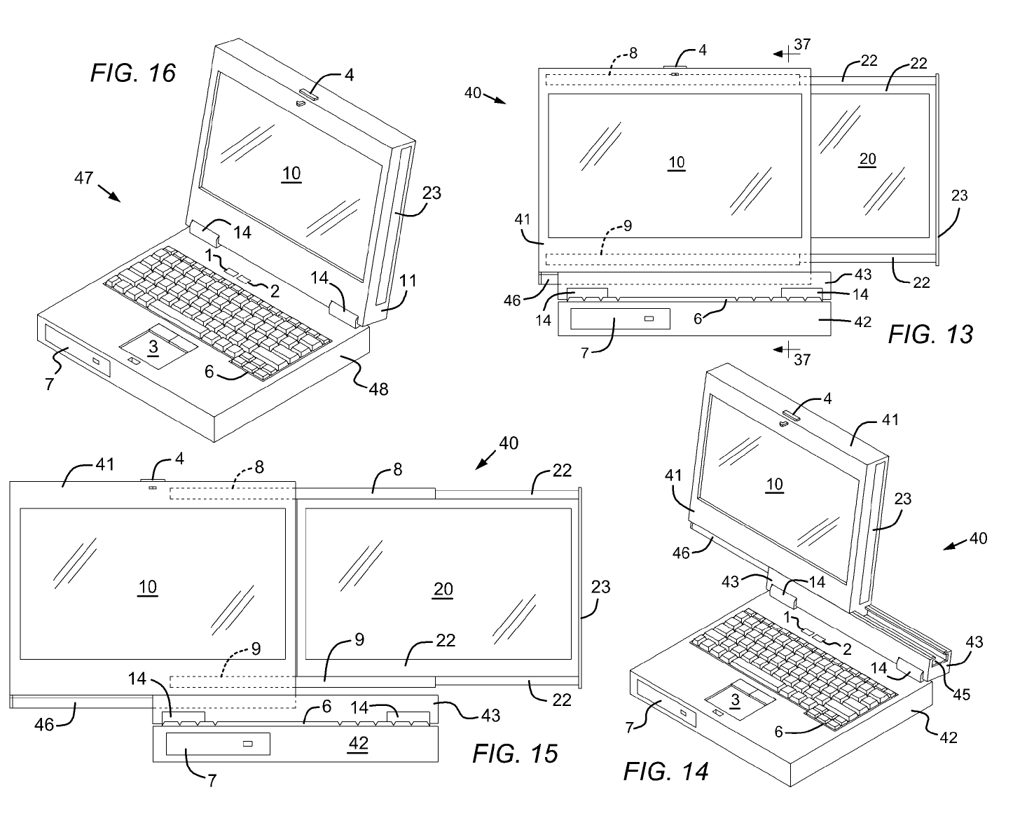

FIG. 13 is a front view of dual screen apparatus 40 of FIG. 12 as secondary enclosure 22 is partially extended and primary enclosure 41 is moved towards the left. When secondary enclosure 22 is partially extended, such as that shown in FIG. 13, slider arms 8, 9 are still within primary enclosure 41 as depicted in hidden outline. Primary enclosure 41 has started to move towards the left by the action of slide 46 to essentially center display enclosures 41, 22 in preparation for the dual screen mode as shown in FIG. 15. The hidden lines above primary enclosure hinge 14 indicate the termination of rail 45 and slide 46.

FIG. 14 is an isometric view of dual screen apparatus 40 of FIG. 12 as primary enclosure 41 is shifted to the left in preparation for secondary enclosure 22 being extended. Primary enclosure 41 is essentially centered with respect to the left side of base electronics housing 42 as secondary enclosure 22 is still within primary enclosure 41. In the single screen mode, as in FIG. 14, primary display screen 10 may be powered on to allow the user to have an unobstructed view of the right portion areas such as when the user is monitoring an activity in a factory or an assembly line.

FIG. 15 is a front view of dual screen apparatus 40 in a dual screen mode as display enclosures 41, 22 are essentially centered. Essentially half of slider arms 8, 9 is out of primary enclosure 41 while the remaining portions are shown in hidden outline. Slide 46 of guiderail assembly 35 is also shown essentially halfway out of base electronics housing 42 as primary enclosure 41 and secondary enclosure 22 are essentially centered relative to base electronics housing 42. In the dual screen mode, such as in FIG. 15, the two display screens may be used as one display screen or two discrete display screens at the same time.

FIGS. 16-18 illustrate an example of a dual screen apparatus without a guiderail assembly showing progression of secondary enclosure 22 as it is moved from a closed (stored) position, to a partially open (partially extended) position, then to an open (extended) position. Primary enclosure 11 of dual screen apparatus 47 is stationary unlike the primary enclosure shown in FIGS. 1-15 that may be moved laterally.

Accordingly, FIG. 16 is an isometric view of dual screen apparatus 47 without a guiderail assembly in single screen mode. Primary enclosure 11 of dual screen apparatus 47 is shown rotatably attached to base electronics housing 48 via primary enclosure hinge 14. Front view of dual screen apparatus 47 resembles a conventional laptop computer but with two display screens fixedly attached to their respective display enclosures as shown in FIG. 18. As in the earlier examples, dual screen apparatus 47 is generally used in the same manner as any two LCD panels adjacent to each other is used such as, for example, in the financial market where two or more display screens or monitors are arranged side by side to monitor stock market activities. In FIG. 16, primary display screen 10 is prominently visible while secondary display screen 20 is hidden. In a single screen mode of dual screen apparatus 47, primary display screen 10 may be used as a typical display screen associated with a laptop computer.

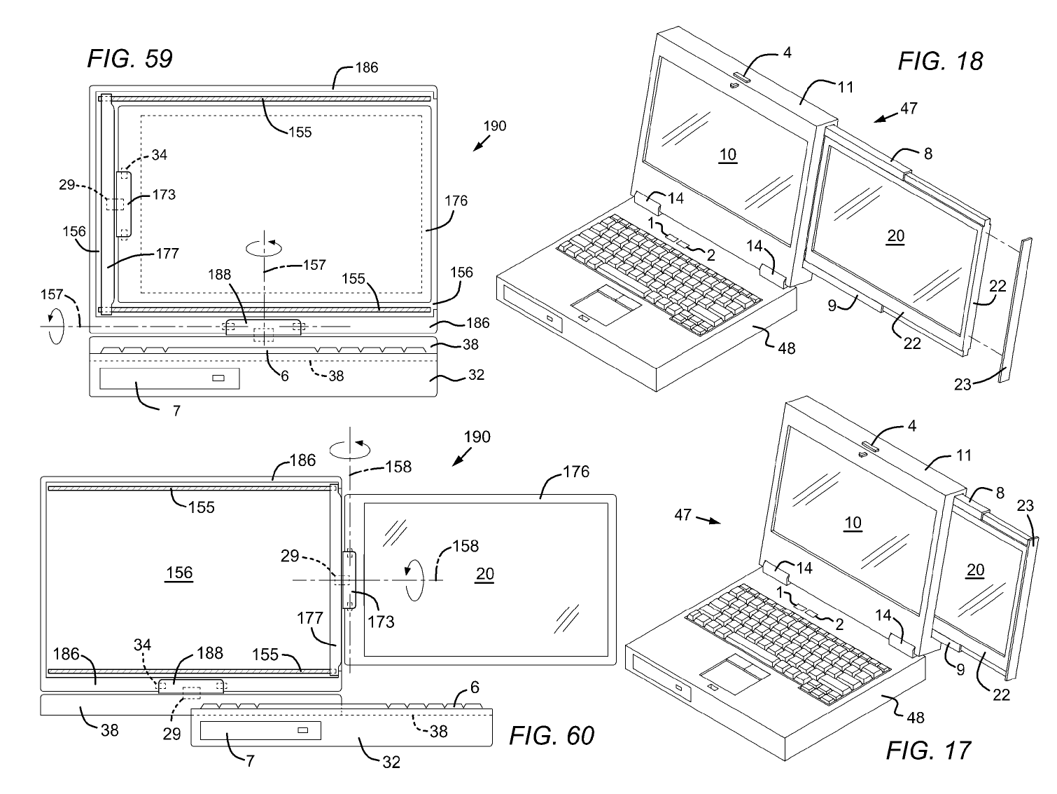

FIG. 17 is an isometric view of dual screen apparatus 47 with secondary enclosure 22 in a partially open (partially extended) position. Secondary enclosure 22 is shown partially extended in its partially open position as portions of slider arms 8, 9 have exited primary enclosure 11. The movement mechanism for opening secondary enclosure 22 of dual screen apparatus 47 is similar to that described in FIG. 1.

FIG. 18 is an isometric view of dual screen apparatus 47 as secondary enclosure 22 is extended and primary enclosure 11 is stationary in a dual screen mode. In a dual screen mode, such as in FIG. 18, secondary enclosure 22 is extended so that the two display screens may be used as one display screen or two discrete display screens at the same time. Secondary enclosure cover 23 is projected out as separated from secondary enclosure 22 to show the shape of the latter. Secondary enclosure cover 23 hides secondary enclosure 22 as it is flushed to its side surface when in a closed position as in FIG. 16.

FIGS. 19-30 are schematic cross sectional views of alternative designs of the primary enclosure, secondary enclosure, slider arms, hinges, and friction sleeves located either at the upper or lower portion or both display enclosures. The examples may be adapted to strengthen the durability and reliability of the dual screen apparatus or to adjust the design for manufacturing or cost considerations.

FIG. 19 is a schematic cross sectional view of primary enclosure 11 and secondary enclosure 22 taken along lines 19-19 of FIG. 6. Secondary enclosure 22 is shown within primary enclosure cavity 19 of primary enclosure 11. Also shown is associated display electronics 21 attached to the respective primary display screen 10 and secondary display screen 20.

FIG. 20 is a schematic cross sectional view of upper slider arm 8, lower slider arm 9 and secondary enclosure 22 taken along lines 20-20 of FIG. 7. Slider arms 8, 9 are depicted holding secondary enclosure 22 as the latter is partially extended out of primary enclosure 11 (as shown in FIG. 7).

FIG. 21 depicts an example in which the design of the slider arm affects the design of the secondary enclosure and the friction sleeve. As upper slider arm 53 is shown shaped like an H and lower slider arm 54 is shaped like a C, the top portion of secondary enclosure 56 and upper friction sleeve 17 may have a straight edge while the bottom portion and lower friction sleeve 55 may have a semi-circular shape.

FIG. 22 points to both aesthetic and structural concerns in which lower slider arm 58 is hidden and thus, may lessen wear and tear since the user cannot snag or tear the slider arms.

FIG. 23 is an example of how lower friction sleeve 63 follows the shape of lower slider arm 64 indicating that the sleeve may be molded.

FIG. 24 is an example of secondary enclosure 66 not enclosed within primary enclosure 65 but is connected by upper slider arm 67 and lower slider arm 68. Primary enclosure 65 protects secondary display screen 20 even if it does not enclose secondary enclosure 66. There is no need for the friction sleeve as secondary enclosure 66 is not enclosed.

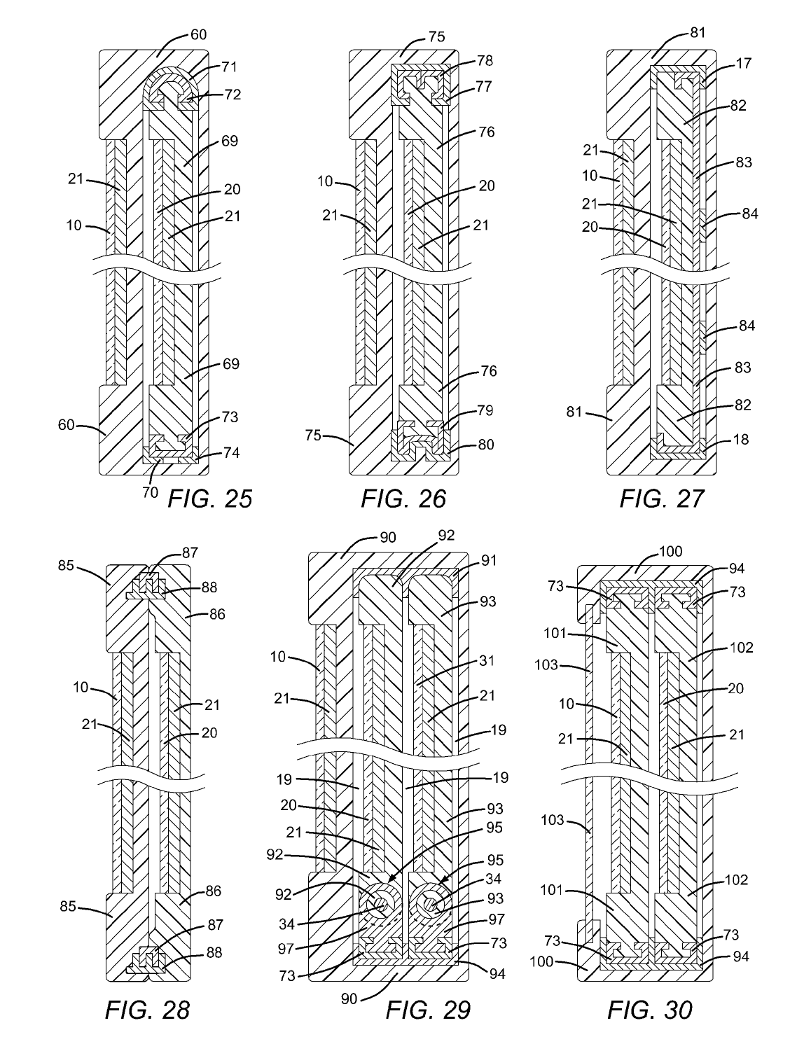

FIG. 25 shows an example different shapes for the slider arm and friction sleeve for top and bottom portions. Shown are two L shaped lower friction sleeves 70, 74, an open rectangular shape for lower slider arm 73 and a semi-circular shapes for upper friction sleeve 71, upper slider arm 72. The shapes of both upper slider arm 72 and upper friction sleeve 71 are different from their corresponding lower parts.

FIG. 26 shows an example in which W shaped slider arms 78, 79 are the ones holding on to friction sleeves 77, 80.

FIG. 27 is an alternative example of an elongated slider support 83 to extend secondary enclosure 82. Slider support 83 may be a metal sheet since it is elongated. Friction insert 84 prevents slider support 83 from sliding or rubbing the back of secondary enclosure 82. Friction insert 84 functions similarly to a friction sleeve such as in reducing noise, wear and tear of the slider, and ensuring that secondary enclosure 82 may be extended from primary enclosure 81 smoothly without a jerk. Slider support 83 is an alternative for the upper and lower slider arms. FIG. 28 is an example of same slider arms 87 and friction sleeves 88 for top and bottom of two independent display enclosures. Primary display screen 10 of primary enclosure 85 is visible to the user. Secondary enclosure 86 is secured to primary enclosure 85 via slider arms 87 but is not enclosed by the latter similar to that shown in FIG. 24. Display enclosures 85, 86 may be moved left or right to effect a dual screen mode.

FIG. 29 depicts three display enclosures with three displays screens and with only lower slider arm 73 to extend secondary enclosure 92 and tertiary enclosure 93. Primary enclosure 90 encapsulates secondary enclosure 92 and tertiary enclosure 93 in a single screen mode in which primary display screen 10 faces the user. Display enclosures 92, 93 may be extended via lower slider arms 73 for the dual screen or triple screen mode. Upper friction sleeve 91 and lower friction sleeve 94 ensure smooth opening and closing of display enclosures 92, 93 and slider arm 73 respectively.

FIG. 30 shows an example primary enclosure 101 and secondary enclosure 102 housed within display enclosure 100 and protective screen 103. Protective screen 103 may be made of polycarbonate plastic, transparent glass, steel, opaque, or fiberglass. In the case of transparent glass, the user may right away see what is displayed on the monitor which may be as an important announcement or instructions. The main function of protective screen 103 is to protect primary display screen 10 such as in an industrial setting where the display screen is exposed and frequently used. Display enclosures 101, 102 may be extended out of display enclosure 100 via upper and lower slider arms 73 similar to that shown in FIG. 29.

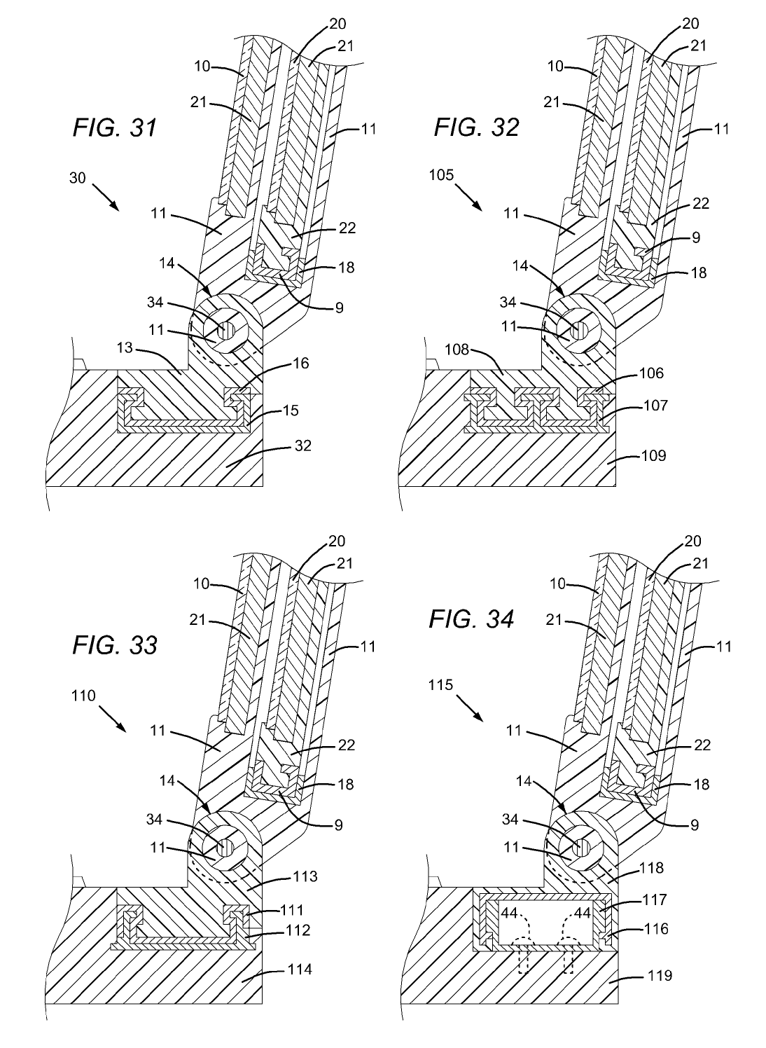

FIGS. 31-40 are schematic cross sectional views of alternative arrangements and designs of the guiderail cover, slide, and rail components of the guiderail assembly. Each variation may be used address design or manufacturing considerations such as cost or mechanism weight or to improve the durability and reliability of the components of the guiderail assembly. It should be apparent that further alternative arrangements of the components or mechanisms shown in FIGS. 19-40, 212, and 213 are possible.

FIG. 31 is a partial schematic cross sectional view of primary enclosure 11 and base electronics housing 32 taken along lines 31-31 of FIG. 2 showing the position of guiderail assembly 5. Guiderail assembly 5 is shown flushed with the surface of base electronics housing 32 and pivotably attached to primary enclosure 11 via primary enclosure hinge 14. Primary enclosure hinges 14 are fixedly attached to guiderail cover 13. The bottom edge of primary enclosure 11 may alternatively be shaped like a square as shown in FIGS. 1-4. In FIG. 2, secondary enclosure 22 is partially extended and slide 16 of guiderail assembly 5 is also partially moved towards the left along with primary enclosure 11 in preparation for the dual screen mode.

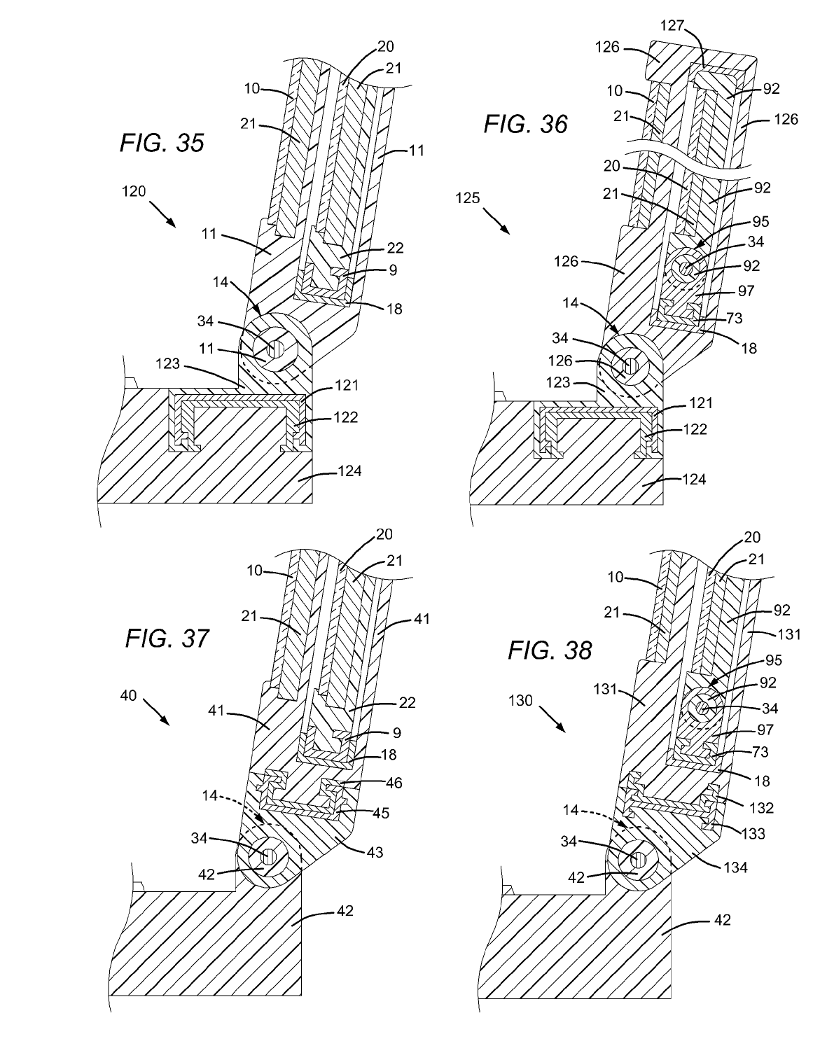

FIGS. 32-34 are alternative examples of the slide, rail, and guiderail cover of the guiderail assembly shown in FIG. 31. FIG. 32 shows an example inverted T shape of slide 106 and rail 107. The shape design of slide 106 and rail 107 essentially provides a strong hold which may also function to emit optical lasers for transferring data to the display screens above or may provide power for the display screens. FIG. 33 is an example rail 112 that is matched or fitted to slide 111. FIG. 34 is an alternative example of the slide and rail design shown in FIG. 33 in an inverted position. Slide 116 covers rail 117 with the latter screw fixed to base electronics housing 119 via guiderail fastener 44. In between the top and bottom portions of slide 116 and rail 117 is a space which may be reserved for electronics. This set-up provides a lighter weight for base electronics housing 119. FIG. 35 is an alternative example of the slide and rail design shown in FIG. 34. The space between the slide and the rail in FIG. 34 is consumed by base electronics housing 124 making guiderail cover 123 slimmer. Slide 121 also covers rail 122. FIG. 36 is an alternative example of the slide and rail design similar to that shown in FIG. 35. Unlike in FIG. 35, a hinged secondary enclosure 92 is shown stored within primary enclosure 126.

FIGS. 37-40 are partial schematic cross sectional views of a guiderail assembly attached to the bottom of the primary enclosure and pivotably attached to the base electronics housing via and above the primary enclosure hinge. Accordingly, FIG. 37 is a partial schematic cross sectional view of primary enclosure 41 and base electronics housing 42 taken along lines 37-37 of FIG. 13. In FIG. 37, slide 46 is shown slidably received by rail 45 on top of primary enclosure hinge 14.

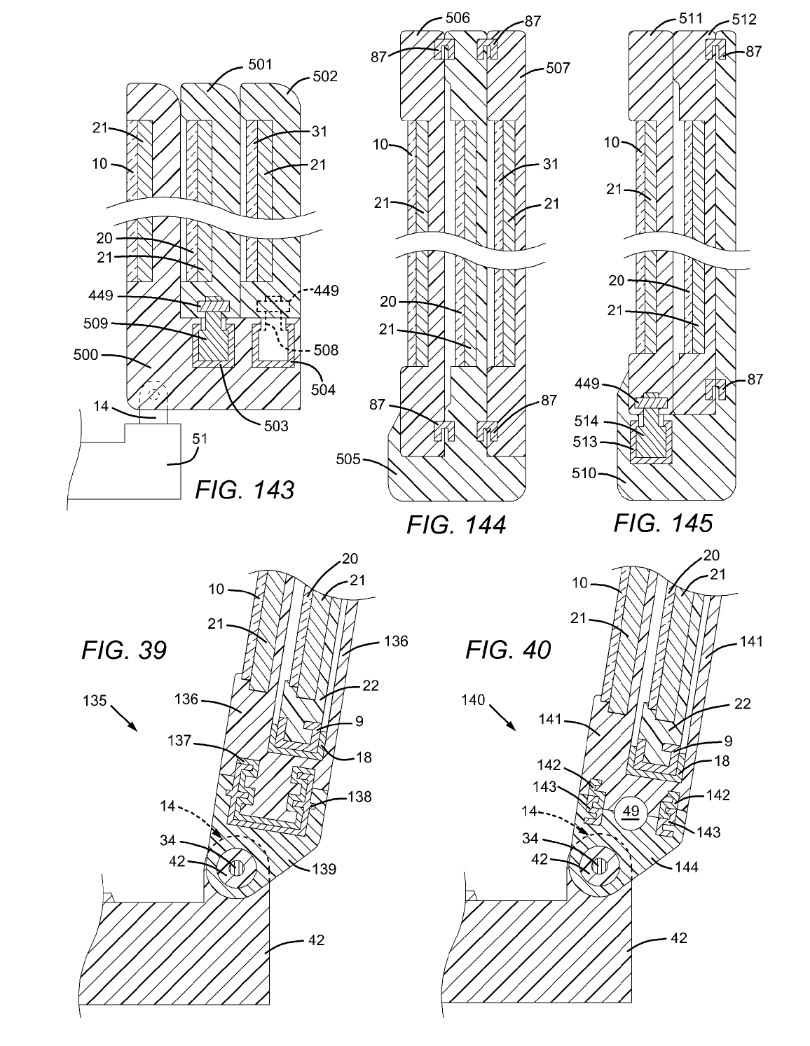

FIG. 38 is an alternative example of the slide and rail design shown in FIG. 37. Rail 133 and slide 132 are shaped like an S and T respectively and slidably attached to each other's surfaces. FIG. 39 is an example how the upper parts of slide 137 and rail 138 are designed in such a manner that the two parts lock. FIG. 40 is an example two slides 142 and two rails 143 located on opposite sides. The cylindrical cavity formed by cable conduit 49 is used to transfer information to primary enclosure 141 and secondary enclosure 22.

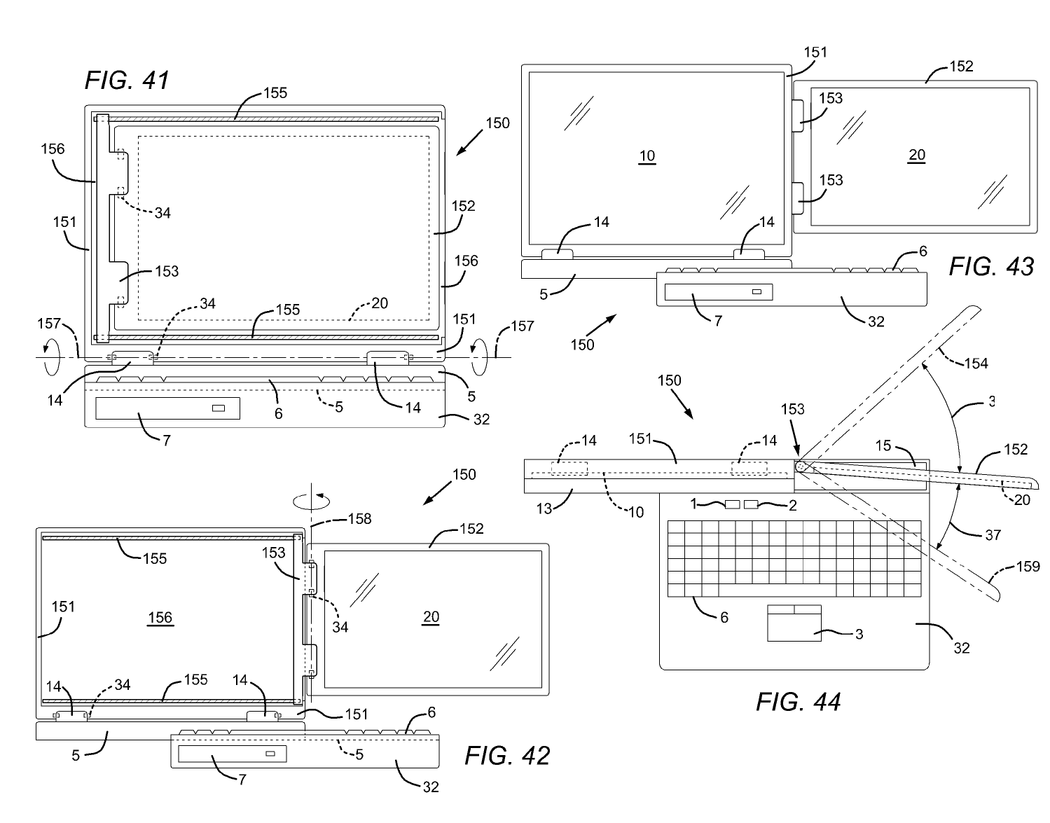

FIGS. 41-62 are examples of the single hinge, double hinge, and swivel hinge designs or a combination thereof as applied to the primary enclosure and the secondary enclosure. The hinge designs may be used to attach the primary enclosure to the base electronics housing or to hold the secondary enclosure and prevent it from being detached from the unit as it is exited from the primary enclosure. The hinge designs may also be used to rotate the two display enclosures for adjusting the display screens for fine contrast and legibility such as in the single screen mode or dual screen mode. The secondary enclosure is still housed within the primary enclosure, in accordance with the first preferred embodiment of the present invention. FIGS. 41-62 are all schematic representations that depict a guiderail assembly below the primary enclosure hinge. A guiderail assembly may also be mounted above the primary enclosure hinge as depicted in FIGS. 12-15. The different hinge designs described in FIGS. 41-61 may also be used to replace the slider arms in extending the secondary enclosure from the primary enclosure. In FIGS. 41-62 the design of the base electronics housing is constant, only the design of the primary enclosure and the secondary enclosure changes. This enables a consumer to choose from among different display screen designs, each of a specific screen size and resolution and the manner the display enclosures are packaged, be they with hinges or guiderail mechanisms. Manufacturers of the dual screen apparatus allow differences in display screen designs, screen resolutions, and screen technology which may be retrofitted to a conventional laptop.

Accordingly, FIG. 41 is a schematic front view of dual screen apparatus 150 incorporating a double hinge design for both primary enclosure 151 and secondary enclosure 152. Secondary enclosure hinge assembly 153 connects to secondary enclosure 152 via hinge pin 34 which also serves as a route for the display cable to pass, while primary enclosure 11 is attached to base electronics housing 32 via primary enclosure hinge 14. In the stored position, secondary enclosure hinge assembly 153 is slidably positioned at the end of supporting rod 155. Primary enclosure cavity 156 receives secondary enclosure 152 in its closed or stored position. In a single screen mode of dual screen apparatus 150, such as in FIG. 41, primary enclosure 151 may be rotated in the direction of primary enclosure hinge rotation axis 157 to adjust the angle of primary display screen 10 (not shown) for contrast and fine viewing. Secondary enclosure hinge assembly 153 and primary enclosure hinge 14 are double hinge designs. In the schematic representation, primary display screen 10 has been removed to show the double hinge set-up of secondary enclosure 152 and the two supporting rods 155 which slidably receive secondary enclosure hinge assembly 153 when secondary enclosure 152 is extended or withdrawn. Shown in hidden outline is the approximate position of secondary display screen 20 in relation to secondary enclosure 152. Also shown is guiderail assembly 5 in hidden outline in its stationary position.

FIG. 42 is a schematic front view of dual screen apparatus 150 of FIG. 41 showing primary enclosure 151 and secondary enclosure 152 essentially centered in a dual screen mode. Secondary enclosure hinge assembly 153 holds secondary enclosure 152 when the latter is extended and prevents it from being detached from the apparatus. Secondary enclosure hinge assembly 153 may contain the electronics for secondary display screen 20. When secondary enclosure 152 is extended, secondary enclosure hinge assembly 153 slides through supporting rod 155 stopping at a point when the entire portion of secondary enclosure 152 is out of primary enclosure 151. The double hinge portion of the assembly is then exposed. Secondary enclosure hinge assembly 153 may be mounted in its own guiderail and need not slide along supporting rod 155. Supporting rod 155, which is fixed and stationary on both ends, is representative only of the rail and thus, may be removed. Secondary enclosure hinge assembly 153 slides along supporting rod 155 in the same manner to, for example, how an ink cartridge slides back and forth along a supporting rod in an ink jet printer or plotter. As secondary enclosure 152 is extended, guiderail assembly 5 is also moved towards the left to adjust the two display enclosures essentially centered relative to base electronics housing 32 for the dual screen mode. In this position, primary enclosure 151 may be rotated forward or backward essentially along primary enclosure hinge rotation axis 157.

FIG. 43 is another schematic front view of dual screen apparatus 150 of FIG. 42 showing primary display screen 10 and the positions of secondary enclosure hinge assembly 153 and primary enclosure hinge 14. Primary display screen 10 and secondary display screen 20 are shown facing the user in the dual screen mode. The two display screens may be made of the same material, have the same weight, or have the same size unlike in the schematic representation in which secondary display screen 20 appears smaller than primary display screen 10. They may function as one display screen or two discrete display screens.

FIG. 44 is a top view of dual screen apparatus 150 of FIGS. 42-43 showing the rotation movements of secondary enclosure 152. In the dual screen mode, secondary enclosure 152 may be rotated forward or away from the user and backward or towards the user via secondary enclosure hinge assembly 153 to adjust secondary display screen 20 for fine contrast and legibility. Secondary enclosure 152 may be rotated forward or away from the user at phantom line representation 154 essentially along secondary enclosure rotation direction arrow 36. Such a rotation may be intended, if for example, the user has other viewers at the right side that need to see secondary display screen 20 more legibly. Secondary enclosure 152 may be rotated backward or towards the user at phantom line representation 159 essentially along secondary enclosure rotation direction arrow 37 so that secondary enclosure 152 is angled towards the user. Primary enclosure 151 may be moved either to the left or right via guiderail assembly 5.

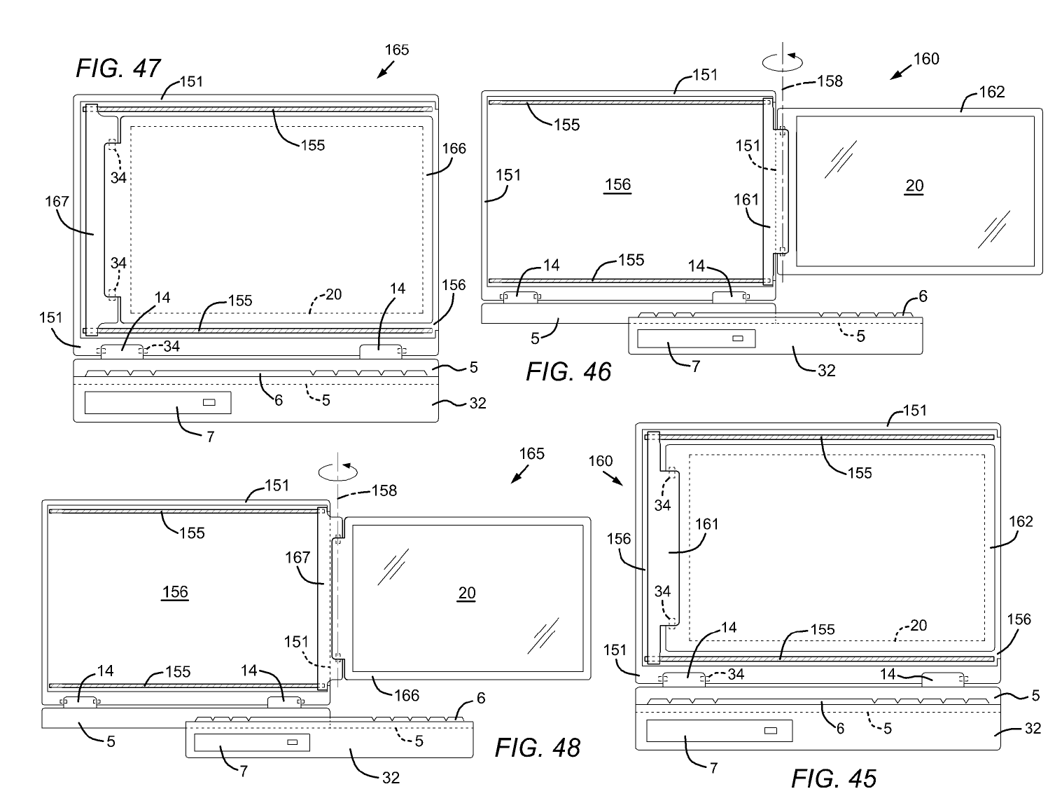

FIG. 45 is a schematic front view of dual screen apparatus 160 showing an alternative example of single hinge design for secondary enclosure 162. The double hinge primary enclosure design of the dual screen apparatus shown in FIGS. 41-44 is retained while a single solid secondary enclosure hinge assembly 161 replaces the secondary enclosure double hinge design. In the schematic representation of FIG. 45, secondary enclosure hinge assembly 161 connects to secondary enclosure 162 similar to that shown in FIGS. 41-44. The design of secondary enclosure hinge assembly 161 is suitable to house more electronics for secondary display screen 20. In FIG. 45, secondary enclosure 162 is received by primary enclosure cavity 156 within primary enclosure 151 in its stored or closed position. Also shown is secondary enclosure hinge assembly 161 slidably positioned at end portion of supporting rod 155.

FIG. 46 is a schematic front view of dual screen apparatus 160 of FIG. 45 showing display enclosures 151, 162 essentially centered in a dual screen mode. From its stored or closed position in FIG. 45, secondary enclosure 162 is extended out of primary enclosure 151 as secondary enclosure hinge assembly 161 slides along from one end to the other end of supporting rod 155. The pair of supporting rods 155 is shown as they prevent secondary enclosure hinge assembly 161 from falling off. The latter holds secondary enclosure 162 and likewise prevents it from being detached from the unit. In a dual screen mode, display enclosures 151, 162 are essentially centered relative to base electronics housing 32. Secondary enclosure 162 may be rotated forward or backward to adjust secondary display screen 20 for fine viewing via secondary enclosure hinge assembly 161 essentially along secondary enclosure hinge rotation axis 158.

FIG. 47 is a schematic front view of dual screen apparatus 165 showing another alternative example of a single hinge design for secondary enclosure 166. The double hinge design for primary enclosure 151 as shown in FIGS. 41-46 is retained while the position of its single hinge design for the secondary enclosure has been reversed. In FIG. 47, secondary enclosure 166 is connected to secondary enclosure hinge assembly 167 via hinge pin 34. In its stored position, secondary enclosure 166 is shown received by primary enclosure cavity 156 within primary enclosure 151 and secondary enclosure hinge assembly 167 is shown slidably positioned at the end portion of supporting rod 155.

FIG. 48 is a schematic front view of dual screen apparatus 165 of FIG. 47 in a dual screen mode. In the schematic representation, primary display screen 10 has been removed to show the two supporting rods 155 and as secondary enclosure hinge assembly 167 slid along it to exit secondary enclosure 166 from primary enclosure 151. Guiderail assembly 5 has moved primary enclosure 151 towards the left to essentially center the two display enclosures for the dual screen mode. In the dual screen mode, secondary enclosure 166 may be rotated forward or away from the user and backward or towards the user to adjust secondary display screen 20 for fine viewing via secondary enclosure hinge assembly 167 essentially along secondary enclosure hinge rotation axis 158. Secondary enclosure hinge assembly 167 holds secondary enclosure 166 in its extended position and prevents it from being detached from the unit.

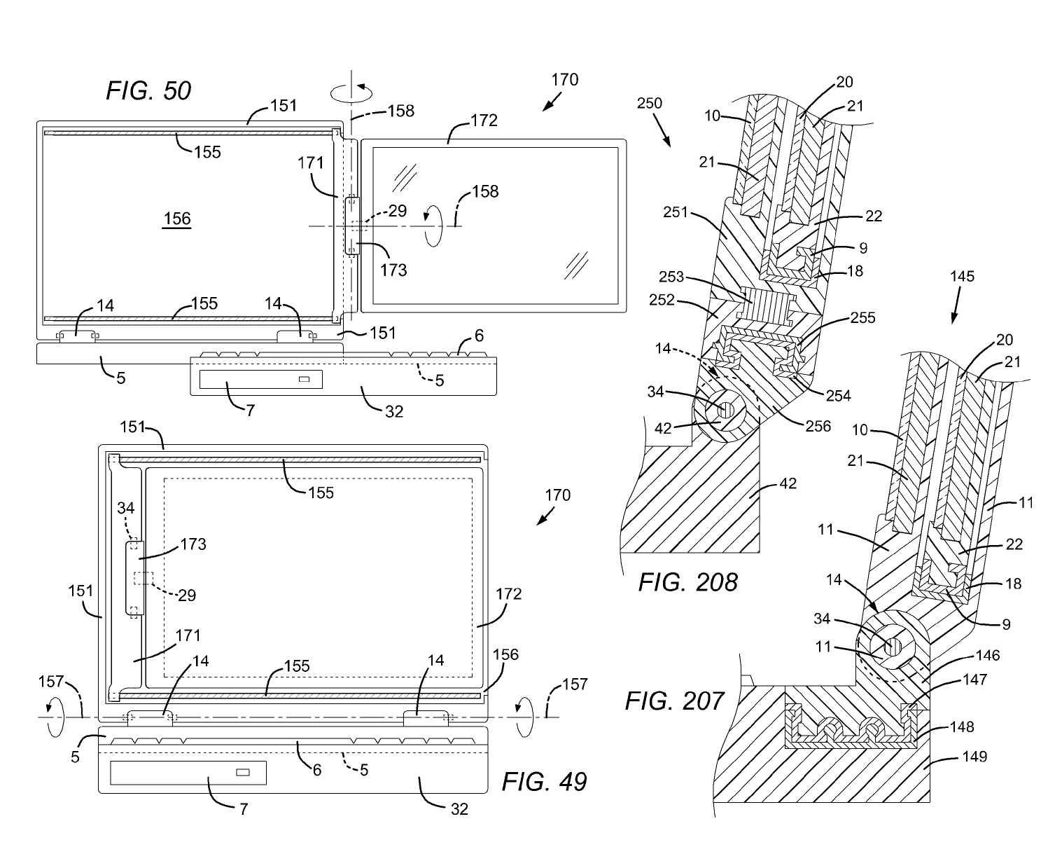

FIG. 49 is a schematic front view of dual screen apparatus 170 showing an example of a swivel hinge design for secondary enclosure 172. Secondary enclosure swivel hinge 173 is shown attached to swivel hinge supporting member 171 via hinge pin 34 and to secondary enclosure 172 via hinge stem 29. Hinge stem 29 serves as the pivot point which allows secondary enclosure 172 to be rotated. Secondary enclosure swivel hinge 173 is similar in function to, for example, the swivel hinge found in LCD displays in camcorders or in digital video recorders. Supporting rod 155 slidably receives swivel hinge supporting member 171 as secondary enclosure 172 is stored within primary enclosure cavity 156 of primary enclosure 151. Swivel hinge supporting member 171 is more solid and thicker as compared to the hinge assembly shown in FIG. 47 or in FIG. 52, thus, the width of secondary enclosure 172 may be lessened for it to fit primary enclosure cavity 156. In a single screen mode, the user may rotate primary enclosure 151 forward or away from the user and backward or towards the user essentially along primary enclosure hinge rotation axis 157 to adjust primary display screen 10 for contrast and fine viewing. The double hinge design for primary enclosure 151 as shown in FIGS. 41-48 is retained.

FIG. 50 is a schematic front view of dual screen apparatus 170 of FIG. 49 in a dual screen mode. Secondary enclosure 172 has been exited from primary enclosure 151 via swivel hinge supporting member 171 sliding through supporting rod 155. As shown in FIG. 50, secondary enclosure 172 is hingely attached to swivel hinge supporting member 171 via secondary enclosure swivel hinge 173 through hinge stem 29 and may be rotated with two degrees of freedom. It may be rotated forward or backward and up or down essentially along secondary enclosure hinge rotation axis 158 relative to hinge pin 34 and hinge stem 29 which serve as pivot points. Thus, secondary enclosure 172 may be rotated approximately 180 degrees so that secondary display screen 20 faces the rear. Dual screen apparatus 170 of FIG. 50 is in a dual screen mode as display enclosures 151, 172 face the user and essentially centered relative to base electronics housing 32.

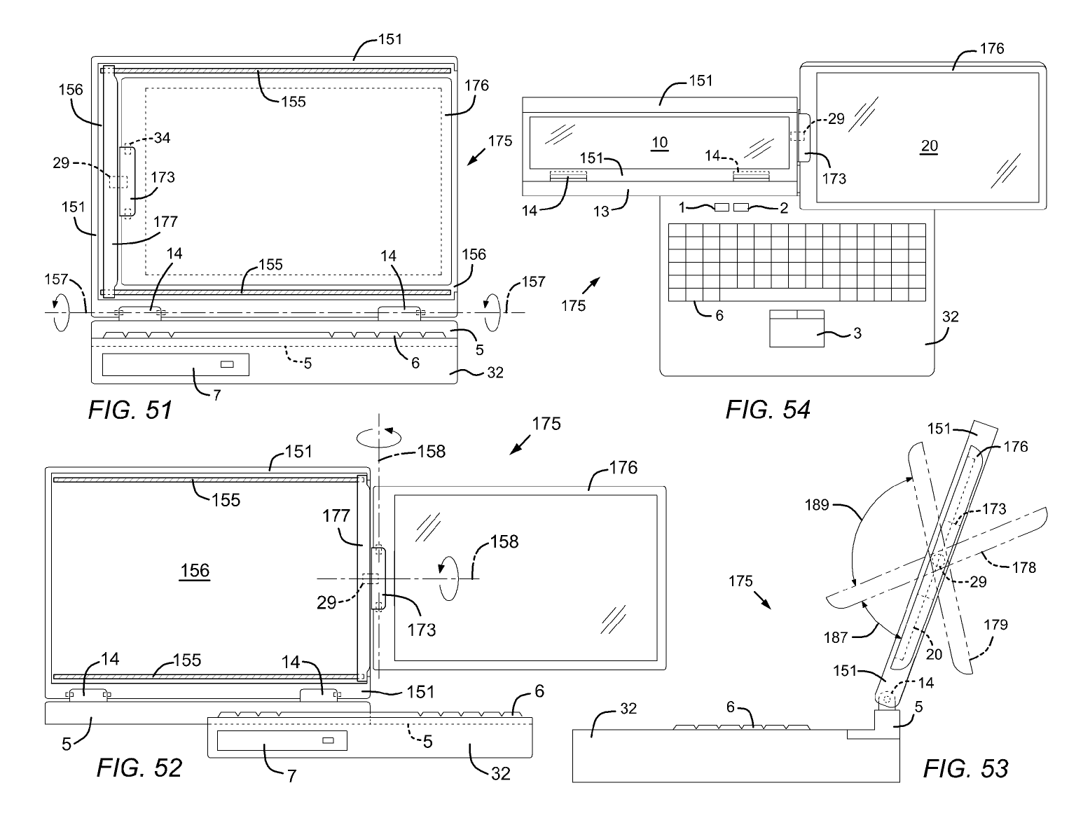

FIG. 51 is a schematic front view of dual screen apparatus 175 showing an alternative example of the secondary enclosure swivel hinge design of FIGS. 49-50. Secondary enclosure swivel hinge 173 is shown connected to secondary enclosure 176 via hinge pin 34 and to swivel hinge supporting member 177 via hinge stem 29, which is in the reversed position as compared to that shown in FIGS. 49-50. Unlike the swivel hinge supporting member shown in FIGS. 49-50, in FIG. 51 it is essentially slimmer and less robust, thus, permitting a larger area for secondary enclosure 176. In a single screen mode, as in FIG. 51, the user may rotate primary enclosure 151 forward or away from the user and backward or towards the user essentially along primary enclosure hinge rotation axis 157 to adjust primary display screen 10 (not shown) for contrast and fine viewing. FIG. 52 is a schematic front view of dual screen apparatus 175 of FIG. 51 in a dual screen mode. Secondary enclosure 176 is extended and primary enclosure 151 is moved towards the left via guiderail assembly 5 to essentially center display enclosures 151, 176 relative to base electronics housing 32. In this position, secondary enclosure 176 may be rotated similar to that shown in FIG. 50 with two degrees of freedom. It may be rotated forward or backward and up or down essentially along secondary enclosure hinge rotation axis 158.

FIG. 53 is a schematic side view of dual screen apparatus 175 of FIG. 52 showing rotation movements of secondary enclosure 176. As display enclosures 151, 176 are essentially centered in a dual screen mode, secondary enclosure 176 may be rotated up or down via hinge stem 29 which serve as the pivot point. Secondary enclosure phantom line representation 178 indicates the position that secondary enclosure 176 may be rotated upward at an angle essentially along secondary enclosure rotation direction arrow 187 such that secondary display screen 20 faces the upper part of the user. Secondary enclosure phantom line representation 179 indicates the position that secondary enclosure 176 may be further rotated upward essentially along secondary enclosure rotation direction arrow 189 such that secondary display screen 20 faces the back or a viewer facing the back of primary enclosure 151. In this position, secondary display screen 20 is aimed at a viewer or audience facing the user while the user is viewing primary display screen 10. Secondary enclosure swivel hinge 173 is not continuous as typically the rotation is not more than 360 degrees. However, the application of fiber optics technology may make secondary enclosure 176 rotate continuously in any direction and still function effectively.

FIG. 54 is a schematic top view of dual screen apparatus 175 of FIG. 53 showing secondary enclosure 176 facing the top of the user in a dual screen mode. Dual screen apparatus 175 of FIG. 54 is in its dual screen mode as display enclosures 151, 176 are operational facing the user and essentially centered relative to base electronics housing 32. Primary enclosure 151 is tilted at an angle facing the user. Secondary enclosure 176 is angled facing the top of the user, similar to the position depicted by secondary enclosure phantom line representation 178 as shown in FIG. 53. In this position, guiderail assembly 5 may be moved towards the left or right to adjust display screens 10, 20 according to the user's preference.

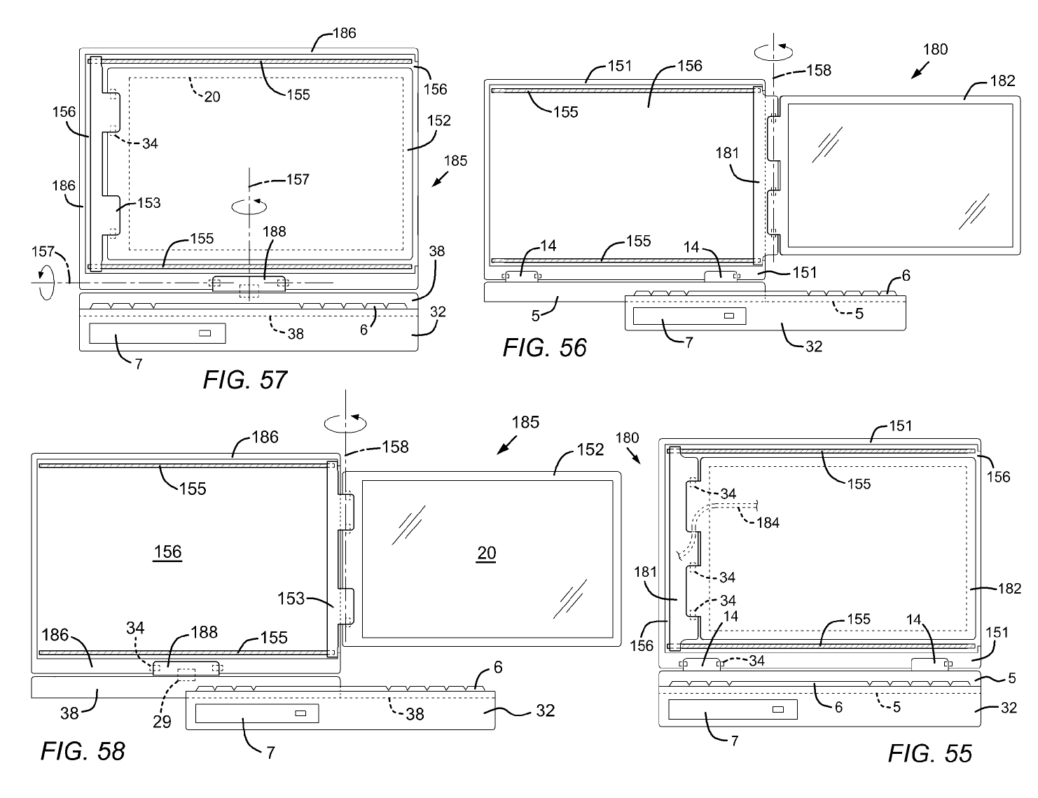

FIG. 55 is a schematic front view of dual screen apparatus 180 showing an alternative example double hinge design for secondary enclosure 182. In FIG. 55, secondary enclosure 182 is the one mounted to secondary enclosure hinge assembly 181 via three hinge pins 34 as compared to that shown in FIGS. 41-44 in which secondary enclosure hinge assembly 153 is attached to secondary enclosure 152. The hidden outline represents cable assembly 184 which is a representation of a cable wire for electronics passing through the space allotted for hinge pin 34. Cable assembly 184 may contain fiber optics or hair thin wires that send, for example, video signals, status information or voltage requirement to the display screens. It functions both as an input and output cable, for example, as an input cable in case of a touch screen sensitive secondary display screen 20. Cable assembly 184 illustrates how hinge pin 34 was removed to permit the cable to weave through the display enclosure without exposing the wirings. Supporting rod 155 may also be used to send signals through primary enclosure hinge 14 via wired or wireless connection. For example, the rod may cause the signals to modulate through a wireless module.

FIG. 56 is a schematic front view of dual screen apparatus 180 of FIG. 55 in a dual screen mode. Secondary enclosure hinge assembly 181 holds secondary enclosure 182 and prevents it from being detached from the unit as the latter is extended out of primary enclosure 151. Secondary enclosure hinge assembly 181 permits secondary enclosure 182 to be rotated forward or away from the user and backward or towards the user essentially along secondary enclosure hinge rotation axis 158. In a dual screen mode, guiderail assembly 5 has moved towards the left to arrange display enclosures 151, 182 to an essentially centered position relative to base electronics housing 32.

FIG. 57 is a schematic front view of dual screen apparatus 185 showing an example of a swivel hinge design for primary enclosure 186. Primary enclosure 186 is shown attached to guiderail assembly 38 via primary enclosure swivel hinge 188. In a single screen mode, when primary display screen 10 (not shown) is the only display screen available, primary enclosure 186 may be rotated via primary enclosure swivel hinge 188 with two degrees of freedom. It may be rotated forward or backward and sideways essentially along primary enclosure hinge rotation axis 157. Secondary enclosure hinge assembly 153 connects to secondary enclosure 152 and prevents it form being detached from the unit. The double hinge design is similar to that shown in FIGS. 41-44.

FIG. 58 is a schematic front view of dual screen apparatus 185 of FIG. 57 in a dual screen mode. Secondary enclosure 152 is shown extended and prevented from being detached from the unit by secondary enclosure hinge assembly 153. In the dual screen mode, in which the two display screens are available and facing the user, secondary enclosure 152 may be rotated forward or away from the user and backward or towards the user essentially along secondary enclosure hinge rotation axis 158. Secondary hinge assembly 153 slides through supporting rod 155 as secondary enclosure 152 is extended similar to that described in FIGS. 41-44.

FIG. 59 is a schematic front view of dual screen apparatus 190 showing an example of a swivel hinge design for both display enclosures 186, 176. Secondary enclosure swivel hinge 173 connects to secondary enclosure 176 via hinge pin 34 that permits the latter to be exited from primary enclosure 186, similar to that shown in FIGS. 51-54. Secondary enclosure swivel hinge 173 is shown attached to swivel hinge supporting member 177 via hinge stem 29. Primary enclosure swivel hinge 188 is similar to that shown in FIGS. 57-58 and similarly may be rotated with two degrees of freedom. This enables primary enclosure 186 to be rotated sideways and forward or backward similar to that shown in FIG. 57 essentially along primary enclosure hinge rotation axis 157.

FIG. 60 is a schematic front view of dual screen apparatus 190 of FIG. 59 in a dual screen mode. In a dual screen mode, secondary enclosure 176 is exited from primary enclosure 186 from its former position in FIG. 59 as display enclosures 186, 176 are essentially centered relative to base electronics housing 32. Secondary enclosure 176 may be rotated up or down via hinge stem 29 as pivot point and forward or backward via hinge 34 as pivot point essentially along secondary enclosure hinge rotation axis 158.

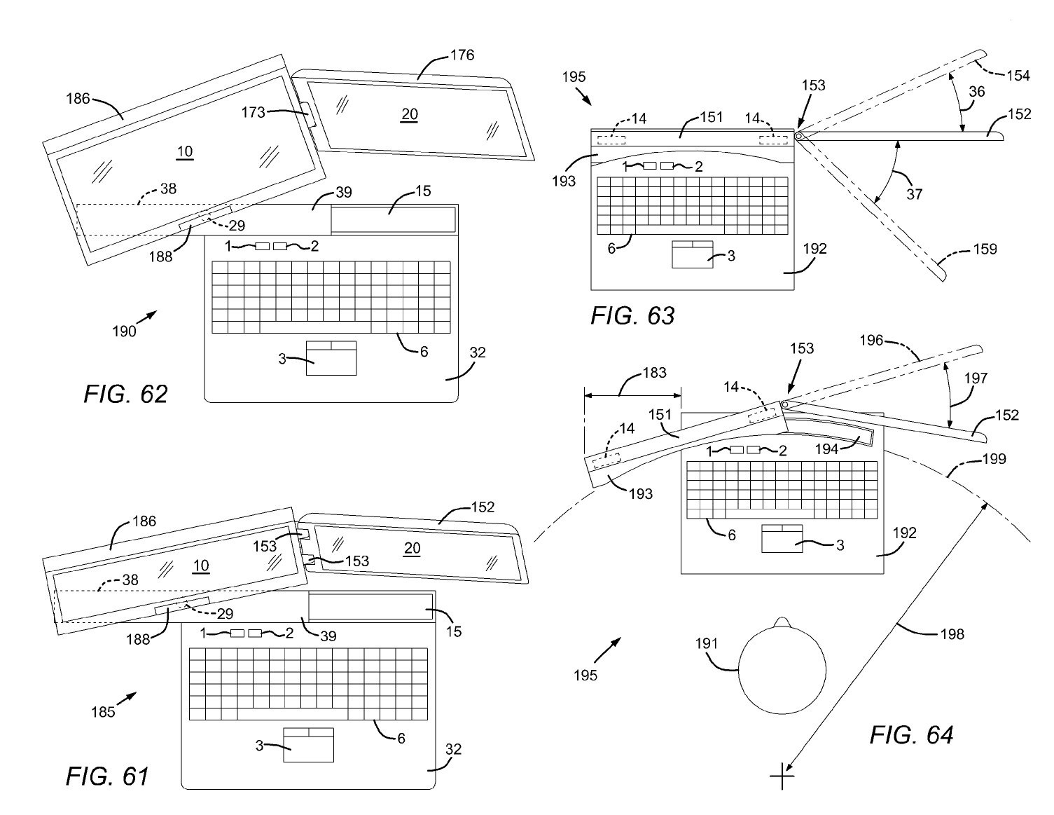

FIG. 61 is a top view of dual screen apparatus 185 of FIG. 58. Shown is primary enclosure 186 rotated at an angle towards the user via primary enclosure swivel hinge 188. Primary enclosure 186 is tilted back and rotated a bit facing right while secondary enclosure 152 is facing towards the user at left or the person behind the user. Display enclosures 186, 152 are essentially centered relative to base electronics housing 32 as the guiderail assembly is shifted to the left in a dual screen mode. The guiderail assembly may also be moved to the right to adjust display enclosures 186, 152 according to the user's preference angle.

FIG. 62 is top view of dual screen apparatus 190 of FIG. 60. Primary enclosure 186 is tilted upward and rotated a bit to the left facing the user via primary enclosure swivel hinge 188 while secondary enclosure 176 is tilted towards the user via secondary enclosure hinge assembly 173. In a dual screen mode, such as in FIG. 62, the guiderail assembly has moved towards the left to arrange display enclosures 186, 176 to an essentially centered orientation. The guiderail assembly may also be shifted towards the right to adjust display enclosures 186, 176 according to the user's preference.

FIG. 63 is a top view of dual screen apparatus 195 showing an extended secondary enclosure 152 and a curved guiderail assembly 193. Secondary enclosure 152 is shown extended out of primary enclosure 151 via secondary enclosure hinge assembly 153 similar to that shown in FIGS. 41-44. When in its extended position, secondary enclosure 152 may be rotated forward or away from the user and backward or towards the user via secondary enclosure hinge assembly 153. Secondary enclosure phantom line representation 154 indicates the position that secondary enclosure 152 may be moved forward or away from the user essentially along secondary enclosure rotation direction arrow 36. This set-up is suitable when there are viewers at the right side of the user. Secondary enclosure phantom line representation 159 indicates the position that secondary enclosure 152 may be moved towards the user or to the person behind the user for adjusting secondary display screen 20 essentially along secondary enclosure rotation direction arrow 37. Secondary enclosure hinge assembly 153 may be connected to secondary enclosure 152, the former may slide along a supporting rod 155 located within primary enclosure 151. Also shown is curved guiderail assembly 193 in its stationary position below primary enclosure 151, although the latter is not curved to the user's view.

FIG. 64 is a top view of dual screen apparatus 195 of FIG. 63 in a dual screen mode. Curved guiderail assembly 193 generally provides natural turning and symmetrical viewing of the two display screens (not shown). It rides on a projected line called projected guiderail curvature 199 which shows the range of movement of primary enclosure 151. Curved guiderail assembly 193 may be moved to a comfortable position to the left or right to suit viewing needs. Curved guiderail extension arrow 183 indicates how far curved guiderail assembly 193 has extended to the left as dual screen apparatus 195 is brought to its dual screen mode. Guiderail radius 198, typically about 0.8 meters to 2.0 meters, is the distance between the center and the circumference of projected guiderail curvature 199. User 191 may be located within guiderail radius 198 to effectively view both the display screens. In the dual screen mode of dual screen apparatus 195, curved guiderail assembly 193 has moved towards the left to arrange display enclosures 151, 152 to an essentially centered orientation relative to base electronics housing 192. Secondary enclosure 152 has been rotated from its position in FIG. 63 as indicated by phantom line representation 196 essentially along secondary enclosure rotation direction arrow 197 to counteract the angle of primary enclosure 151 and to even the angle of display enclosures 151, 152 so user 191 may see both the display screens at the same time. Thus, secondary enclosure 152 has been aligned to user 191 in the same manner that curved guiderail assembly 193 followed projected guiderail curvature 199 to essentially center display enclosures 151, 152 when dual screen apparatus 195 is in a dual screen mode.

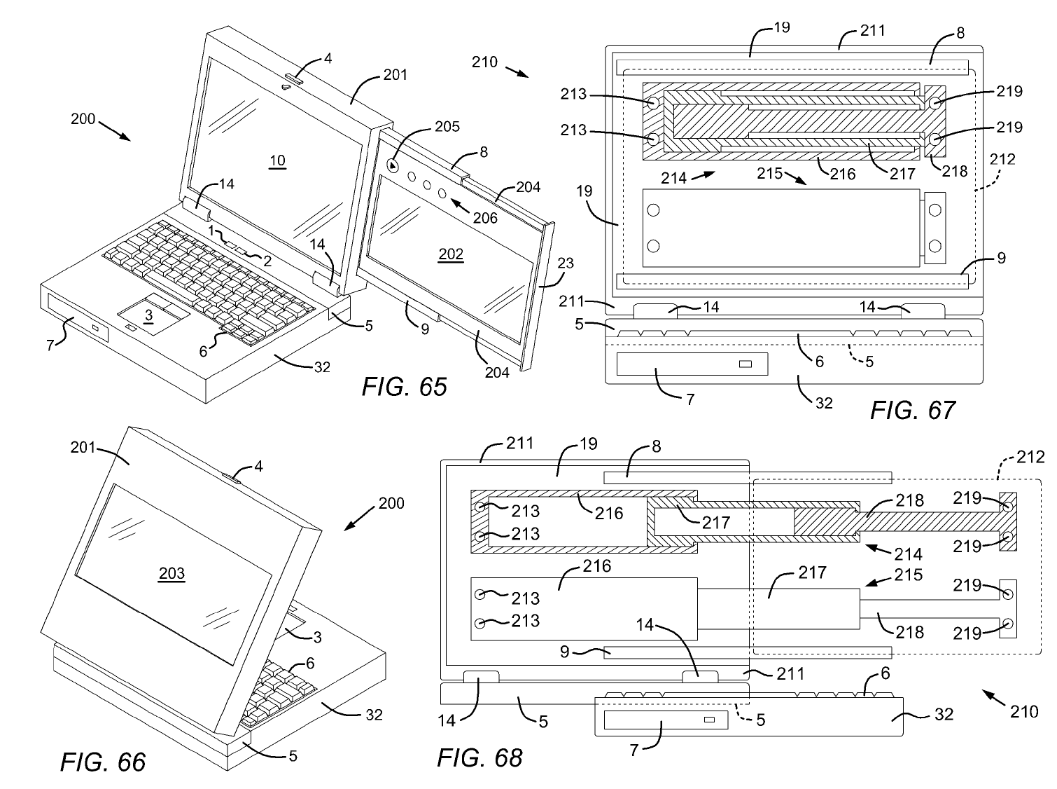

FIG. 65 is an isometric view of dual screen apparatus 200 showing an extended specialized secondary enclosure 204 in a dual screen mode. Secondary display screen 202 of secondary enclosure 204 is especially suited for high resolution displays such as multi-color graphic images or for movie editing while primary display screen 10 of primary enclosure 201 is used as a normal display screen. Secondary enclosure 204 may have a different display technology that is suited to a different application. For example, secondary display screen 202 may have a different aspect ratio such as 16:9 aspect ratio which is more suited to HDTV or some DVD cinema style movies. Aspect ratio is defined as the ratio of the width to the height of an image in a television screen. Secondary display screen 202 may also be used for a specific purpose such as to view one or more TV oriented video channels. Any extra space in secondary enclosure 204 may contain keys, buttons, and speakers of a general nature or specific to secondary display screen 202 function. Secondary enclosure 204 may also contain a clip to hold paper notes or manuscripts for typing or reference, lights such as LED lights, fans, stylus and memory readers, optical storage readers and optical disc storage, and the like. Thus, secondary enclosure 204 may be smaller with a different display screen technology than primary display screen 10. In FIG. 65, secondary enclosure 204 is equipped with physical function buttons located at the upper portion such as play buttons 205 and program buttons 206, the last one regulate functions for volume, speed, stop and pause, and as a TV channel indicator. Sensors may be put in secondary enclosure 204 to detect input from a remote controller or a wireless remote controller such as radio frequency or infra-red. Secondary enclosure 204 is housed within primary enclosure 201 when in a stored or closed position. It may be extended via slider arms 8, 9 for use as a separate display screen or in combination with primary display screen 10. Slider arms 8, 9 function similarly to that earlier described. Dual screen apparatus 200 of FIG. 65 is in a dual screen mode in the sense that two display screens are available and facing the user. Display enclosures 201, 204 may be adjusted to an essentially centered position relative to base electronics housing 32 by moving guiderail assembly 5 towards the left.

FIG. 66 is an isometric rear view of dual screen apparatus 200 of FIG. 65 incorporating tertiary display screen 203 at back of primary enclosure 201. The back portion of primary enclosure 201 is rotated at an essentially diagonal orientation to show a specialized display screen which may also be a high resolution display screen similar to the unit's secondary display screen 202. The specialized tertiary display screen 203 may be used to play multimedia, DVD content, a touch sensitive screen when primary enclosure 201 is latched or closed, a display screen to show a movie, a display screen that may face an audience in front of the user or the rear of primary enclosure 201, or as a tablet PC when primary enclosure 201 is in a closed position. Tertiary display screen 203 may have identical function or size as secondary display screen 202 or it may possess better display screen technology than primary display screen 10.

FIGS. 67-71 illustrate three examples of telescopic arms assembly that may be applied to extend or retract the secondary enclosure without resorting to the slider arms. The slider arms schematically shown in FIGS. 67-71 are just supplemental support that may be removed without downgrading the functionality of the telescopic arms assembly.

Accordingly, FIG. 67 is a schematic front view of dual screen apparatus 210 showing telescopic arms assembly 214, 215 in a closed or contracted position within primary enclosure 211. Upper telescopic arms assembly 214 and lower telescopic arms assembly 215 are shown in their closed or contracted position within primary enclosure 211. In FIG. 67 is a schematic cross sectional view of upper telescopic arms assembly 214 that shows how first segment 216, second segment 217 and third segment 218 relate to each other in their closed or retracted position. The three segments slide into one another or conflate as one so they become smaller and occupy lesser space. First segment 216 is attached towards the left rear portion of primary enclosure 211 via two left rivets 213 while at other end third segment 218 is attached towards the right rear portion of secondary enclosure 212 via two right rivets 219. The three segments are arranged in such a way that third segment 218 is fitted into second segment 217 which in turn is fitted into first segment 216 so that the three segments look as one when contracted in a closed position.

FIG. 68 is a schematic front view of dual screen apparatus 210 of FIG. 67 showing telescopic arms assembly 214, 215 in an extended position. When secondary enclosure 212 is extended as in FIG. 67, third segment 218 and second segment 217 of telescopic arms assembly 214, 215 are also extended stopping at a point through a detent to prevent secondary enclosure 212 from being detached from the unit. Telescopic arms assembly 214, 215 also prevent wiggling or jerking movements as it holds secondary enclosure 212 and as guiderail assembly 5 moves the two display enclosures to an essentially centered orientation relative to base electronics housing 32 in a dual screen mode as shown in FIG. 68. The precision mechanism when the three segments contract or conflate as one may be compared to how a zoom lens is fitted to a camera in a precise way. Similarly, slider arms 8, 9 are also shown providing added strength to hold secondary enclosure 212 and prevent it from falling off the unit. As earlier mentioned, slider arms 8, 9 are optional and may be removed.

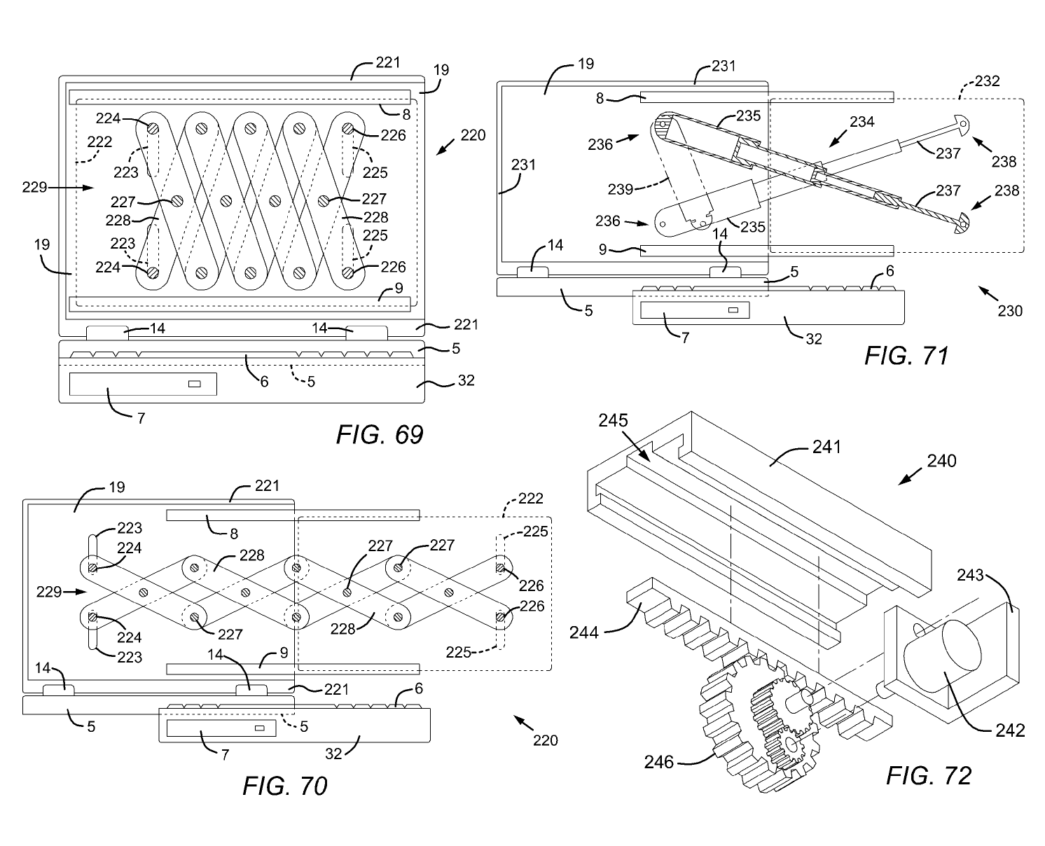

FIG. 69 is a schematic front view of dual screen apparatus 220 showing a scissors style telescopic arms assembly 229 in a closed or contracted position within primary enclosure 221. In its closed or contracted position, telescopic arms assembly 229 may be likened to four pairs of criss-cross patterns or four pairs of open scissors placed next to each other. It functions similarly to a scissor style lift platform or an accordion style baby gate.

FIG. 70 is a schematic front view of dual screen apparatus 220 of FIG. 69 showing telescopic arms assembly 229 in an extended position. In a dual screen mode, such as in FIG. 70, secondary enclosure 222 is extended as guiderail assembly 5 moves primary enclosure 221 to the left to essentially center display enclosures 221, 222 relative to base electronics housing 32. Telescopic arms assembly 229 are also extended or stretched out. The leftmost telescopic arm segment 228 is attached to connecting pins 224 which in turn are slidably attached to primary enclosure guide slot 223 while the rightmost telescopic arm segment 228 is attached to connecting pins 226 which in turn are slidably attached to secondary enclosure guide slot 225. Connecting pins 224, 226 slide from one end to the other end of enclosure guide slots 223, 225 respectively as secondary enclosure 222 is extended. Guide slot 223 is embedded towards the back of primary enclosure cavity 19 while guide slot 225 is embedded towards the back of secondary enclosure 222 behind secondary display screen 20 (not shown). Telescopic arms assembly 229 may be pulled out mechanically or electrically. The assembly may be fitted with a motorized linear actuator and the like to mechanically facilitate the extension and retrieval of secondary enclosure 222 from primary enclosure 221.

FIG. 71 is a schematic front view of dual screen apparatus 230 showing an alternative example telescopic arms assembly 234. The pair of telescopic arms assembly 234 is arranged in a criss-cross manner similar to how the scissor style telescopic arms assembly 229 of FIG. 70 is arranged. Telescopic arms assembly 234 consists of four segment arms which function similarly to that shown in FIG. 70. It is rotatably attached behind primary display screen 10 (not shown) of primary enclosure 231 via first segment 235 at first segment mounting position 236 and secondary display screen 20 (not shown) of secondary enclosure 232 via fourth segment 237 at fourth segment mounting position 238. Phantom line representation 239 shows position of the upper segment arms in a closed or contracted position when secondary enclosure 232 is housed within primary enclosure cavity 19. Phantom line representation 239 also shows how the upper segment arms look as they conflate to become one. The lower segment arms of telescopic arms assembly 234 also conflate similar to that depicted by phantom line representation 239 when telescopic arms assembly 234 is in its closed or contracted position.

FIG. 72 is an exploded view of the components of guiderail motor assembly 240. Guiderail motor assembly 240 is comprised of gear assembly 246 attached to the shaft of electromechanical motor 242 which in turn is fitted to motor mounting bracket 243. Electromechanical motor 242 engages with and rotates gear assembly 246 transferring mechanical motion that causes the rotation of the latter and causes rack 244 that is fixedly attached along groove 245 of guiderail slide 241 to move back and forth. Gear assembly 246 consists of three gears: an inside small first gear mounted to the motor shaft and a middle second gear fixedly attached to the bigger outer third gear. The gears magnify the torque produced by electromechanical motor 242 which may be a weak motor so that a minimum torque is required to move rack 244. The outer gear has a lower rotation speed rate than the smaller gears inside. Guiderail slide 241 of the guiderail assembly may be attached below or above the primary enclosure hinge. Guiderail slide 241 enables the motorized control of the guiderail assembly to the left (from its stationary position) to allow the two display enclosures to be essentially centered relative to the base electronics housing for the dual screen mode or to the right to go back to their original position.

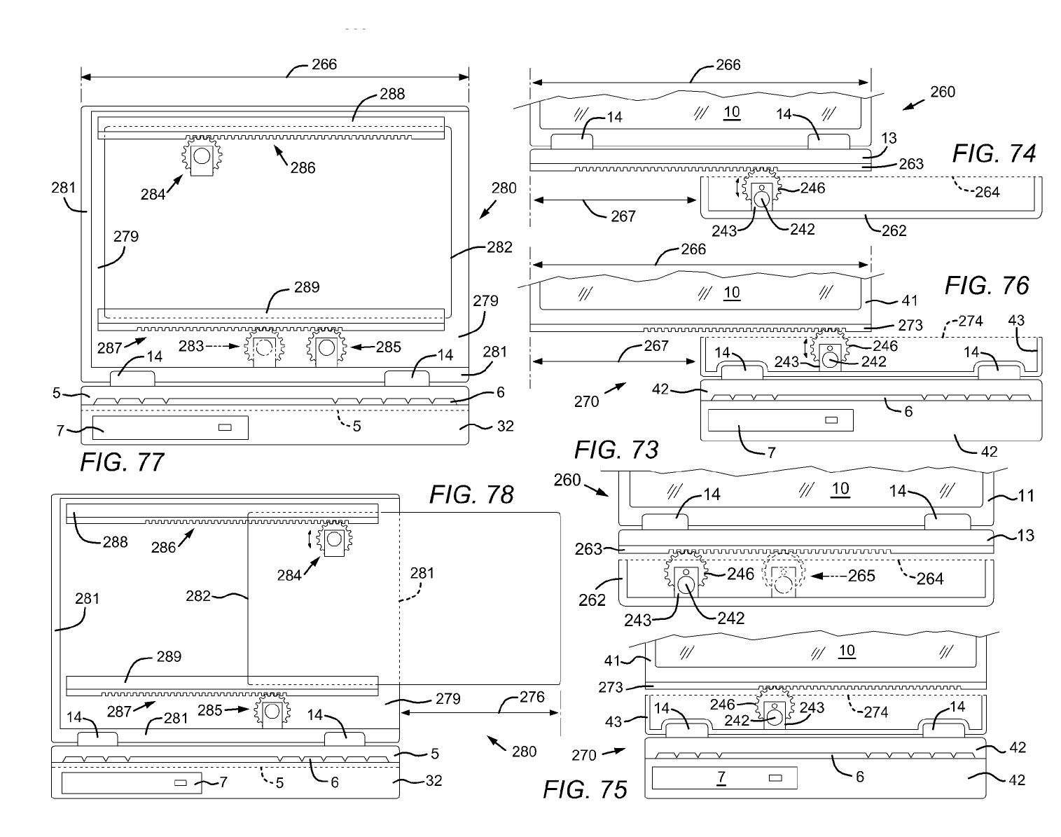

FIGS. 73-80 depict the relative positions of the guiderail motor assembly as it moves the rack and slide back and forth along with the two display enclosures and extends the slider arms. FIGS. 73-74 are partial schematic front views of motorized dual screen apparatus 260 incorporating guiderail motor assembly 240 and rack and slide 263 located below primary enclosure hinge 14 similar to that shown in FIGS. 1-4. Rack and slide 263, as shown in FIGS. 73-74, is mounted to the bottom of the slide portion of the guiderail assembly, the slide in turn is secured to guiderail cover 13. For purpose of illustration, the side of the slide is not shown to show clearly the motor and rack mechanism, the relative placement of the motor and how the gear engages rack and slide 263. Ordinarily, the rack gear would not be visible. Rack and slide 263 is made up of rack 244 and guiderail slide 241 as depicted in FIG. 72. In FIG. 73, phantom line representation of alternative motor position 265 shows that guiderail motor assembly 240 may also be located at any distance on the left side from the center of base electronics housing 262 and still effectively move rack and slide 263 to the left as shown in FIG. 74. As explained earlier, electromechanical motor 242 effects rotation of the gear assembly that causes rack and slide 263 to be moved back and forth. In FIG. 74, guiderail motor assembly 240 causes rack and slide 263 to be moved towards the left. Gear assembly 246 movements are either clockwise or counter clockwise. If counter clockwise, primary enclosure 11 is pushed to the left. Rack and slide 263 is also pushed to the left since it's fixedly attached to primary enclosure 11 via primary enclosure hinge 14. Guiderail dimension arrow 267 indicates the length that rack and slide 263 has moved to the left which is essentially half the length of dimension arrow 266 or the entire width of primary enclosure 11. Primary enclosure 11 has also moved to the left to an essentially centered position relative to base electronics housing 262. The distance between the left edge of base electronics housing 262 and electromechanical motor 242 in FIGS. 73-74 is essentially identical.

FIGS. 75-76 are partial schematic front views of motorized dual screen apparatus 270 incorporating guiderail motor assembly 240 and rack and slide 273 located above primary enclosure hinge 14 similar to that shown in FIGS. 12-15.

Accordingly, in FIG. 75, guiderail motor assembly 240 is positioned towards the center from the left portion of base electronics housing 42 unlike in FIGS. 73-74 in which the guiderail motor assembly is located towards the left edge of base electronics housing 42. Motorized dual screen apparatus 270 is similar to that shown in FIGS. 12-15 in which the guiderail assembly is located above primary enclosure hinge 14.

In FIG. 76, guiderail motor assembly 240 has moved rack and slide 273 towards the left. The length of guiderail dimension arrow 267 relative to dimension arrow 266 indicates the length that rack and slide 273 has moved which is essentially half the length of dimension arrow 266 or the equivalent of the entire width of primary enclosure 41. If guiderail motor assembly 240 has moved rack and slide 273 that much, it allows the dual screen mode when the secondary enclosure (not shown) is extended. Electromechanical motor 242 may be an AC/DC micro miniature motor of conventional design so it would not occupy much space or it may be a stepper motor similar to the motors used in digital cameras and lenses, or camcorders. The motor should have sufficient torque to easily move the guiderail assembly in either direction (left or right) to effect a single screen or dual screen mode.

FIG. 77 is a schematic front view of motorized dual screen apparatus 280 incorporating primary enclosure motor 285 and secondary enclosure motor 284. In the schematic representation of FIG. 77, primary enclosure motor 285 may be fixed in one location or mounted towards the bottom right portion of primary enclosure cavity 279 of primary enclosure 281, while secondary enclosure motor 284 is mounted towards the top left portion of secondary enclosure 282. The two motors engage with and cause secondary enclosure 282 and slider arms 288, 289 to be extended or withdrawn. Movement of secondary enclosure 282 may also be accomplished with secondary enclosure motor 284 mounted to another position and engaging slider arms 288, 289 to an extended position, and to actuate them through the use of cables and pulleys. Slider arms 288, 289 thus, become linear actuators which grab secondary enclosure 282 and permit it to exit or withdraw from primary enclosure cavity 279 within primary enclosure 281. Primary enclosure motor 285 may be alternatively located at any point from phantom line representation of alternative primary enclosure motor position 283 to the rightmost portion of lower rack 287.

FIG. 78 is a schematic front view of motorized dual screen apparatus 280 as secondary enclosure motor 284 causes secondary enclosure 282 to partially extend. In FIG. 78, slider arms 288, 289 remain stationary as secondary enclosure motor 284 engages and causes the gear assembly to rotate clockwise along upper rack 286 to move secondary enclosure motor 284 towards the right along with secondary enclosure 282 to partially extend. Secondary enclosure motor 284 remains fixed to secondary enclosure 282. Primary enclosure motor 285 remains in neutral state. The two motors need not be symmetrical: one motor may result in accomplishing two thirds of the total desired length while the other motor may accomplish the remaining one third of the total desired length. Secondary enclosure extension direction arrow 276 shows the distance traveled by secondary enclosure 282 when secondary enclosure motor 284 is effectuated.

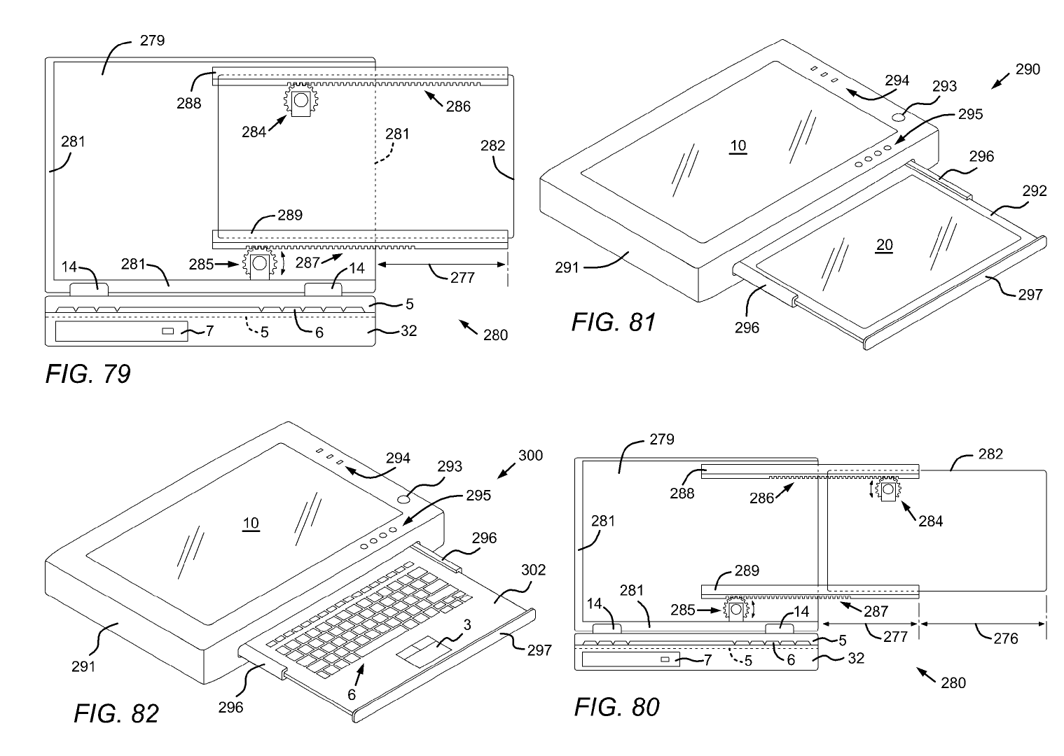

FIG. 79 is a schematic front view of motorized dual screen apparatus 280 as primary enclosure motor 285 causes slider arms 288, 289 to extend and essentially align with secondary enclosure 282. As secondary enclosure motor 284 reverts to neutral state, primary enclosure motor 285 engages with lower rack 287 then starts so as to extend slider arms 288, 289 until they are aligned at a certain point towards the edge of secondary enclosure 282. Secondary enclosure extension arrow 277 indicates the distance traveled by slider arms 288, 289 when primary enclosure motor 285 is effectuated. Upper rack 286 and lower rack 287 need not be mounted to the full length of slider arms 288, 289. The motor may also be mounted on the slider arms while the gearing mechanism and rack may be mounted on either primary enclosure 281 or secondary enclosure 282. Control logic dictates which motor engages and which one starts first. The two motors may both start at the same time. Racks 286, 287 may be molded to slider arms 288, 289 respectively as a two-piece unit or a one-piece unit molding such as a machine part. The slider arm has a friction free surface. The slider arm stop pins detent mechanism shown in FIGS. 10-11 still applies and permits secondary enclosure 282 to be pushed and pulled by slider arms 288, 289.

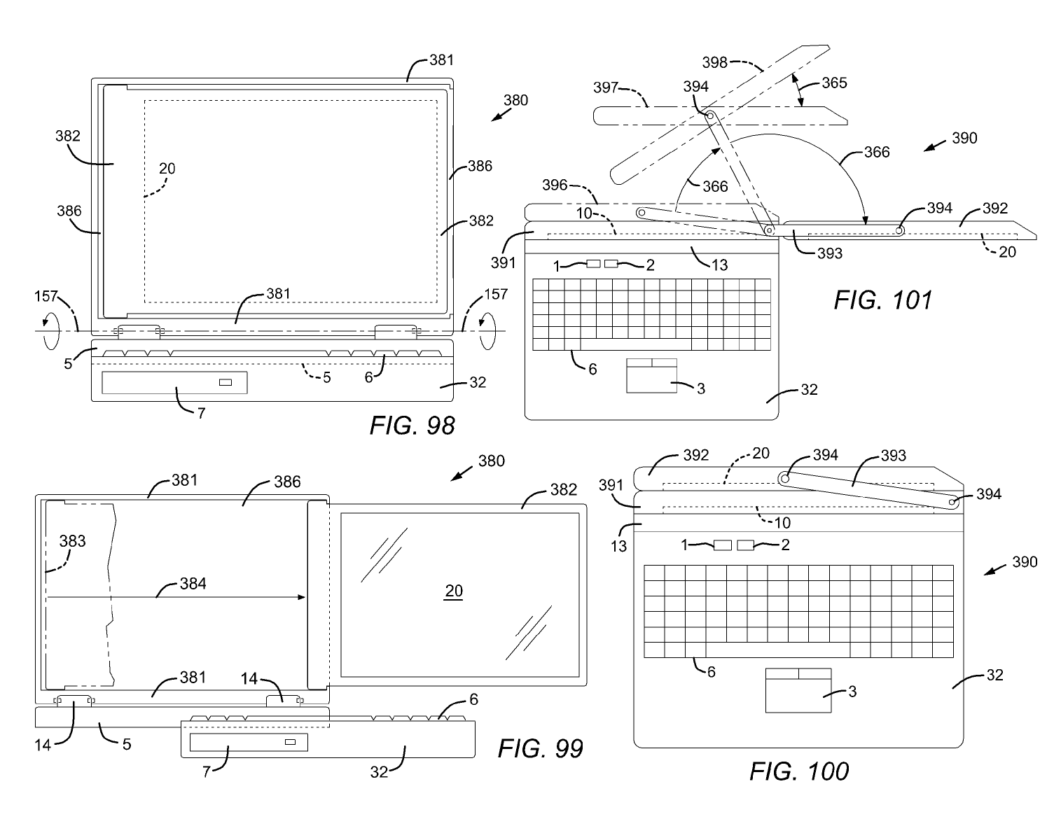

FIG. 80 is a schematic front view of motorized dual screen apparatus 280 as secondary enclosure motor 284 causes secondary enclosure 282 to fully extend. In FIG. 80, secondary enclosure motor 284 is effectuated as it moves out of primary enclosure 281 together with secondary enclosure 282 essentially along the direction of secondary enclosure direction arrow 276. The entire portion of secondary enclosure 282 is shown out of primary enclosure 281. Motorized dual screen apparatus 280 has two motors to extend secondary enclosure 282 if secondary display screen 20 (not shown) has a full width. However, if secondary display screen 20 is smaller, then a single motor may be used for closing and extending secondary enclosure 282 which may be located either at the top or bottom of the display enclosure. The single motor may be used in an example of dual screen apparatus in which the secondary enclosure may be extended without slider arms as shown in FIGS. 98-99. The mechanism is designed in a way that the secondary enclosure may be opened or closed even without the assistance of a motor or if the motor is not functioning. The application of the motor to extend or retract the secondary enclosure from the primary enclosure as described in FIGS. 77-80 may also be adapted in other examples of dual screen apparatuses such in the scissor type telescopic arms assembly shown in FIG. 69, the pedestal mount shown in FIG. 87, pivoting of the secondary enclosure as shown in FIG. 101, and movement of two display enclosures with sliding hinges as shown in FIG. 124.

The motorized mechanism for extending and retracting the secondary enclosure may be similar to that used in an ink jet printer, for example, a Lexmark Z35 printer which uses a motor, a toothed belt, and support rods to move the ink cartridge in a back and forth motion as it prints. In the case of the dual screen apparatus, cables, gears, a toothed belt, a toothed slider arm and their associated motors, solenoids, or actuators may be employed to extend and retract the secondary enclosure from the primary enclosure, or to move the guiderail slide to center both displays relative to the user.

FIGS. 81-84 illustrate a conventional slate-style tablet PC with an integrated yet extendable secondary display enclosure, keyboard enclosure, scanner enclosure, or solar panel enclosure stored within the primary enclosure. The respective mechanisms of the four integrated enclosures may also be considered as a plug and play peripheral device that are manufactured to standard housing sizes so they may be interchangeable or replaceable. This may be related in the same manner how a PCI (peripheral component interconnect) card which is used for connecting a computer and its peripherals conforms to a standard that allows it to be fitted to a PCI expansion slot at the rear of a desktop computer tower. The apparatus shown in FIGS. 82-84 are still called dual screen slate style tablet PC apparatus in the sense that the secondary display enclosure has been substituted by a keyboard, scanner or solar panel enclosure since the four enclosures are interchangeable. The secondary display enclosure may be used again when needed.

Accordingly, FIG. 81 is an isometric view example of dual screen slate-style tablet PC apparatus 290 incorporating an integrated secondary enclosure 292. Secondary enclosure 292 is housed within primary enclosure 291 and may be extended via slider arms 296 which function similarly to the slider arms described in FIGS. 6-7. Secondary enclosure cover 297 seals secondary enclosure 292 when inside primary enclosure 291. Secondary enclosure 292 may have a conventional secondary display screen 20 which may be of the same size as primary display screen 10 or it may be larger suitable for multitasking in which two or more programs may be executed concurrently. Visible in primary enclosure 291 are primary display screen 10 which functions as a typical display screen; status lights 294 which indicate when the unit is charged and may be used as hard drive indicator, wireless indicator or diagnostic indicator; and function buttons 295 to open and turn on or off secondary enclosure 292 and also handle the control aspects of the unit such as volume and brightness. The associated electronics of primary enclosure 291 are located within the display enclosure. The functionality of dual screen slate-style tablet PC apparatus 290 is enhanced by its ability to swap specific peripherals such as when secondary enclosure 292 is no longer needed and that other peripheral devices are desired which may be any one of those described in FIGS. 82-84 and which may be considered more suitable for specific tasks.

FIG. 82 is an isometric view of an alternative example of dual screen slate-style tablet PC apparatus 300 incorporating an integrated keyboard enclosure 302. Keyboard enclosure 302 is housed within primary enclosure 291 and may be extended or pushed out to an operating position via slider arms 296. Keyboard 6 functions as a typical keyboard while touchpad 3 functions both as a cursor-pointing device and a scroll control device.

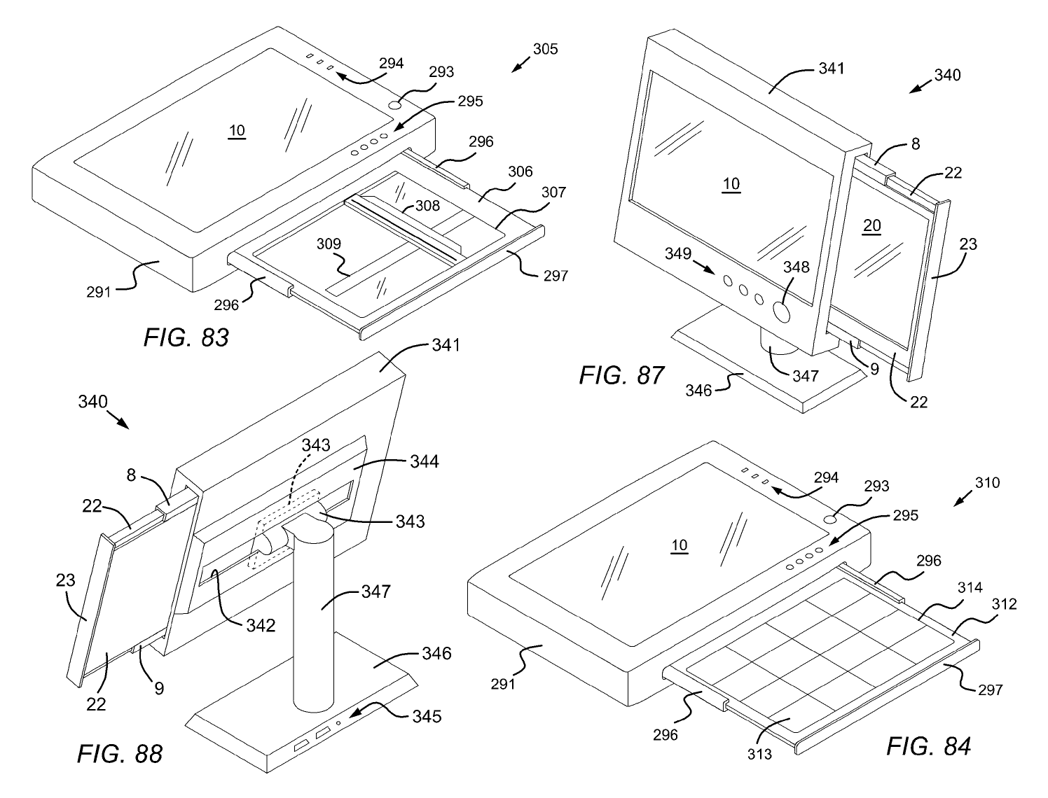

FIG. 83 is an isometric view of a further alternative example of dual screen slate-style tablet PC apparatus 305 incorporating an integrated scanner enclosure 306. Scanner enclosure 306 is housed within primary enclosure 291 and may be extended to an operating position via slider arms 296. Scanner enclosure 306 is comprised of scanner window 307, scanner head 308, and ribbon cable 309, the last one relays information to scanner head 308. Scanner enclosure 306 may have an ultra thin flatbed conventional scanner used for scanning documents or may be equipped with an OCR function.

FIG. 84 is an isometric view yet another alternative example of dual screen slate-style tablet PC apparatus 310 incorporating an integrated solar panel enclosure 312. Solar panel enclosure 312 is housed within primary enclosure 291 in a non-operating position. Solar panel enclosure 312 is made up of solar cells 313 enclosed within solar panel enclosure 312. Adapted for outdoor use, solar panel 314 uses sunlight or solar energy to recharge its batteries.

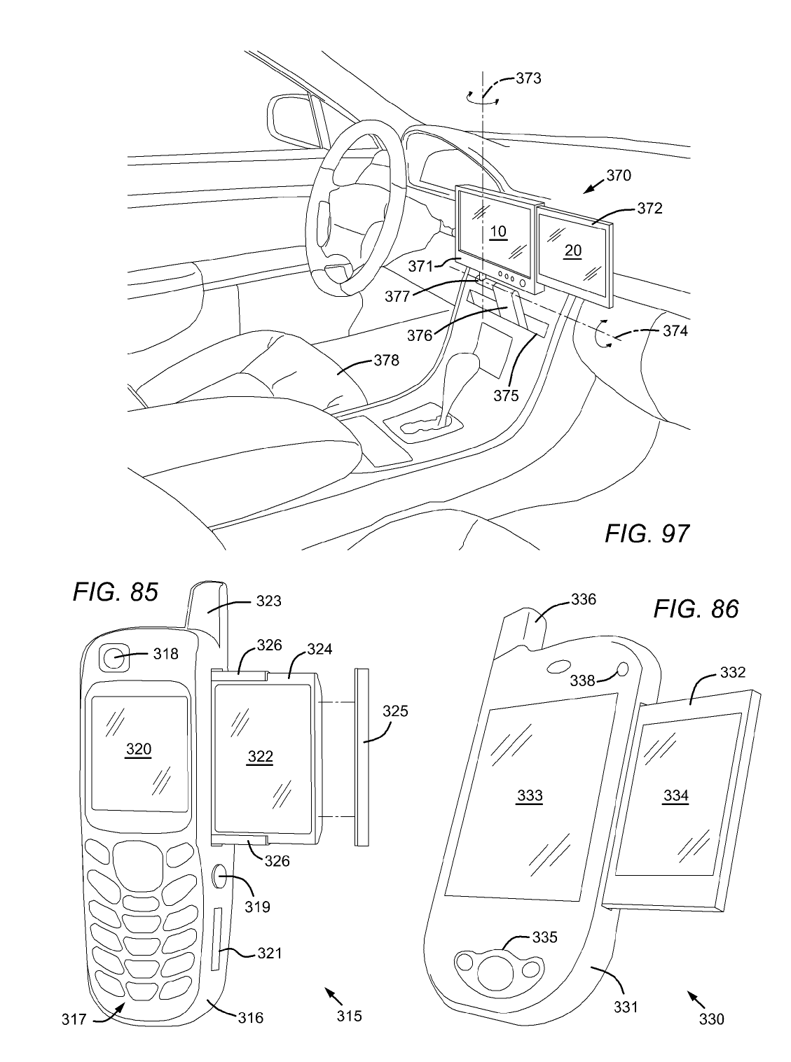

FIG. 85 is a front view example of dual screen mobile phone apparatus 315. Primary phone enclosure 316 contains electronics of a typical mobile phone and features such as keypad 317 and radio antenna 323. Integrated within primary phone enclosure 316 are memory card slot 321, secondary enclosure 324 with an embedded secondary display screen 322 supported by a pair of slider arms 326, and secondary enclosure cover 325 (in exploded view). Secondary display screen 322 may have a different screen technology from primary display screen 320 in the sense that it may have a high screen resolution to complement pictures taken from the unit's integrated camera 318 shown with a lens or to view specialized contents like high resolution images when desired. It may also be used to view DVD programs or Internet contents. Secondary display screen 322 appears larger than primary display screen 320 due to its specialized function. Secondary enclosure 324 is normally stored within primary phone enclosure 316 and is accessible by secondary enclosure release button 319 which pushes out secondary enclosure 324 in one motion. An electronic and mechanical switch enables the user to gently eject secondary enclosure 324 via slider arms 326 to be able to use secondary display screen 322 to view contents supplemental to primary display screen 320 such as photos, video contents, TV programs and the like. Secondary enclosure 324 may be pushed back similar to pushing a cassette tape to a cassette player or recorder. Alternatively, the manner of retracting secondary enclosure 324 may be motorized such that pressing secondary enclosure release button 319 again withdraws secondary enclosure 324 to primary enclosure 316. Dual screen mobile phone apparatus 315 supports different wireless standards such as 3G that enables video conferencing, watching TV programs or sports coverages, browsing Internet or WAP contents. A USB connector may be included to allow display screens 320, 322 to show video contents from a network, similar to the other dual screen apparatuses mentioned.

FIG. 86 is a perspective view example of dual screen PDA/smart phone apparatus 330. Dual screen PDA/smart phone apparatus 330 functions as a typical PDA and smart phone with an integrated PDA and phone capability. A smart phone uses Microsoft software with a built-in PDA. Primary PDA/smart phone enclosure 331 is shown with primary display screen 333, radio antenna 336, secondary enclosure open/close button 338, and navigation button 335. An extended secondary enclosure 332 is shown with an embedded secondary display screen 334 which is smaller than primary display screen 333 unlike to that shown in FIG. 85. Display screens 333, 334 may both be touch sensitive although the open and close functions are not related since secondary enclosure open/close button 338 performs these. As shown in FIG. 86, secondary enclosure 332 is fully extended without slider arms. A hinge may be connected to open and close secondary enclosure 332. The hinge may slide along a supporting rod, for example, similar to that shown in FIGS. 41-42. Dual screen PDA/smart phone apparatus 330 supports different wireless standards such as 3G that enables video conferencing, watching TV programs, sports programs, browsing the Internet or WAP contents. A USB connector may be included to allow display screens 333, 334 to show video contents from a network, similar to the other dual screen apparatuses mentioned.

FIG. 87 is an isometric view example of a dual screen desktop pedestal apparatus 340. The two display enclosures depicted in FIGS. 87-88 are taken from the dual screen apparatus shown in FIG. 3. Dual screen desktop pedestal apparatus 340 is suitable to be placed on a desk or stand. Pedestal column 347 may be lengthened to a desired height to sit on the floor and to function as a podium. Pedestal 346 may also be enlarged to corresponding size to provide stability. Secondary enclosure 22 is housed within primary enclosure 341 and may be extended via slider arms 8, 9. Display enclosures 341, 22 may be moved via guiderail assembly 342 (shown in FIG. 88) to an essentially centered orientation for the dual screen mode or may be tilted as needed via enclosure hinge 343.

FIG. 88 is an isometric view rear portion of dual screen desktop pedestal apparatus 340 of FIG. 87. Primary enclosure 341 is hingely attached to pedestal column 347 via enclosure hinge 343. Support plate 344 may be molded and be a part of the shape of primary enclosure 341. It clamps, strengthens, and supports the back of primary enclosure 341. Power and video connections may be mounted on primary enclosure 341, pedestal column 347, support plate 344, or pedestal 346. If connections are mounted on pedestal column 347 or pedestal 346 cabling will be routed inconspicuously to primary enclosure 341 in the sense that the power supply connectors are not shown. Located at rear of pedestal 346 are electronics connectors 345 which allow audio signals, video signals and power supply connections. Also shown at rear of support plate 344 is guiderail assembly 342 which permits user to essentially center display enclosures 341, 22 relative to pedestal column 347 for the single screen or dual screen modes. Slidably received by guiderail assembly 342 is enclosure hinge 343 which permits primary enclosure 341 to be tilted up or down by the user. Pedestal column 347 may be rotated to suit the user's preference. Dual screen desktop pedestal apparatus 340 may function as a single screen or dual screen with the video card(s) associated or mounted with the PC tower or contained in the apparatus. Wireless circuitry may be integrated into dual screen desktop pedestal apparatus 340. Video and status signals may be relayed wirelessly and the apparatus may be configured to function as a network addressable display(s). Secondary enclosure 22 of dual screen desktop pedestal apparatus 340 may be extended or opened manually or by means of motors similar to the motorized dual screen apparatus shown in FIGS. 73-80.

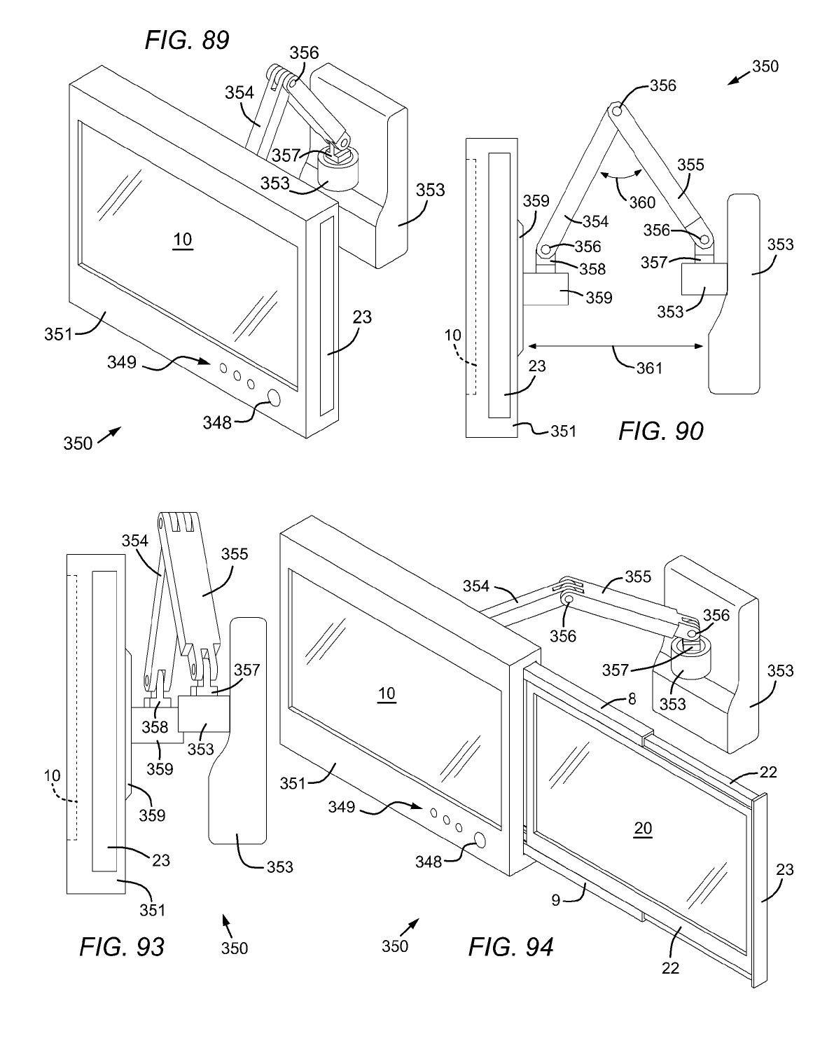

FIG. 89 is an isometric view example of dual screen wall mounted apparatus 350. With reference to FIG. 89, primary enclosure 351 is connected to wall bracket 353 via first arm portion 354 and second arm portion 355 of the support arms assembly. The support arms assembly is comprised of first arm portion 354, second arm portion 355, the three hinge pins 356, and swivel hinges 357, 358. Hinge pin 356 connects first arm portion 354 and second arm portion 355 at one end. It connects second arm portion 355 to swivel hinge 357 which in turn is rotatably received by wall bracket 353. Hinge pin 356 also connects first arm portion 354 to swivel hinge 358 which in turn is rotatably received by enclosure bracket 359 as shown in FIG. 90. Also shown in FIG. 89 are status indicator lights 349 and power buttons 348 both function similarly to that shown in FIGS. 81-84. Secondary enclosure cover 23 seals off secondary enclosure 22 when in its closed position. In a single screen mode, primary display screen 10 may be used alone as a typical display screen to watch movies or videos.

FIG. 90 is a side view of dual screen wall mounted apparatus 350 of FIG. 89. Primary display enclosure 351 may be moved forward or backward relative to the user via hinge pin 356 as indicated by pivot direction arrow 360. In similar manner, the support arms may be retracted or extended laterally in back and forth motion as indicated by movement direction arrow 361.

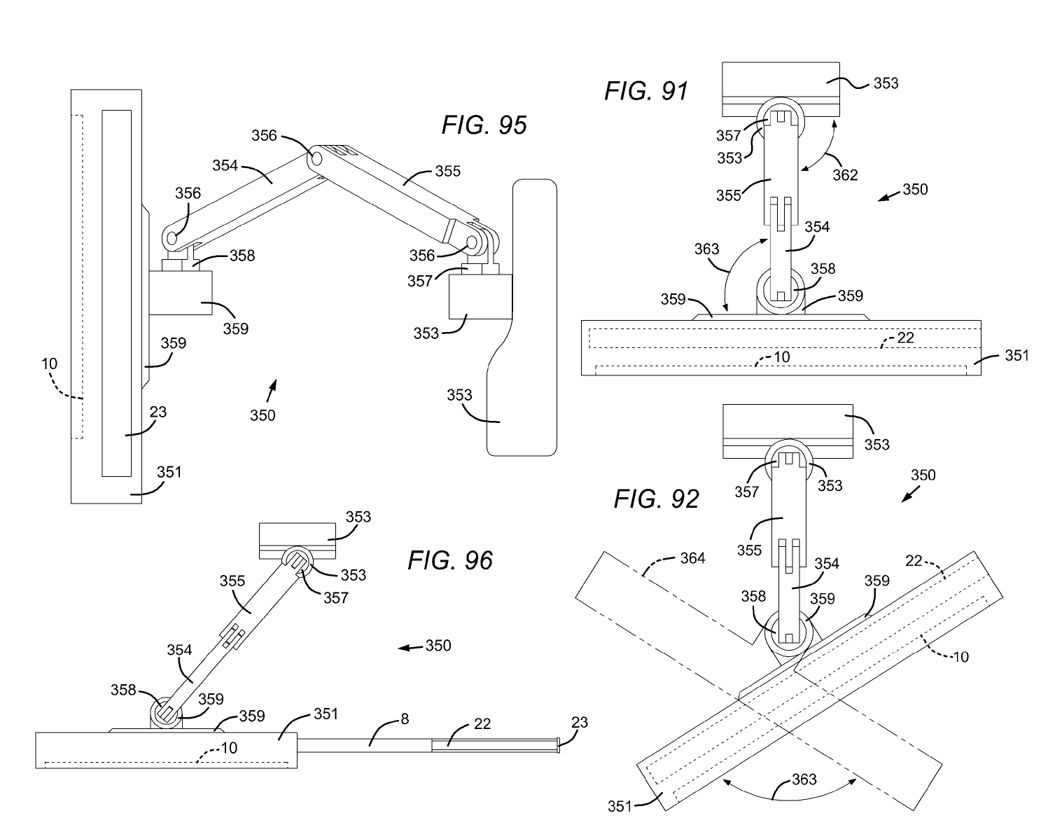

FIG. 91 is a top view of dual screen wall mounted apparatus 350 of FIG. 89. Swivel hinge 357 permits rotation of second arm portion 355 of the support arms assembly relative to wall bracket 353 essentially along rotation direction arrow 362 while swivel hinge 358 permits rotation of primary enclosure 351 relative to first arm portion 354 essentially along rotation direction arrow 363.

FIG. 92 is a top view of dual screen wall mounted apparatus 350 of FIG. 91 showing a rotation movement of primary enclosure 351. Phantom line representation 364 indicates the position of primary enclosure 351 and enclosure bracket 359 as primary enclosure 351 is rotated through swivel hinge 358 essentially along rotation direction arrow 363. Shown in hidden outline is the general or approximate position of secondary enclosure 22 within primary enclosure 351.

FIG. 93 is a side view of dual screen wall mounted apparatus 350 of FIG. 90 as it is compacted and pushed towards wall bracket 353. FIG. 93 shows the capacity of dual screen wall mounted apparatus 350 to be compacted as the support arms assembly is pushed towards wall bracket 353 which may be carried out either in the single screen or dual screen modes. Primary enclosure 351 is moved towards the left of the user to adjust primary display screen 10 for fine viewing in the single screen mode or to essentially center display enclosures 351, 22 relative to wall bracket 353 in the case of dual screen mode.

FIG. 94 is an isometric view of dual screen wall mounted apparatus 350 of FIG. 89 in a dual screen mode. Display enclosures 351, 22 are shown essentially centered relative to wall bracket 353. In this position, display screens 10, 20 may be used as one display screen, for example, to post important announcements or instructions or they may be used as two discrete display screens with each screen, for example, having different contents or images.

FIG. 95 is a side view of dual screen wall mounted apparatus 350 of FIG. 94. The support arms are shown at an angle towards left as primary enclosure 351 is moved towards the user. In this position, primary enclosure 351 may also be tilted up or down via swivel hinge 358 to adjust primary display screen 10.

FIG. 96 is a top view of dual screen wall mounted apparatus 350 of FIG. 94. Secondary enclosure 22 is shown extended and essentially centered together with primary enclosure 351 relative to wall bracket 353 in a dual screen mode. Also shown is upper slider arm 8 (with lower slider arm 9 but not shown) holding secondary enclosure 22 and prevents it from being detached from the unit.

FIG. 97 is a perspective view of dual screen apparatus 370 as applied to a dashboard of a vehicle. As shown in FIG. 97, dual screen apparatus 370 is mounted to a dashboard of a vehicle and faces the driver or user in driver seat 378 or a passenger at right. Dual screen apparatus 370 is in a dual screen mode with secondary enclosure 372 shown fully extended in an operating position. Apparatus support post 376 and rotation stem 377 permit dual screen apparatus 370 with two degrees of freedom rotation. It may be rotated sideways and forward or backward essentially along vertical rotation axis 373 and horizontal rotation axis 374 respectively. Secondary enclosure 372 is friction fitted into primary enclosure 371 and may be pulled out and returned without the use of slider arms, secondary hinge assemblies or support arms, thus, secondary enclosure 372 may be narrower to permit some portion to be retained in primary enclosure 371. To store dual screen apparatus 370, secondary enclosure 372 is retracted to primary enclosure 371, and then the apparatus is pushed down to apparatus housing 375. Dual screen apparatus 370 is ideally used for example, in police cars when an instant data is needed that may easily be retrieved such as primary display screen 10 may contain the mug shots of a possible offender or suspect and secondary display screen 20 may contain relevant information or the individual's personal record. It may also be used in fire trucks, ambulances, vans, 18-wheeler trucks, commercials vehicles, and the like. Thus, the display screens may be used for examining data or watching movies.

FIG. 98 is a schematic front view of dual screen apparatus 380 showing secondary enclosure 382 within primary enclosure 381 without slider arms, hinge, or support arms. The width of secondary display screen 20 is smaller than primary display screen 10 (not shown) to permit portions of the left edge of secondary enclosure 382 to be retained in primary enclosure cavity 386 within primary enclosure 381 when secondary enclosure 382 is extended. Secondary enclosure 382 may be exited from primary enclosure 381 without the assistance of slider arms, secondary hinge assemblies, or support arms unlike in earlier examples of dual screen apparatuses. Secondary enclosure 382 is fitted in a precise way so that the tighter the fit the less likelihood it will wobble as it is extended. Primary enclosure 381 is hingely attached to base electronics housing 32 via primary enclosure hinge 14 which enables it to be rotated forward or backward.

FIG. 99 is a front schematic view of dual screen apparatus 380 of FIG. 98 as secondary enclosure 382 is extended. Secondary enclosure 382 has been moved essentially from phantom line representation edge of secondary enclosure at 383 to the other side along movement direction arrow 384 as its top and bottom edges slide through primary enclosure cavity 386. The friction may stop secondary enclosure 382 from falling off in the absence of slider arms, hinge assemblies, or support arms. The part retained within primary enclosure 381 prevents secondary enclosure 382 from being detached from the unit.

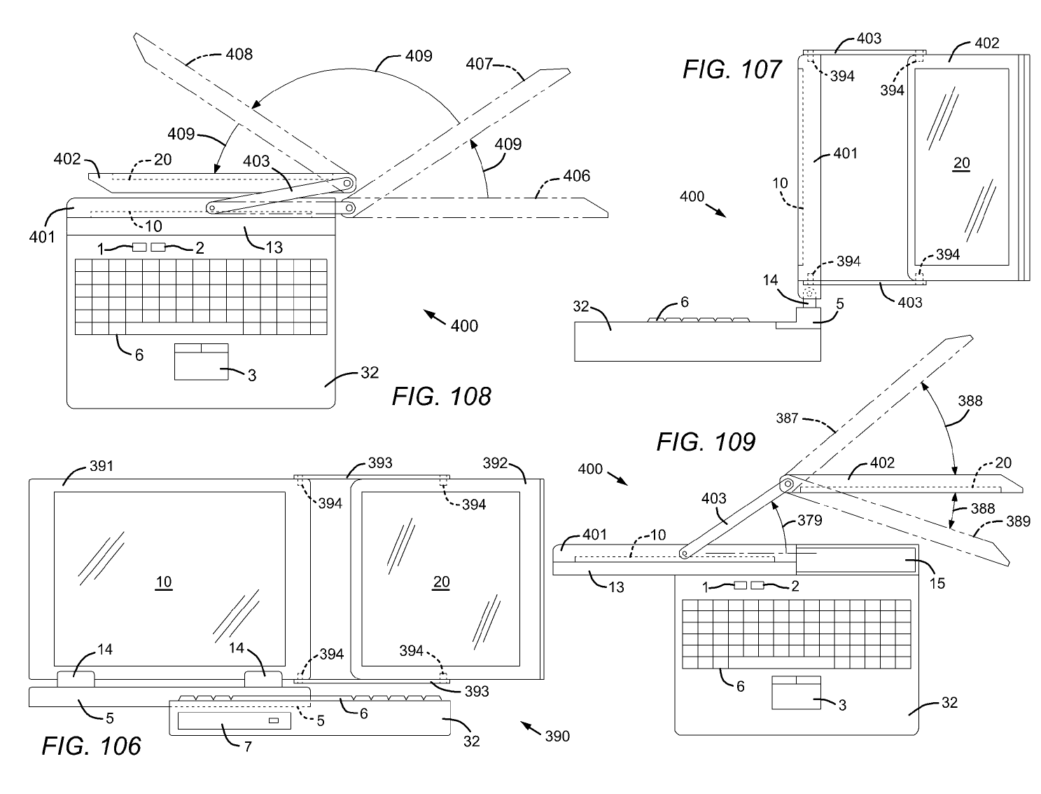

FIGS. 100-109 depict a dual screen apparatus with a guiderail assembly and a primary enclosure and secondary enclosure independent of each other in that the secondary enclosure is not enclosed by the primary enclosure, in accordance with the second preferred embodiment of the present invention. The two independent display enclosures are supported by an upper and lower secondary enclosure support arms. Two alternative mounting positions of the secondary enclosure support arms are described without affecting the functionality of the secondary enclosure. In FIGS. 100-103 and FIG. 106, the secondary enclosure support arms are attached at off-center of the secondary enclosure at one end and at the rightmost edge of the primary enclosure at the other end via the support arms hinge. In FIGS. 104-105 and FIGS. 107-109, the secondary enclosure support arms are attached at leftmost edge of the secondary enclosure at one end and at off-center of the primary enclosure at the other end via the support arms hinge. The primary enclosure is hingely attached to the guiderail assembly via the primary enclosure hinge (shown in FIGS. 106-107 only), similar to the dual screen apparatus shown in FIGS. 1-11.

Accordingly, FIG. 100 is a top view of dual screen apparatus 390 showing two independent display enclosures supported by secondary enclosure support arms 393 in a single screen mode. Upper and lower secondary enclosure support arms 393 are attached towards the right edge of primary enclosure 391 via support arms hinge pin 394 and the other end is attached off-center of secondary enclosure 392 and serves as its pivot point. In the top view representation, the right edge of secondary enclosure 392 has been chopped to distinguish it from the primary enclosure when it is rotated. In the single screen mode of dual screen apparatus 390, as in FIG. 100, secondary enclosure 392 is in parallel proximity and rests with primary enclosure 391 by means of a piggyback. Primary enclosure 391 is fully visible to the user. Secondary enclosure 392 may be swiveled to the right in preparation for its operating position as shown in FIG. 101. Shown in FIG. 100 is guiderail cover 13 of the guiderail assembly. Dual screen apparatus 390 has its own guiderail assembly that may facilitate movement of primary enclosure 391 to an essentially centered position along with secondary enclosure 392 in preparation for the dual screen mode as shown in FIG. 103. Power and signals for secondary enclosure 392 and secondary display screen 20 may be routed via secondary enclosure support arms 393 wirelessly or by using standard cabling or fiber optics approach.

FIG. 101 is a top view of dual screen apparatus 390 of FIG. 100 as secondary enclosure 392 is rotated in preparation for the dual screen mode. From its closed position in FIG. 100, as represented by phantom line representation 396, secondary enclosure 392 swivels towards the right via secondary enclosure support arms 393 with support arms hinge pin 394 as pivot point essentially along movement direction arrow 366, after which secondary enclosure 392 is rotated from phantom line representation 398 to phantom line representation 397 as indicated by rotation direction arrow 365, then rotated to an operating position essentially along movement direction arrow 366 in which secondary enclosure 392 is parallel to primary enclosure 391 and with secondary display screen 20 facing the user to prepare for the dual screen mode.

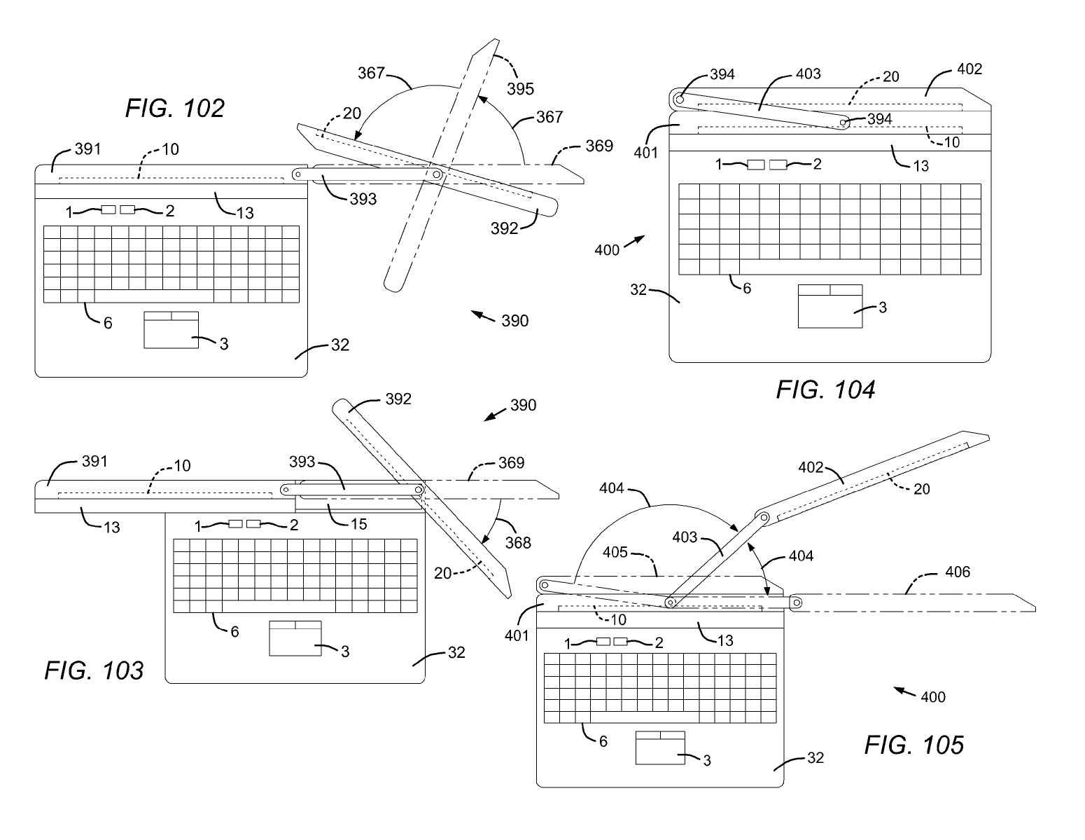

FIG. 102 is a top view of dual screen apparatus 390 of FIG. 101 as secondary enclosure 392 is rotated to face the rear of the user. FIG. 102 shows that secondary enclosure 392 may be rotated to make secondary display screen 20 face the back of the apparatus or the user. From its position in FIG. 101, as represented by phantom line representation 369, secondary enclosure 392 is rotated via support arms hinge pin 394 essentially along rotation direction arrow 367 to phantom line representation 395, thereat further rotated towards the left to permit secondary display screen 20 face the rear of the user. The rotation of secondary enclosure 392 is applied in instances, for example, when a user wants to show the contents of secondary display screen 20 to a person at the back while he is viewing primary display screen 10.

FIG. 103 is a top view of dual screen apparatus 390 of FIG. 101 as primary enclosure 391 is moved towards the left and secondary enclosure 392 is rotated to face user in a dual screen mode. From its position in FIG. 101 as represented by phantom line representation 369 secondary enclosure 392 may be rotated essentially along movement direction arrow 368 to make secondary display screen 20 face the towards the user at an angle as primary enclosure 391 is moved towards the left until reaching essentially its midpoint to the left side of base electronics housing 32 in preparation for centering the two display enclosures. In FIG. 103, display enclosures 391, 392 may be moved to the left or right to an essentially centered position relative to base electronics housing 32 for the dual screen mode.

FIG. 104 is a top view of dual screen apparatus 400 showing an alternative example of two independent display enclosures supported by secondary support arms 403 in a single screen mode. Secondary enclosure 402 is shown in parallel proximity with primary enclosure 401 by means of a piggyback similar to that shown in FIG. 100. Unlike in FIG. 100, secondary enclosure support arms 403 is attached towards leftmost edge of secondary enclosure 402 at one end and at off-center of primary enclosure 401 at the other end via support arm hinge 394. In FIG. 104, secondary enclosure support arms 403 may be designed with some tension such as a spring mechanism to hold secondary enclosure 402 in place or to function as a latching mechanism to secure secondary enclosure 402. Dual screen apparatus 400 is in a single screen mode in which primary display screen 10 is operational and faces the user while secondary display screen 20 is hidden from view.

FIG. 105 is a top view of dual screen apparatus 400 of FIG. 104 as secondary enclosure 402 is rotated in preparation for the dual screen mode. From its stored position in FIG. 104, as represented by phantom line representation 405, secondary enclosure 402 swivels towards the right via secondary enclosure support arms 403 essentially along movement direction arrow 404 until it reaches phantom line representation 406. The double movement direction arrow 404 indicates that secondary enclosure 402 has been rotated back from phantom line representation 406 in preparation for secondary display screen 20 to face towards the user or face the user's rear.

FIG. 106 is a front view of dual screen apparatus 390 of FIG. 103. In a dual screen mode, such as in FIG. 106, primary enclosure 391 has moved towards the left and secondary enclosure 392 has been rotated and angled facing the user. Display enclosures 391, 392 may be moved left or right via guiderail assembly 5 to an essentially centered position relative to base electronics housing 32.

FIG. 107 is a side view of dual screen apparatus 400 of FIG. 105. Secondary enclosure 402 is essentially halfway as it is rotated to either align with primary enclosure 401 facing the user in preparation for the dual screen mode as shown in FIG. 109 or to rotate facing the rear as shown in FIG. 108.

FIG. 108 is a top view of dual screen apparatus 400 of FIG. 105 as secondary enclosure 402 is rotated to face the rear. From its phantom line representation 406 as shown in FIG. 105, secondary enclosure 402 is rotated back along rotation direction arrow 409 to phantom line representation 407, thereat rotated further to phantom line representation 408, then finally rotated to align with the rear of primary enclosure 401 and secondary display screen 20 facing rear. Dual screen apparatus 400 is in single screen mode in the sense that only primary display screen 10 faces the user.

FIG. 109 is a top view of dual screen apparatus 400 of FIG. 108 as primary enclosure 401 is moved towards the left and secondary enclosure 402 is rotated to face the user in a dual screen mode. From its position in FIG. 108, secondary enclosure support arms 403 is rotated forward essentially along rotation direction arrow 379, thereat secondary enclosure 402 is rotated from phantom line representation 387 to phantom line representation 389 and then moved back essentially along movement direction arrow 388 such that secondary enclosure 402 is parallel to and facing the rear of primary enclosure 401 in a dual screen mode. The two display screens face towards the user in an essentially centered position relative to base electronics housing 32 as guiderail assembly 5 has moved primary enclosures 401 towards the left.

FIG. 110 is a top view of dual screen apparatus 410 showing another example two independent display enclosures connected by secondary enclosure hinge 413 in a single screen mode. Secondary enclosure 412 is folded at the back of primary enclosure 411 in a clam shell type design as secondary display screen 20 faces the rear and primary display screen 10 faces the user. Shown in FIG. 110 is primary enclosure clearance notch 418 which cuts into the right corner of primary enclosure 411 to permit secondary enclosure 412 to rotate beyond 180 degrees for the dual screen mode. Dual screen apparatus 410 is in single screen mode with reference to the user having access to only one display screen. Secondary enclosure hinge may be replaced by a swivel hinge similar to that shown in FIGS. 59-60, 62 thus, permitting secondary enclosure 412 with two degrees of freedom so it may be rotated sideways and forward or backward. When in dual screen mode, as shown in FIG. 113, secondary enclosure 412 may be rotated towards the back of primary enclosure 411 about 180 degrees so that display enclosures 411, 412 are back-to-back. In this position, secondary enclosure 412 may be converted to a tablet PC. A single swivel hinge may be sturdier and stronger than secondary enclosure hinge 413 and may have sufficient tension to hold secondary enclosure 412 and prevent it from being detached from the unit.

FIG. 111 is a top view of dual screen apparatus 410 of FIG. 110 as secondary enclosure 412 is rotated in preparation for dual screen mode. From its position in single screen mode as shown in FIG. 110 and represented by phantom line representation 416, secondary enclosure 412 is rotated via hinge 413 along secondary enclosure rotation direction arrow 415 essentially over 180 degrees to the right to phantom line representation 417, after which secondary enclosure 412 is rotated back for the dual screen mode. Primary enclosure 411 has also moved to the left via the guiderail assembly to essentially center display enclosures 411, 412 relative to base electronics housing 32. Primary enclosure clearance notch 418 permits secondary enclosure 412 to rotate beyond 180 degrees. Secondary enclosure phantom line representation 417 is angled relative to the user and may be rotated back to adjust secondary display screen 20 for fine viewing.

FIG. 112 is a side view of dual screen apparatus 410 of FIG. 110. Secondary enclosure 412 is shown hingely attached to primary enclosure 411 in a back-to-back relation. Secondary enclosure hinge 413 firmly secures secondary enclosure 412 and prevents it from being detached from the unit or from any wiggling movements.

FIG. 113 is a side view of dual screen apparatus 410 of FIG. 111. Secondary enclosure 412 is angled facing the user or to another person beside the user in the dual screen mode. It may be rotated to align with primary enclosure 411 so that the two display enclosures face the user essentially centered relative to base electronics housing 32 in dual screen mode. As shown in FIG. 113, primary enclosure clearance notch 418 creates a space that permits secondary enclosure 412 to rotate further towards user.

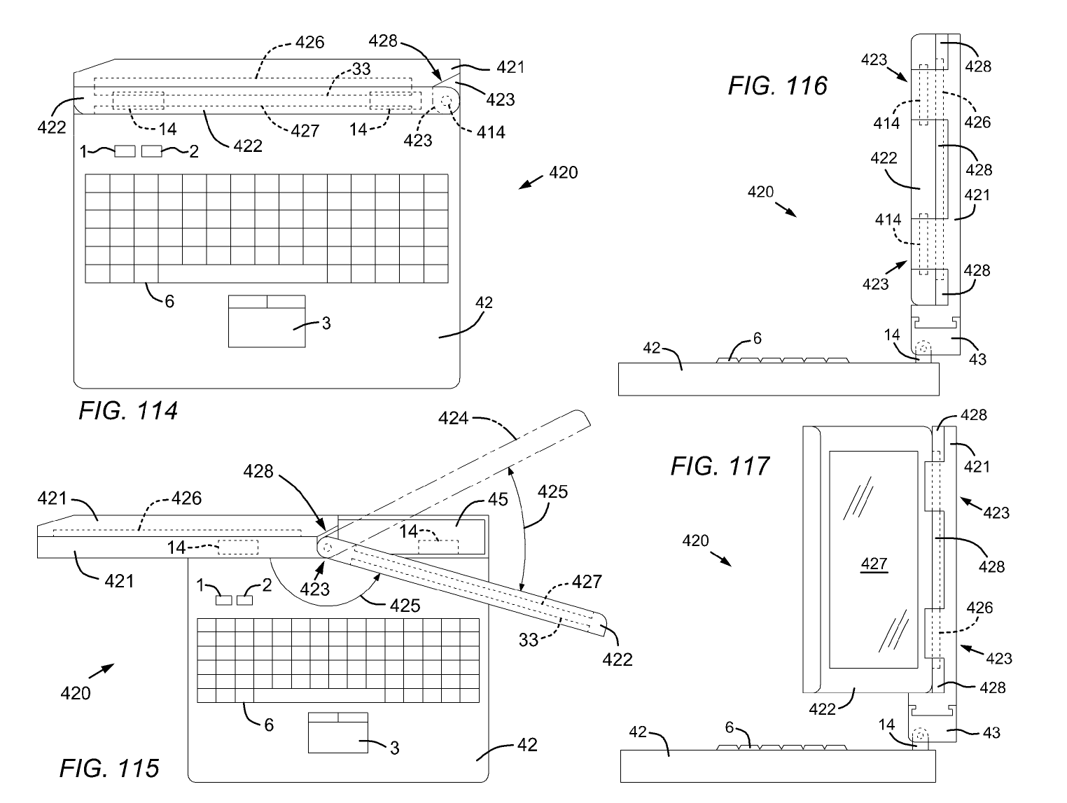

FIG. 114 is a top view of triple screen apparatus 420 incorporating second display enclosure 422 with two display screens and first display enclosure 421 with one display screen. Second display enclosure 422 is shown folded to the front of first display enclosure 421. Two display screens are fixedly attached back-to-back of second display enclosure 422 which are second display screen 427 facing the user and tertiary display screen 33 in a face-to-face relation with first display screen 426. Triple screen apparatus 420 of FIG. 114 is in single screen mode in that only one display screen, that is, second display screen 427, is facing the user. Second display enclosure hinge 423 permits second display enclosure 422 to be rotated to an operating position. Second display enclosure 422 may work with only one display screen facing either side.

FIG. 115 is a top view of triple screen apparatus 420 of FIG. 114 as second display enclosure 422 is rotated in preparation for the dual screen mode or triple screen mode. Second display enclosure 422 is rotated away from the user essentially along secondary enclosure rotation direction arrow 425 to second display enclosure phantom line representation 424, thereat may be rotated back towards the user angled as first display enclosure 421 is moved towards the left via the guiderail assembly to adjust the two display enclosures essentially centered relative to base electronics housing 42 for the dual screen mode. In this position, second display enclosure 422 projects its rear second display screen 427 for an audience facing the user. In a triple screen mode, the three display screens function simultaneously with first display screen 426 and tertiary display screen 33 facing the user while second display screen faces the rear. The user may switch to a dual screen mode by using first display screen 426 and tertiary display screen 33 only. First display enclosure clearance notch 428, which is a surface and a part of first display enclosure 421 located at its right edge, permits second display enclosure 422 to be rotated essentially over 180 degrees.

FIG. 116 is a side view of triple screen apparatus 420 of FIG. 114. First display enclosure 421 and second display enclosure 422 are shown flushed. Second display enclosure 422 contains two display screens located at its front and at its rear. In the single screen mode, second display enclosure 422 provides second display screen 427 (not shown) for the user. Shown is first display enclosure clearance notch 428 that permits first display enclosure to rotate approximately 180 degrees.

FIG. 117 is a side view of triple screen apparatus 420 of FIG. 115. As shown in FIG. 117, second display screen 427 faces the rear right portion of base electronics housing 42. In hidden outline is first display screen 426 facing the user. Another display screen, tertiary display screen 33 (not shown) also faces the user; hence, triple screen apparatus 420 is in a dual screen mode. Second display enclosure hinge 423 connects to second display enclosure 422 and permits it to be rotated essentially over 180 degrees.

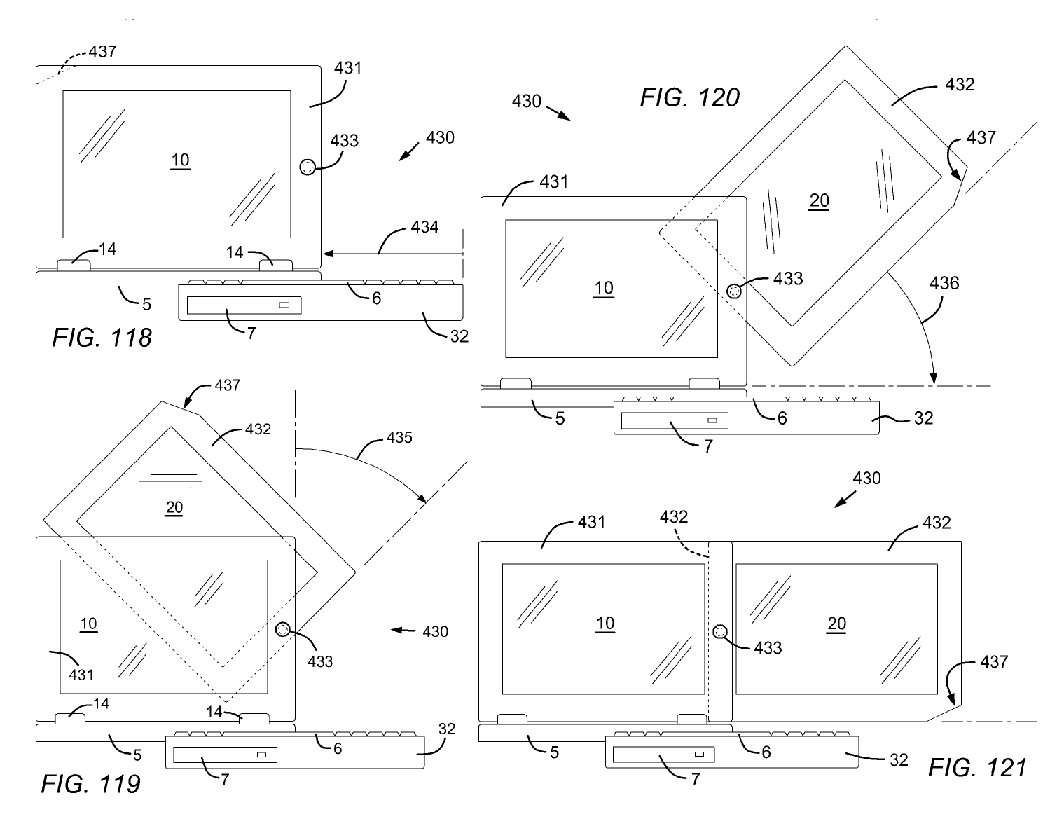

FIGS. 118-122 illustrates a dual screen apparatus with two independent display enclosures with the secondary enclosure connected to the primary enclosure via a secondary enclosure hinge which also functions as the secondary enclosure's pivot point. The secondary enclosure sits behind primary enclosure in single screen mode and the former may be rotated essentially 180 degrees for the dual screen mode.

FIG. 118 is a schematic front view of dual screen apparatus 430 showing two independent enclosures connected by secondary enclosure hinge 433 and progression of secondary enclosure 432 rotated from single screen to dual screen mode. Dual screen apparatus 430 is in single screen mode with primary display screen 10 facing the user. Secondary enclosure 432 (shown in FIGS. 119-122) sits flushed and aligned with the edge of primary enclosure 431 regardless of whether in single screen mode as in FIG. 118 or in dual screen mode as in FIG. 121. Secondary enclosure hinge 433 may have some tension or pressure to strengthen its hold on secondary enclosure 432 so it will not drop due to gravity. The enclosure casing may catch secondary enclosure 432 and secure it with a hook, an indent or similar latching device in a single screen mode. The hook (not shown), for example, may stop secondary enclosure 432 from falling. Shown in FIG. 118 is wedge-shaped notch 437 located at upper left corner of secondary enclosure 432 and may be seen to rotate down to lower right corner of dual screen apparatus 430 as shown in FIG. 121. Guiderail movement direction arrow 434 indicates the length traveled by guiderail assembly 5 towards the left in preparation for the dual screen mode. Primary enclosure 431 is shifted towards the left in preparation for the opening of secondary enclosure 432 and centering of the two display enclosures.

FIG. 119 is a schematic front view of dual screen apparatus 430 of FIG. 118 as secondary enclosure 432 is rotated essentially 45 degrees. In the single screen mode, such as in FIG. 118, secondary enclosure 432 is aligned behind primary enclosure 431, the former is rotated towards the right via secondary enclosure hinge 433 essentially at 45 degrees as indicated by secondary enclosure rotation direction arrow 435.

FIG. 120 is a schematic front view of dual screen apparatus 430 of FIG. 119 as secondary enclosure 432 is further rotated essentially 90 degrees from its position in FIG. 119. From its position in FIG. 119, secondary enclosure 432 is further rotated to essentially 90 degrees. Secondary enclosure rotation direction arrow 436 indicates secondary enclosure 432 rotation to a final position or the last 45-degree turn from the top edge to the dual screen mode where secondary enclosure 432 is effectively upside down. Also shown are display enclosures 431, 432 moving towards left via guiderail assembly 5 to essentially center the two display enclosures relative to base electronics housing 32 for the dual screen mode.

FIG. 121 is a schematic front view of dual screen apparatus 430 of FIG. 120 in a dual screen mode. Display enclosures 431, 432 are essentially centered relative to base electronics housing 32 and face towards the user in a dual screen mode. Secondary enclosure 432 is shown fully exposed and the edges of display enclosures 431, 432 are flushed. Display screens 10, 20 terminate without overlapping. Wedge-shaped notch 437 is shown at lower right edge of secondary enclosure 432 from its single screen mode position at upper left edge as shown in FIG. 118. The position in FIG. 121 indicates secondary enclosure 432 has essentially been rotated upside down.

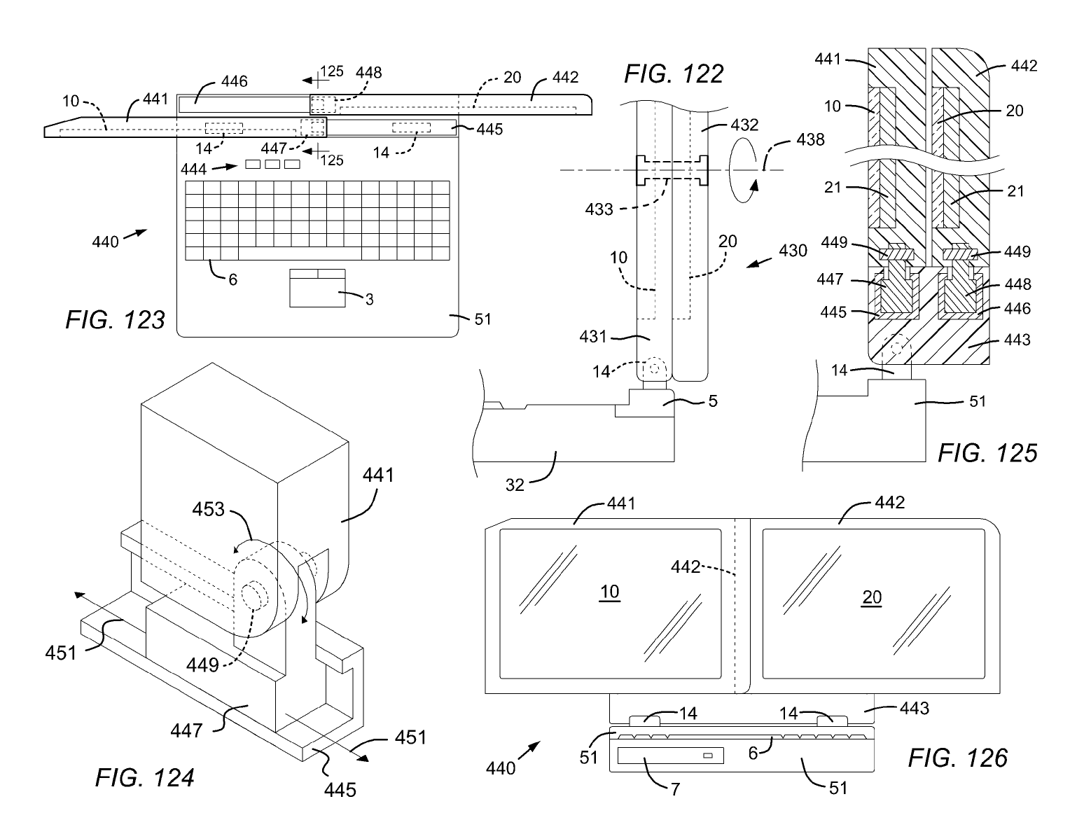

FIG. 122 is a partial schematic side view of dual screen apparatus 430 of FIG. 118 showing secondary enclosure hinge 433 in relation to display enclosures 431, 432. Secondary enclosure hinge 433 connects secondary enclosure 432 to primary enclosure 431 and serves as the pivot point with one degree of freedom. Secondary enclosure 432 may be rotated essentially along secondary enclosure hinge rotation direction axis 438. Although the manner of rotating secondary enclosure 432 to effect a dual screen mode from the single screen mode is accomplished by a simple rotation movement via secondary enclosure hinge 433, a swivel hinge similar to that shown in FIGS. 59-60, 62 may replace secondary enclosure hinge 433 thus, permitting secondary enclosure 432 with two degrees of freedom. The swivel hinge enables secondary enclosure 432 to be rotated sideways and forward or backward. When in a dual screen mode, as shown in FIG. 121, secondary enclosure 432 may be rotated towards the back of primary enclosure 431 via the swivel hinge at about 180 degrees so that the two display enclosures are back-to-back. In this position, secondary enclosure 432 may be converted to a tablet PC.

FIGS. 123-134 illustrate examples of a dual screen apparatus incorporating two independent display enclosures that are moved via enclosure slide hinges along two adjacent guiderails, in accordance with the third preferred embodiment of the present invention. The two display enclosures are attached to their respective enclosure slide hinges which consist of a hinge mechanism mounted on a slide. It allows the two display enclosures with two degrees of freedom to move laterally back and forth along its rail or to be rotated. The enclosure slide hinges may conduct electricity and transmit or receive data from the base electronics housing and transmit it to the display screens either through wired or wireless connection.

Accordingly, FIG. 123 is a top view of dual screen apparatus 440 incorporating primary enclosure 441 and secondary enclosure 442 with respective enclosure slide hinges 447, 448 that are slidably received by adjacent enclosure rails 445, 446 in a dual screen mode. In a dual screen mode, primary enclosure 441 and secondary enclosure 442 are essentially centered, the same with their respective enclosure slide hinges 447, 448 relative to base electronics housing 51. Display screens 10, 20 are available and face the user. Also shown is one or more function buttons 444 comprised of a group of function buttons which, for example, permit supply of power to the apparatus through on/off button, provide motorized movement of a specific guiderail assembly whether for the primary enclosure or secondary enclosure or for both, or provide viewing toggle among viewing display modes such as in the orientation of images shown on the display screens and how the display screens function in relation to each other.

FIG. 124 is partial isometric view showing details of primary enclosure slide hinge 447 and its adjacent parts. In the isometric representation, primary enclosure 441 is slidably and rotatably attached to primary enclosure slide hinge 447 via hinge pin 449. Primary enclosure slide hinge 447 in turn, is slidably received by primary enclosure rail 445 and permits the former to slide along the rail surface back and forth as indicated by primary enclosure slide movement direction arrow 451. Primary enclosure 441 may be pivoted or rotated via primary enclosure slide hinge 447 essentially in the direction shown by primary enclosure rotation direction arrow 453. The rear and bottom portions of primary enclosure rail 445 is shown while the other half is not included to show clearly the detail assembly of the four elements shown. Primary enclosure slide hinge 447 is shown like a hinge that is integrated into a slide as one unit.

FIG. 125 is a partial schematic cross sectional view of dual screen apparatus 440 showing elements above primary enclosure hinge 14 including primary enclosure slide hinge 447 and secondary enclosure slide hinge 448 taken along lines 125-125 of FIG. 123. Enclosure slide hinges 447, 448 are shown slidably received by primary enclosure rail 445 and secondary enclosure rail 446 respectively. Display enclosures 441, 442 may have a gap in between the sides or some parts may be touching to prevent vibration.

FIG. 126 is a schematic front view of dual screen apparatus 440 of FIG. 123 showing display enclosures 441, 442 both horizontally oriented in a dual screen mode. For purpose of illustration, primary enclosure hinge 14 is raised relative to base electronics housing 51. Normally, primary enclosure hinge 14 sits on the same surface as keyboard 6. The edges of primary enclosure 441 is chopped at upper left corner and rounded at lower right corner while the edges of secondary enclosure 442 is rounded at upper right corner and also rounded at lower left corner to distinguish the two display enclosures in their different positions.

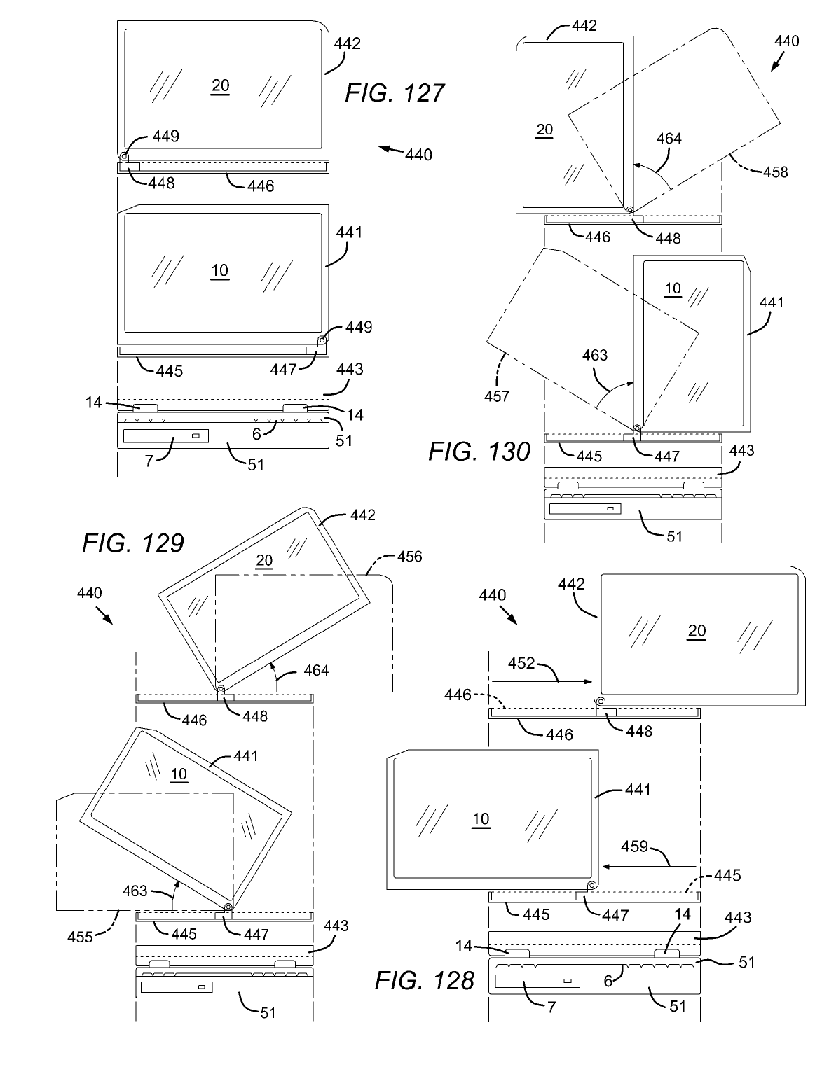

FIGS. 127-128 are partially exploded schematic front views of dual screen apparatus 440 of FIG. 126 progression as display enclosures 441, 442 are moved from a single screen mode to dual screen mode in horizontal or landscape orientation. The exploded views of dual screen apparatus 440 consists of two parts: primary enclosure 441 which shows primary enclosure slide hinge 447 mounted at the enclosure's right edge and primary enclosure rail 445 at its bottom, and secondary enclosure 442 which shows secondary enclosure slide hinge 448 mounted at its left edge and secondary enclosure rail 446 at its bottom. In the single screen mode, as in FIG. 127, only primary display screen 10 is visible and faces towards the user. Secondary display screen 20 is hidden at the back of primary enclosure 441. Accordingly, in FIG. 128, both display enclosures 441, 442 and enclosure slide hinges 447, 448 are essentially at center in a dual screen mode in horizontal or landscape orientation. In FIG. 128, primary enclosure 441 slides to the left via primary enclosure slide hinge 447 essentially along primary enclosure slide movement direction arrow 459 and secondary enclosure 442 slides in the opposite direction to the right essentially along secondary enclosure slide movement direction arrow 452. In the dual screen mode, display enclosures 441, 442 and their respective enclosure slide hinges 447, 448 are essentially centered relative to base electronics housing 51. Display enclosures 441, 442 are also horizontally oriented or in a landscape orientation similar to that shown in FIG. 126.

FIGS. 129-130 are partially exploded schematic front views of dual screen apparatus 440 of FIG. 128 progression as display enclosures 441, 442 are rotated for the dual screen mode in vertical or portrait orientation. From the position in FIG. 128, in which display enclosures 441, 442 are horizontally oriented or in a landscape orientation, the two display enclosures are rotated via their respective enclosure slide hinges 447, 448. In FIG. 129, primary enclosure 441 is rotated about 45 degrees to the right as indicated by primary enclosure rotation direction arrow 463 and secondary enclosure 442 is rotated about 45 degrees to the left as indicated by secondary enclosure rotation direction arrow 464. The positions of display enclosures 441, 442 in FIG. 128 are depicted in phantom line representations at 455, 456 respectively. With reference to FIG. 130, display enclosures 441, 442 are rotated further at about 45 degrees to the right and to the left respectively such that the two display enclosures are essentially vertically oriented or in portrait orientation in a dual screen mode. In this position, display enclosures 441, 442 are essentially centered relative to base electronics housing 51.

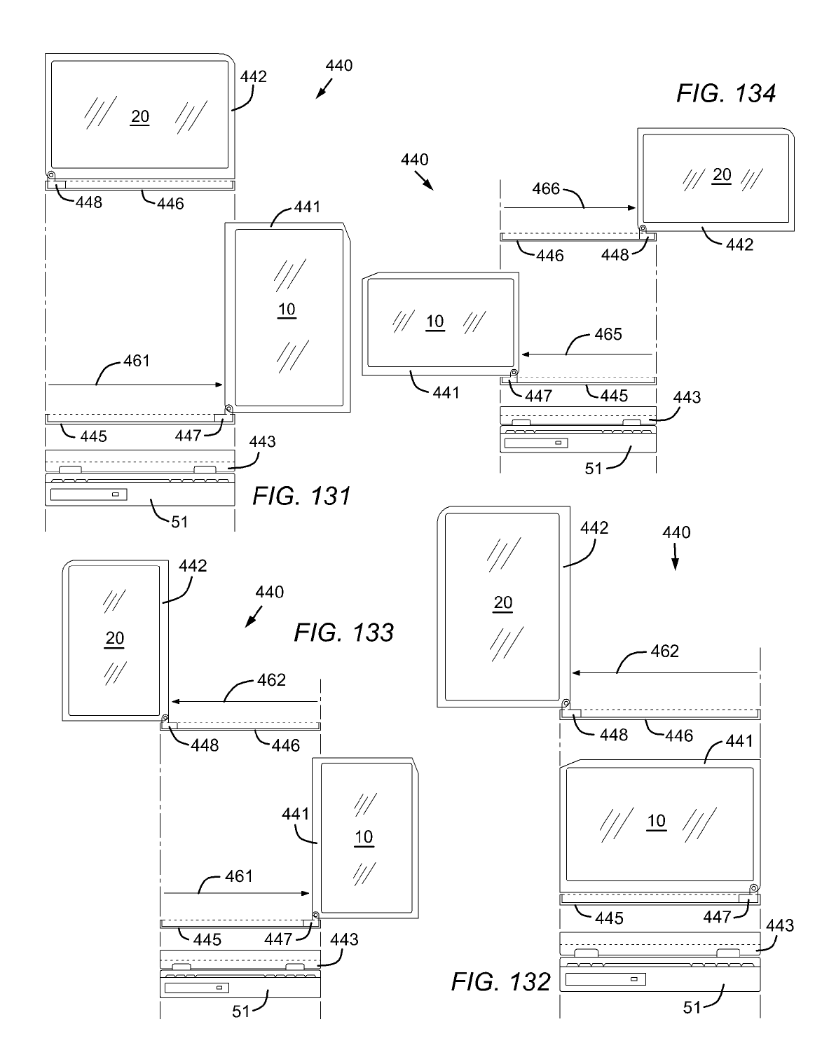

FIG. 131 is a partially exploded schematic front view of dual screen apparatus 440 of FIG. 127 and FIG. 130 in which secondary enclosure 442 is horizontally oriented and primary enclosure 441 is vertically oriented in a dual screen mode. The horizontal or landscape orientation of secondary enclosure 442 in FIG. 127 is retained while the vertical or portrait orientation of primary enclosure 441 of FIG. 130 is moved via primary enclosure slide hinge 447 essentially to its maximum point to the right of base electronics housing 51 as indicated by primary enclosure slide movement direction arrow 461. The dual screen mode of FIG. 131 may be described as a combination of secondary enclosure 442 in horizontal or landscape orientation essentially centered relative to base electronics housing 51, and primary enclosure 441 in vertical or portrait orientation, with primary display screen 10 essentially beyond the right side portion of base electronics housing 51. The electronics and the images follow the orientation of the respective display screens. In this position, the user for example, may use secondary display screen 20 as a typical display screen while primary display screen 10 may be used as a special display screen to match the image or the text such as when the image is essentially vertical to achieve maximum view.

FIG. 132 is a partially exploded schematic front view of dual screen apparatus 440 of FIG. 127 and FIG. 130 in which primary enclosure 441 is horizontally oriented and secondary enclosure 442 is vertically oriented in a dual screen mode. The horizontal or landscape orientation of primary enclosure 441 in FIG. 127 is retained while the vertical or portrait orientation of secondary enclosure 442 of FIG. 130 is moved via secondary enclosure slide hinge 448 essentially to its maximum point to the left of base electronics housing 51 as indicated by secondary enclosure slide movement direction arrow 462. The dual screen mode of FIG. 132 is a combination of primary enclosure 441 in horizontal or landscape orientation essentially centered relative to base electronics housing 51, and secondary enclosure 442 in vertical or portrait orientation, with primary display screen 10 essentially beyond the left side portion of base electronics housing 51 at left portion. The electronics and the images follow the orientation of the respective display screens.

FIG. 133 is a partially exploded schematic front view of dual screen apparatus 440 of FIG. 130 in which display enclosures 441, 442 are vertically oriented as secondary enclosure 442 is moved farther left and primary enclosure 441 is moved farther right in a dual screen mode. From the vertical or portrait orientation of display enclosures 441, 442 as shown in FIG. 130, secondary enclosure 442 is moved via secondary enclosure slide hinge 448 essentially to its maximum point to the left as indicated by secondary enclosure slide movement direction arrow 462 and primary enclosure 441 is likewise moved via primary enclosure slide hinge 447 essentially to its maximum point to the right as indicated by primary enclosure slide movement direction arrow 461. In the dual screen mode, such as in FIG. 133, a space in between display enclosures 441, 442 is created which may be used to view or monitor an activity such as in a factory or assembly line while using the two display screens. The dual screen mode of FIG. 133 consists of two display screens in portrait orientation located essentially at opposite left and right edges of base electronics housing 51, thus, creating a space in the center of base electronics housing 51.

FIG. 134 is a partially exploded schematic front view of dual screen apparatus 440 of FIG. 128 in which display enclosures 441, 442 are horizontally oriented as secondary enclosure 442 is moved farther right and primary enclosure 441 is moved farther left in a dual screen mode. From their horizontal or landscape orientation of FIG. 128, secondary enclosure 442 is moved via secondary enclosure slide hinge 448 essentially to its maximum point to the right of base electronics housing 51 as indicated by secondary enclosure slide movement direction arrow 466, and primary enclosure 441 is moved via primary enclosure slide hinge 447 essentially to its maximum point to the left of base electronics housing 51 as indicated by primary enclosure slide movement direction arrow 465. The position of the two display enclosures in FIG. 134 is similar to that of FIG. 133 in that a space in between them is created which may be used to view or monitor an activity such as in an assembly line. The dual screen mode of FIG. 134 consists of two display screens in horizontal or landscape orientation located essentially at opposite left and right ends of base electronics housing 51 and creating a space in between display enclosures 441, 442.

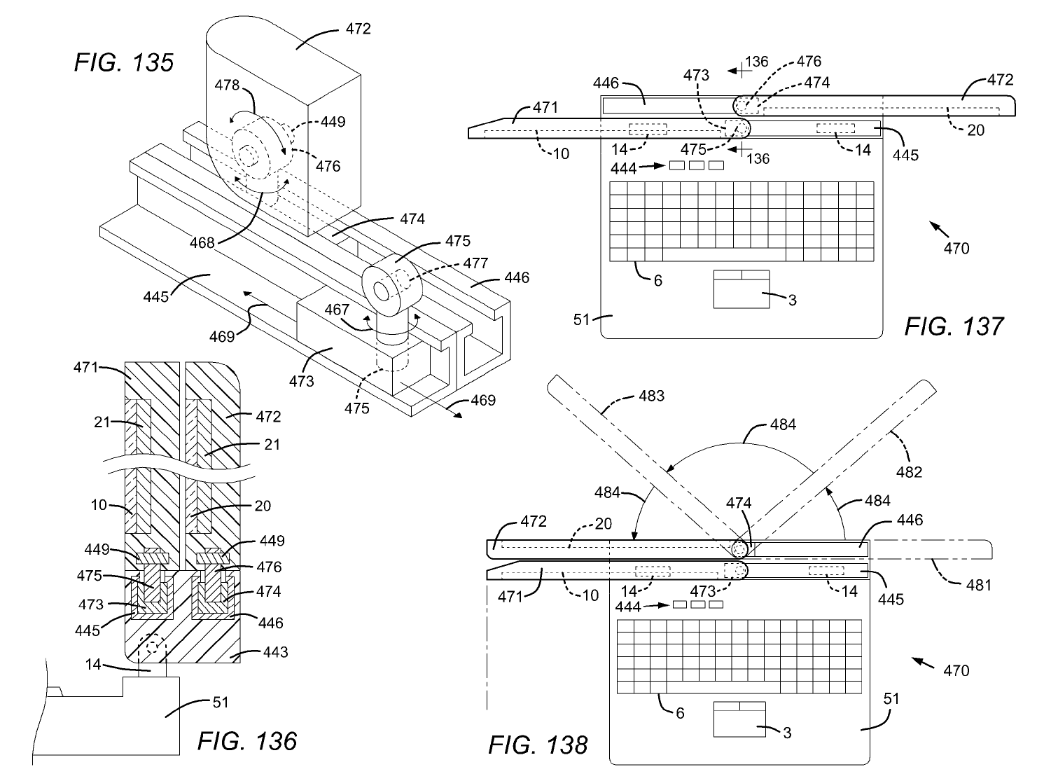

FIG. 135 is a partial isometric view showing relationship of primary enclosure swivel hinge 475 and secondary enclosure swivel hinge 476 and associated guiderail components. Primary enclosure swivel hinge 475 is rotatably attached to primary enclosure slide 473 which in turn is slidably received by primary enclosure rail 445. Secondary enclosure swivel hinge 476 is rotatably attached to secondary enclosure slide 474 which in turn is slidably received by secondary enclosure slide 446. The swivel hinge permits the two enclosures to have three degrees of freedom. In FIG. 135, secondary enclosure 472 may be pivoted or rotated via secondary swivel hinge 476 to the left or right and sideways as shown by secondary enclosure swivel rotation direction arrow 468 and secondary enclosure swivel rotation direction arrow 478 respectively. Primary enclosure swivel hinge 475 may be moved via primary enclosure slide 473 back and forth as indicated by primary enclosure slide movement direction arrow 469. Also shown is hole 477 of primary enclosure swivel hinge 475, the former receives hinge pin 449 (not shown).

FIG. 136 is a schematic cross sectional view of primary enclosure 471 and secondary enclosure 472 of dual screen apparatus 470 taken along lines 136-136 of FIG. 137. Shown are primary enclosure swivel hinge 475 rotatably attached to primary enclosure slide 473, and secondary enclosure swivel hinge 476 rotatably attached to secondary enclosure slide 474. Enclosure slides 473, 474 are in turn slidably received by enclosure rails 445, 446 respectively.

FIG. 137 is a schematic top view of dual screen apparatus 470 incorporating enclosure swivel hinges 475, 476 rotatably attached to enclosure slides 473, 474 in a dual screen mode. Dual screen apparatus 470 is in a dual screen mode in which display enclosures 471, 472 and enclosure swivel hinges 475, 476 are essentially centered relative to base electronics housing 51. Primary display screen 10 and secondary display screen 20 are both available and face toward the user. Also shown are primary enclosure rail 445 and secondary enclosure rail 446 which slidably receive enclosure slides 473, 474 respectively.

FIG. 138 is a schematic top view of dual screen apparatus 470 of FIG. 137 progression as secondary enclosure 472 is rotated from the dual screen mode to the single screen mode in which secondary display screen 20 faces the rear. From the dual screen mode, as depicted in FIG. 137, secondary enclosure 472 is rotated towards the left to the back of primary enclosure 471 via secondary enclosure swivel hinge 476 essentially at 180 degrees along secondary enclosure rotation direction arrow 484. Phantom line representation 481 indicates the position of secondary enclosure 472 in the dual screen mode. The intervening positions of secondary enclosure 472 as it is rotated towards the back of primary enclosure 471 is shown by phantom line representations 482, 483. The phantom line representations show progression as secondary enclosure 472 is rotated 180 degrees to the left to face opposite direction, that is, from facing user to facing the opposite direction. Secondary enclosure rotation direction arrow 484 indicates that secondary enclosure 472 has rotated 180 degrees from phantom line 481 where it faces the user to its final position in FIG. 138 facing the back. Primary enclosure 471 remains stationary from its position in FIG. 137 as secondary enclosure 472 is shown folded at its back with secondary display screen 20 facing the rear. Primary enclosure 471 may still swivel a few degrees to improve the contrast of primary display screen 10. If primary enclosure 471 is rotated 180 degrees to the right (not shown), there would be two display enclosures facing the back. Hence, the two display screens may face the user's front or back at the same time.

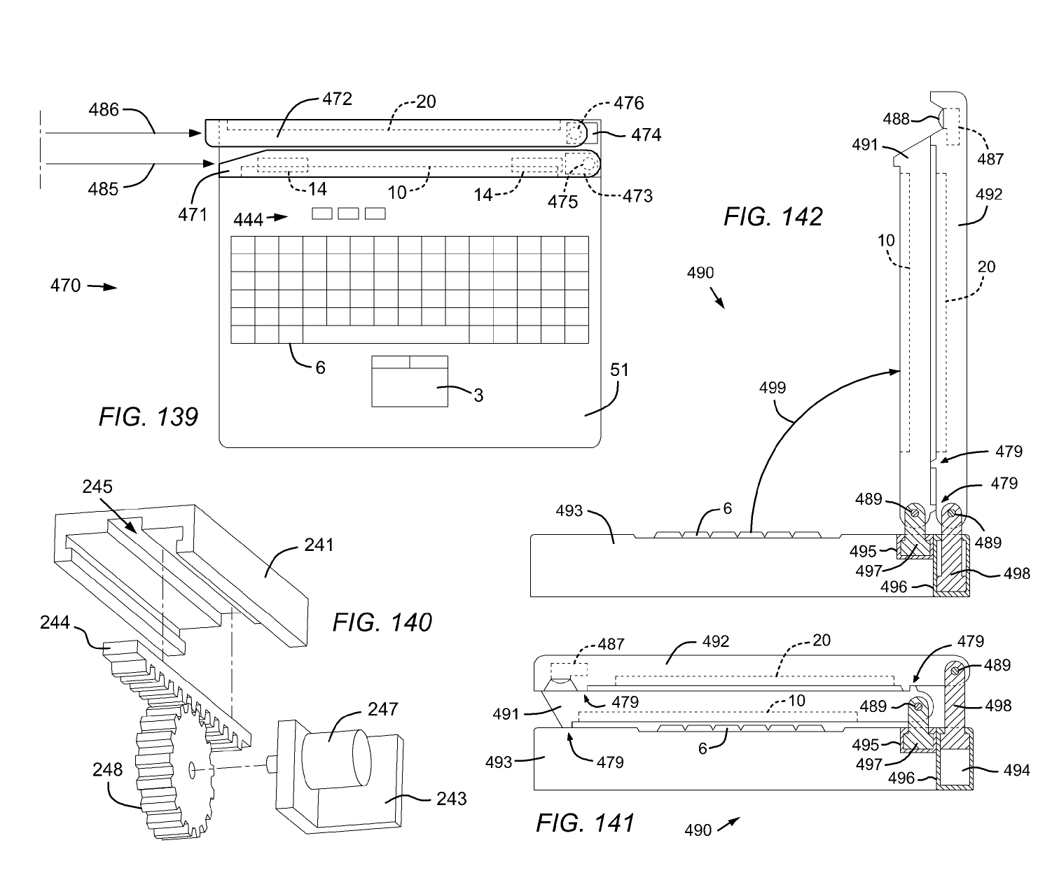

FIG. 139 is a schematic top view of dual screen apparatus 470 of FIG. 138 as display enclosures 471, 472 are pushed to the right to align with base electronics housing 51. Display enclosures 471, 472 are pushed while in their position in FIG. 138 when enclosure swivel hinges 475, 476 are essentially at center. Primary enclosure 471 faces the user while secondary enclosure 472 faces the rear in a single screen mode in the sense that only one display screen is available. Primary enclosure 471 traveled a shorter distance than primary enclosure 471 because of the space occupied by secondary enclosure slide 474 at the edge. Enclosure movement direction arrows 485, 486 indicate that display enclosures 471, 472 respectively had been pushed to align with base electronics housing 51. This set-up is ideal when a user is doing a presentation to several persons in front. There is no need for the audience to gather around the user to view the presentation.

FIG. 140 is an exploded view details of a direct drive motor 247. Direct drive motor 247 is typically a micro miniature direct drive motor or a stepper motor, such as for examples, the motor used in a bubble jet printer or an ultrasonic motor, as compared to the guiderail motor assembly 240 shown in FIG. 72 which does not imply a direct drive arrangement. In FIG. 140, direct drive motor 247 is fitted to motor mounting bracket 243 and coupled to rack 244 mounted on slide 241. Groove 245 receives rack 244; the latter is fixedly attached to groove 245 on slide 241. Groove 245 is specifically machined or molded to receive rack 244. Direct drive motor 247 engages with and rotates spur gear 248 producing linear motion from rotary motion. The round spur gear 248 or the pinion meshes with the teeth cut on a straight bar of rack 244. As the pinion (spur gear 248) rotates, it meshes with successive teeth in the rack, causing it to shift in a straight line and thus, move guiderail slide 241. Compared to guiderail motor assembly 240 as shown in FIG. 72, direct drive motor 247 has a higher torque and more powerful than the former. It has sufficient torque to move spur gear 248 without help.

FIG. 141 is a schematic side view of dual screen apparatus 490 incorporating two independent enclosures which may be folded as secondary enclosure slide 498 is lifted in a closed position. In a closed or folded position, an air gap is formed by rail cavity 494 as it permits secondary enclosure slide 498 to ride up. Secondary enclosure slide hinge 498 functions like a plunger when dual screen apparatus 490 is lifted or opened as it thrusts and rests at bottom of secondary enclosure rail 496 as shown in FIG. 142. The bottom parts of primary enclosure slide 497 and secondary enclosure slide 498 are of the same height when the apparatus is folded or in a closed position. Wedge-shaped molded tabs 479 are located and spaced between display enclosures 491, 492 and permit the two display enclosures to slide with each other's surfaces as molded tabs 479 restrict points of contact. Molded tabs 479 also assist in raising or lowering secondary enclosure slide 498 when the apparatus is in a folded or in an open position.

FIG. 142 is a schematic side view of dual screen apparatus 490 of FIG. 141 in an open position. Dual screen apparatus 490 is raised to an open upright position essentially along rotation direction arrow 499. Secondary enclosure 492 is taller than primary enclosure 491 whether in the single screen (shown) or dual screen mode. Camera module 487 with an embedded camera lens 488 is available to function as a typical digital camera, webcam, or camcorder. Hence, the top of primary enclosure 491 is inclined so it doesn't obscure the viewing angle of camera module 487.

FIG. 143 is a schematic cross sectional view of an apparatus with three display enclosures and a variation of a cross section of FIG. 136. Primary enclosure 500 is stationary essentially centered relative to base electronics housing 51 while secondary enclosure 501 is slid towards the left via secondary enclosure slide hinge 509 and tertiary enclosure 502 is slid towards the right via tertiary enclosure slide hinge 508. Thus, the three display screens may all face the user in a triple screen mode. Display enclosures 501, 502 are similar to that shown in FIG. 136 and may be rotated to a vertically oriented position similar to that shown in FIG. 133 or to a horizontally oriented position similar to that shown in FIG. 134. In both instances, primary enclosure 500 is essentially centered and horizontally oriented. Secondary enclosure slide hinge 509 and tertiary enclosure slide hinge 508 are not aligned but positioned on opposite edges of the unit. Slide hinges 509, 508 are slidably received by secondary enclosure rail 504 and tertiary enclosure rail 503 respectively.

FIG. 144 is a schematic cross sectional view of an apparatus incorporating three display enclosures with secondary enclosure 505 stationary and both primary enclosure 506 and tertiary enclosure 507 extendable via slider arms 87. The middle secondary enclosure 505 is stationary as primary enclosure 506 is extended to the left and tertiary enclosure 507 is extended to the right on the front and rear respectively of secondary enclosure 505 via slider arms 87 to effect an operating position. The two upper and lower slider arms 87 connect the three display enclosures which also prevent primary enclosure 506 and tertiary enclosure 507 from being detached when moved sideways. A guiderail assembly may be used to mount the three display enclosures to add flexibility.

FIG. 145 is a schematic cross sectional view of a dual screen apparatus incorporating combinations of primary enclosure 511 with primary enclosure slide hinge 514 and secondary enclosure 512 with slider arms 87. Primary enclosure 511 is slidable via primary enclosure slide hinge 514 from right to left along primary enclosure rail 513 while secondary enclosure 512 may be extended via upper and lower slider arms 87 from left to right. The third panel, enclosure support 510, functions as a cradle or holder for display enclosures 511, 512. A guiderail assembly may be used to mount the two display enclosures to add flexibility.

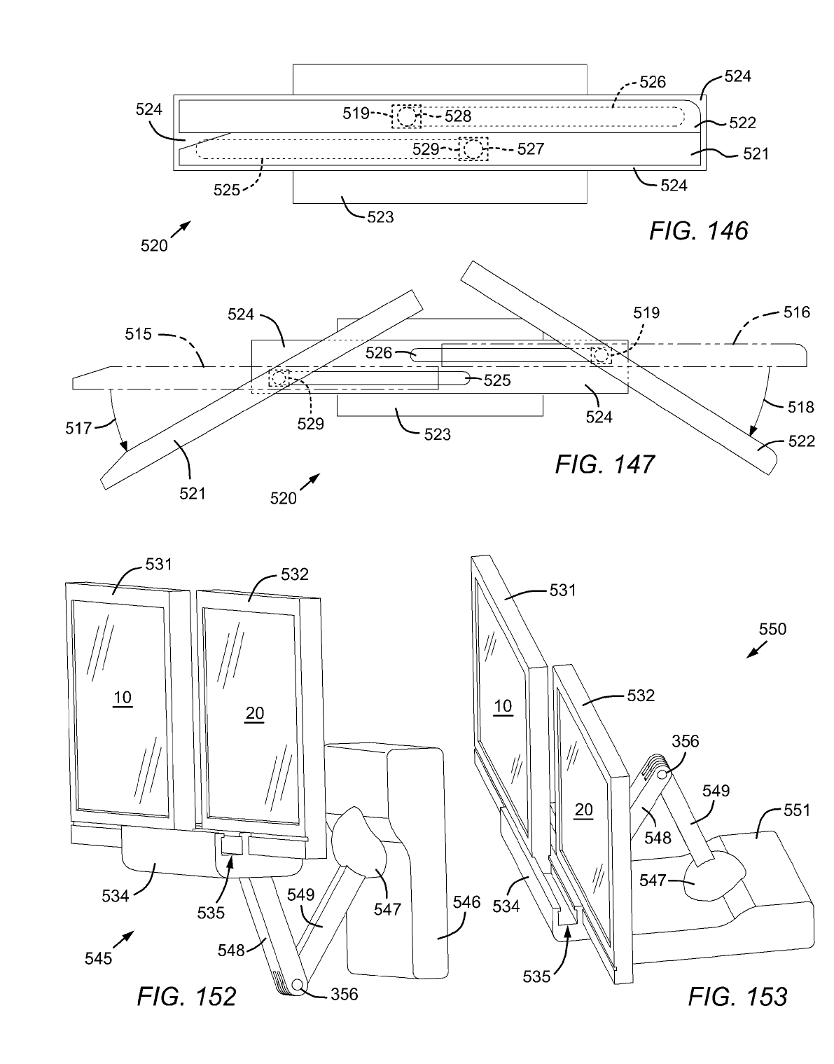

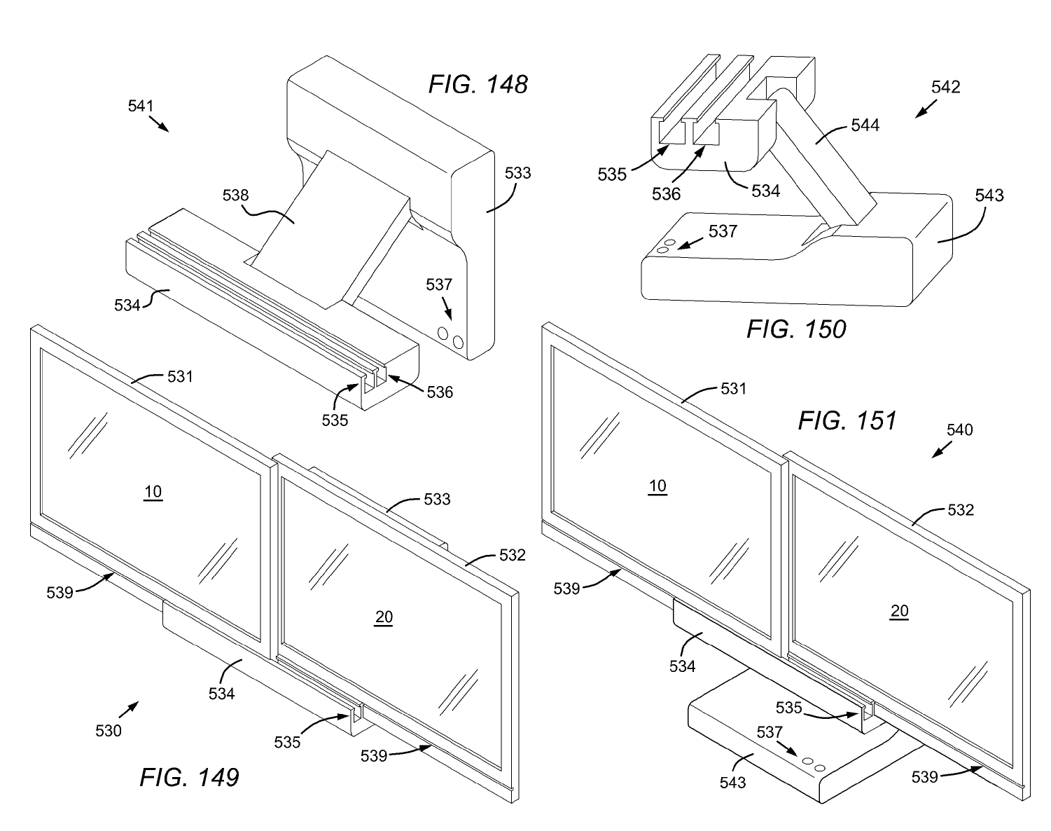

FIG. 146 is a schematic top view example of dual screen desktop apparatus 520 incorporating a pedestal 523 and guiderail assembly 524 with guiderail openings and shafts. Dual screen desktop apparatus 520 is suitable to be placed on a desk or stand. The base that holds guiderail assembly 524 located above pedestal 523 may be connected to a column similar to that shown in FIGS. 87-88. Guiderail assembly 524 may be wall mounted similar to that shown in FIG. 148 or attached to a pedestal directly or supporting a column similar to that shown in FIGS. 87-88. Guiderail assembly 524 houses primary enclosure guiderail opening 525 and secondary enclosure guiderail opening 526 and provides the display enclosures for the two guiderail openings. Additionally, it elevates the two display enclosures from pedestal 523. It may contain electronics connectors, video connectors, power circuitry and power point connector requirements for the two display screens. Primary enclosure shaft 527 and secondary enclosure shaft 528 protrude through their respective enclosure guiderail openings 525, 526 and connects or travels to display enclosures 521, 522. The round edges of the enclosure guiderail openings slidably receive their respective enclosure guiderail slides. Dual screen desktop apparatus 520 is in a single screen mode with primary enclosure 521 and its associated primary display screen (not shown) available to the user.

FIG. 147 is a top view of dual screen desktop apparatus 520 of FIG. 146 as the two display enclosures are moved and rotated to a dual screen mode. From the single screen mode as shown in FIG. 146, display enclosures 521, 522 are slid via their respective guiderail slides 529, 519 towards the left and right sides respectively, after which the two display enclosures are rotated via their respective enclosure shafts 527, 528 towards the user essentially along primary enclosure rotation direction arrow 517 from phantom line representation 515 for primary enclosure 521 and secondary enclosure rotation direction arrow 518 from phantom line representation 516 for secondary enclosure 522. Primary enclosure rotation direction arrow 517 and secondary enclosure rotation direction arrow 518 indicate that the two display enclosures are pivoted towards the user via their respective enclosure shafts 527, 528. Hence, their associated display screens (not shown) may be directed towards the user for optimum contrast, more legible display, and viewing comfort. Display enclosures 521, 522 both contain their respective display screens 10, 20 as in the earlier examples.

FIG. 148 is an isometric view of wall mount stand 541 incorporating wall bracket 533, adjustable support arm 538, and guiderail assembly 534. Adjustable support arm 538 is hingely attached to wall bracket 533 and guiderail assembly 534. It may be rotated up or down to adjust the angle of guiderail assembly 534 or to position guiderail assembly 534 to be operated near the user from the wall. Function buttons 537 provide power supply to the apparatus through on/off button.

FIG. 149 is an isometric view example of dual screen wall mounted apparatus 530 incorporating wall mount stand 541 of FIG. 148 in a dual screen mode. Display enclosures 531, 532 are essentially centered relative to guiderail assembly 534 in a dual screen mode with display screens 10, 20 both visible and available to the user. Groove 539 located at bottom portion of display enclosures 531, 532 are slidably received by the upper portions of respective enclosure guiderails 535, 536. Groove 539 enables display enclosures 531, 532 to be moved sideways from left or right, to adjust to dual screen mode, to stabilize the two display enclosures, and to prevent the two display enclosures from being detached from guiderail assembly 534.

FIG. 150 is an isometric view of desktop stand 542 incorporating pedestal 543, adjustable support arm 544 and guiderail assembly 534. Desktop stand 542 is similar to that shown in FIG. 148 flattened to be mounted on a horizontal surface or a table unlike in FIG. 148 which is adapted to be mounted to a wall or vertical surface.

FIG. 151 is an isometric view example of dual screen desktop apparatus 540 incorporating desktop stand 542 in a dual screen mode. Dual screen desktop apparatus 540 is adapted to function preferably as a desktop to sit on a horizontal surface such as a desk, counter, kiosk, table and the like. Primary enclosure 531 and secondary enclosure 532 are essentially centered relative to pedestal 543 in a dual screen mode.

FIG. 152 is an isometric view of an alternative example dual screen wall mounted apparatus 545 incorporating a ball and socket joint 547 for pivoting display enclosures 531, 532. One end of support arm 548 is connected to guiderail assembly 534, the other end is connected via hinge pin 356 to support arm 549 which in turn is connected to wall mount assembly 546 via ball and socket joint 547. The ball portion of ball and socket joint 547 permits display enclosures 531, 532 to be pivoted left or right, forward or backward, and tilted up or down to adjust display screens 10, 20 for fine viewing or to go to a dual screen mode by essentially centering the two display enclosures relative to wall mount assembly 546 as shown in FIG. 152. Wall mount assembly 546 may be mounted to a wall, a partition, or a vertical surface similar to that of FIG. 148.

FIG. 153 is an isometric view another alternative example of dual screen desktop apparatus 550 incorporating a ball and socket joint 547 for pivoting display enclosures 531, 532. Dual screen apparatus 550 is similar to that shown in FIG. 152 adapted as a desktop for use on a flat or horizontal surface. Desktop stand 551 may be mounted to a desk or table. Primary enclosure 531 and secondary enclosure 532 may be pivoted left and right, forward and backward, and tilted up or down via ball and socket joint 547 to adjust display screens 10, 20 similar to that described in FIG. 152.

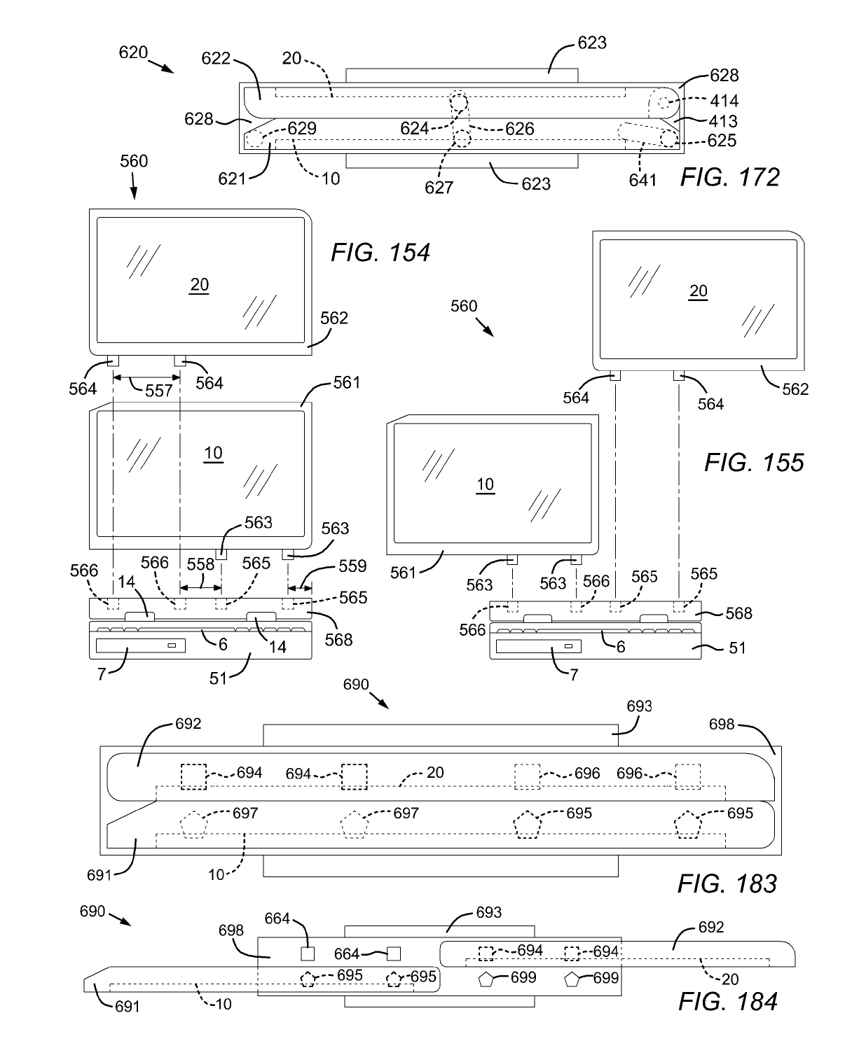

FIGS. 154-186 illustrate a fourth embodiment of the present invention in which the primary enclosure, the secondary enclosure, and any additional enclosures are self contained and function physically independent of each other. The multiple monitor apparatus may function in single screen, dual screen, or triple screen modes as explained hereinafter. The display enclosures are lifted and their associated pegs, which may be a single peg, double peg, and the like, are fitted in peg holes mounted onto the enclosure platform assembly unlike in alternative embodiments where a guiderail, slider arm, hinge or a slide hinge are used instead to move the display enclosures. The order may also be reversed such that the display enclosures may contain the peg holes and the enclosure platform assembly may contain the pegs instead. The shape of the pegs is generally round and cylindrical but other examples show a square peg and a pentagonal peg with matching peg holes. The pegs may be designed and mounted with some tension or pressure such as the use of rubber to absorb for example, the vibrations of the fan in the computer tower or vibration caused by the action of the keyboard keys. The rubber tension may absorb the energy or vibrations before it resonates. The pegs are typically conductive and may contain bi-directional optical connection inside.

Accordingly, FIG. 154 is a partially exploded schematic front view of dual screen apparatus 560 incorporating a two-peg design for both primary enclosure 561 and secondary enclosure 562 in a single screen mode. Primary enclosure 561 is shown with pegs 563 mounted at its right bottom edge and secondary enclosure is shown with pegs 564 mounted at its left bottom edge. Pegs 563, 564 are received by peg holes 565, 566 respectively. The four peg holes which may be plastic coated, are contained in enclosure platform assembly 568, the latter has a typically metallic structure inside and functions to support the pegs. For purpose of illustration, the wedged enclosure represents primary enclosure 561 while the curved enclosure at upper right and lower left corners represent secondary enclosure 562. In a single screen mode, as in FIG. 154, primary display screen 10 may be used by the user as a typical display screen while behind is secondary display screen 20 in a closed or stored position. The enclosure pegs are interchangeable in the sense that primary enclosure pegs 563 fit securely into secondary enclosure peg holes 566 and secondary enclosure pegs 564 fit securely into primary enclosure peg holes 565. As such, the distance between two adjacent pegs of an enclosure is essentially the same as indicated by dimension arrow 557. The distance or gap between the right secondary enclosure peg hole and the left primary enclosure peg hole is essentially shorter than dimension arrow 557 and thus, would not fit the enclosure pegs. The distance between the right edge of enclosure platform assembly 568 to the right primary enclosure peg hole as shown by dimension arrow 559 is essentially the same distance from the right primary peg to the edge of primary enclosure 561. Hence, the display enclosures are essentially in a centered position for the single screen mode.

FIG. 155 is a partially exploded schematic front view of dual screen apparatus 560 of FIG. 154 as display enclosures 561, 562 are lifted and moved to a dual screen mode. From the single screen mode as shown in FIG. 155, display enclosures 561, 562 interchange positions similar, for example, to two cars changing lanes while on opposite sides of the road. Primary enclosure 561 is lifted and its pegs 563 are fitted into peg holes 566 of secondary enclosure 562, after which secondary enclosure 562 is lifted and its pegs 564 are fitted into peg holes 565 of primary enclosure 561. Display screens 10, 20 are essentially centered relative to base electronics housing 51 in a dual screen mode.

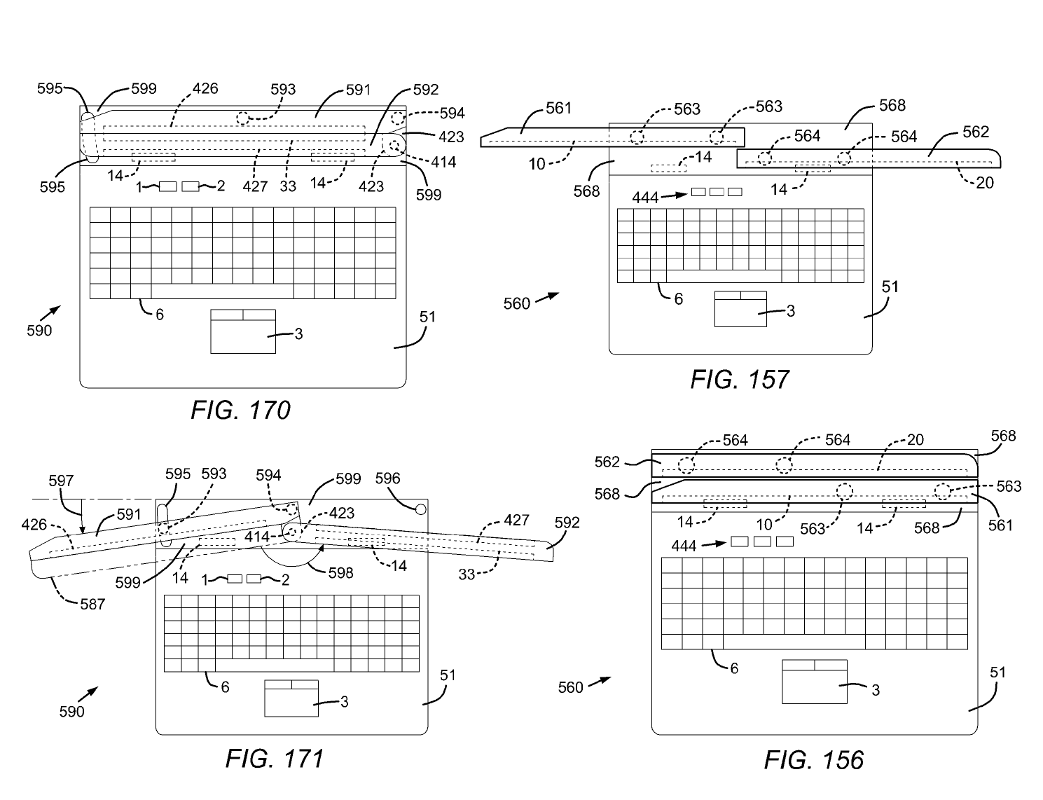

FIG. 156 is a schematic top view of dual screen apparatus 560 of FIG. 154. Shown on enclosure platform assembly 568 is an arrangement of aligned pegs 563, 564 and their respective display enclosures 561, 562. Secondary enclosure 562 is also shown in parallel proximity with primary enclosure 561. Only primary display screen 10 is available and faces the user in a single screen mode. Secondary display screen 20 is in stored or closed position.

FIG. 157 is a schematic top view of dual screen apparatus 560 of FIG. 155. In the dual screen mode, such as in FIG. 157, primary enclosure 561 is lifted and its pegs 563 are moved towards left to fit into the peg holes (not shown) of secondary enclosure 562. Secondary enclosure 562 is lifted and its pegs 564 are moved towards right to fit into the peg holes (not shown) of primary enclosure 562. In FIG. 157 display enclosures 561, 562 are aligned and parallel with base electronics housing 51 in a dual screen mode in which display screens 10, 20 directly face the user.

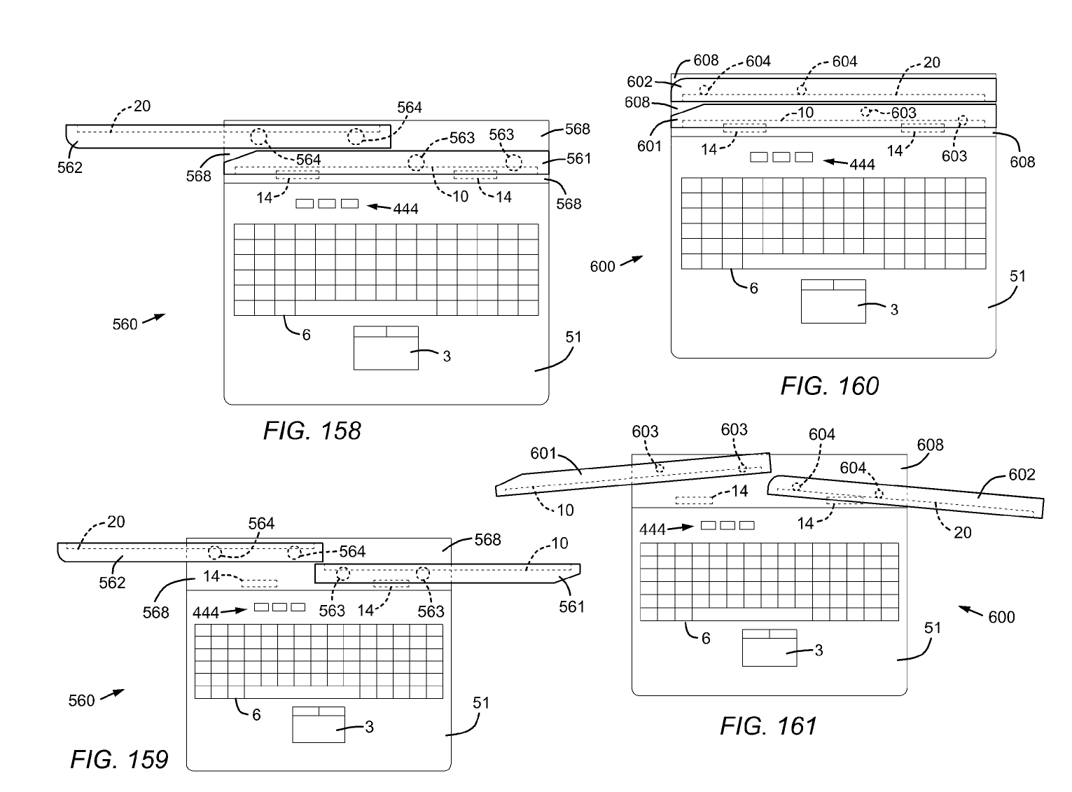

FIG. 158 is a schematic top view of dual screen apparatus 560 of FIG. 156 as secondary enclosure 562 is lifted and turned 180 degrees to face the rear. From the single screen mode, as shown in FIG. 156, secondary enclosure 562 is lifted and turned sideways essentially 180 degrees to the left after which pegs 564 is fitted into peg holes 566 (not shown) so that secondary enclosure 562 faces the rear. This set-up is used in instances when a user is making a presentation or wants to project an image to an audience located at the back of the apparatus towards the left portion. In this case, the contents of primary display screen 10 may be same as secondary display screen 20. Dual screen apparatus 560 is still in a single screen mode in the sense that only one display screen, which is primary display screen 10, is available to the user. FIG. 158 also shows a progression to a dual screen mode in which the two display enclosures face the back as shown in FIG. 159.

FIG. 159 is a schematic top view of dual screen apparatus 560 of FIG. 158 as both display enclosures 561, 562 face the rear in a dual screen mode. From the position shown in FIG. 158, primary enclosure 561 is lifted and rotated sideways to the right essentially 180 degrees and its pegs are fitted in peg holes 565 so that primary enclosure 561 faces the back of the apparatus. In this position, both display screens 10, 20 face the back of the apparatus in a dual screen mode in which the user is located at the back which may also be a group of individuals or an audience.

FIG. 160 is a top view of dual screen apparatus 600 incorporating an example angled peg holes 603 of primary enclosure 601 and aligned pegs 604 of secondary enclosure 602 in a single screen mode. Dual screen apparatus 600 shows primary enclosure 601 with its two angled pegs 603 fitted into angled peg holes 605 (shown in FIG. 163) and secondary enclosure 602 with its two aligned pegs 604 fitted into aligned peg holes 606 (shown in FIG. 163). Pegs 603 and peg holes 605 are angled while pegs 604 and peg holes 606 are aligned and parallel to base electronics housing 51. In FIG. 160, primary enclosure 601 and its associated primary display screen 10 face the user in a single screen mode. Pegs 603, 604 are interchangeable similar to that shown in FIGS. 154-159. When pegs 603, 604 interchange positions as shown in FIG. 161, the two display enclosures are angled facing the user as shown in FIG. 161.

FIG. 161 is a schematic top view of dual screen apparatus 600 of FIG. 160 showing display enclosures 601, 602 angled and essentially centered facing the user in a dual screen mode. To effect a dual screen mode, display enclosures 601, 692 interchange positions: primary enclosure 601 is lifted and moved towards the left at rear and its angled pegs 603 are fitted into aligned peg holes 606 of secondary enclosure 602. Secondary enclosure 602 is lifted and moved towards the right at front and its aligned pegs 604 are fitted into angled peg holes 605 of primary enclosure 601. The slotting of display enclosures 601, 602 results in a natural angled projection due to the design of the pegs and peg holes. The design illustrates that either one of the two enclosures need to have an angled pegs and angled peg holes in order to have two display screens angled in a dual screen mode.

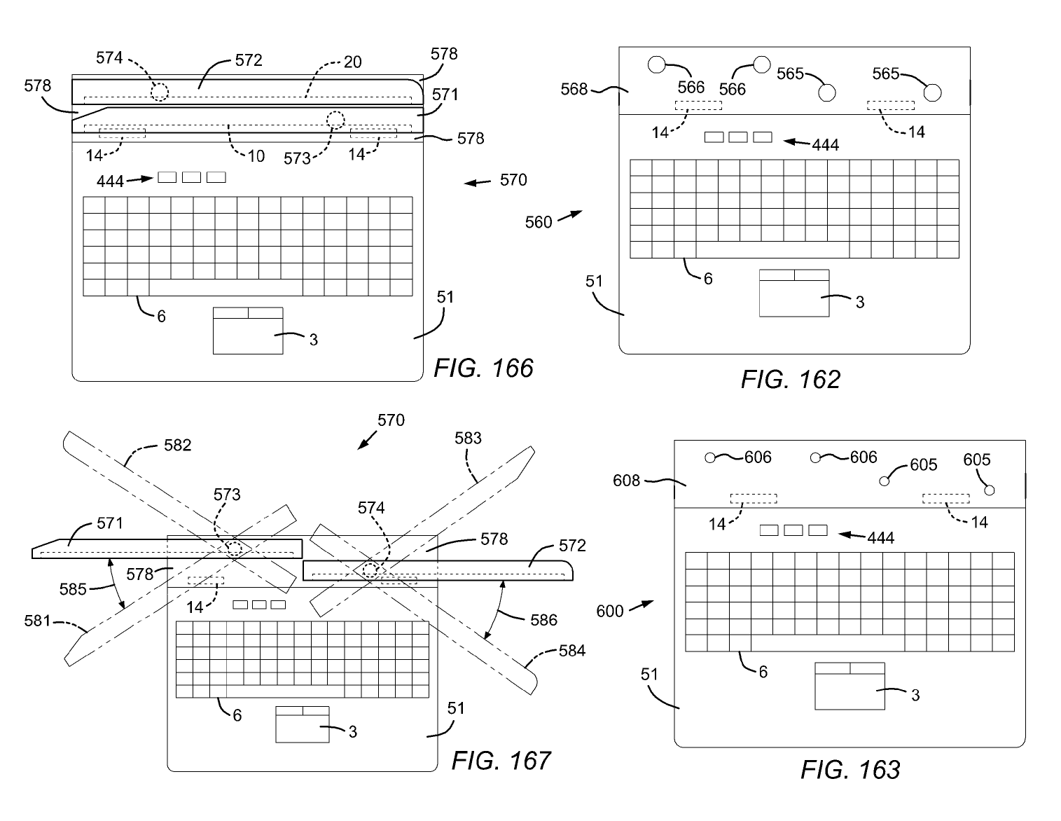

FIG. 162 is a top view of dual screen apparatus 560 with its two display enclosures removed to emphasize the relative position and arrangement of the peg holes. Primary enclosure 561 and secondary enclosure 562 (both not shown) as depicted in FIGS. 154-159 have been removed from the top view representation of dual screen apparatus 560 to emphasize the relative position and arrangement of peg holes 565, 566 respectively. Enclosure platform assembly 568 is shown without pegs 563 (not shown) and the two display enclosures. Peg holes 565 and 566 are shown aligned and parallel to base electronics housing 51.

FIG. 163 is a top view of dual screen apparatus 600 with its two display enclosures removed to emphasize the relative position and arrangement of the peg holes. Primary enclosure 601 and secondary enclosure 602 (both not shown) of dual screen apparatus 600 as shown in FIGS. 160-161 have been removed to emphasize the relative position and arrangement of peg holes 605, 606 respectively. The peg holes are smaller as compared to that shown in FIG. 162 with peg holes 605 angled a bit and peg holes 606 aligned and parallel to base electronics housing 51. When the respective pegs of the two enclosures swap peg hole positions, the two display enclosures are also angled towards the user as shown in FIG. 161. Enclosure platform assembly 608 is also shown without pegs 604 (not shown) and the two display enclosures.

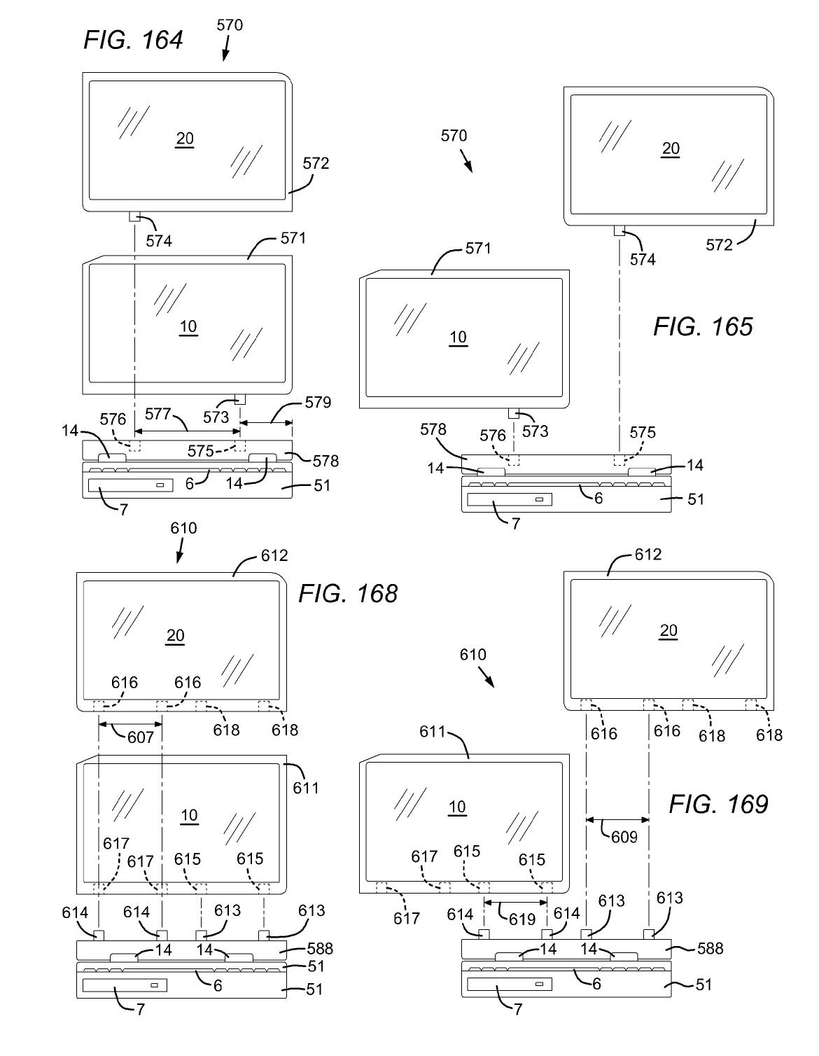

FIG. 164 is partially exploded schematic front view of dual screen apparatus 570 showing an alternative example single peg design in a single screen mode. Shown are peg 573 mounted at right bottom edge of primary enclosure 571 with corresponding peg hole 575, and peg 574 mounted at left bottom edge of secondary enclosure 572 with corresponding peg hole 576. Peg holes 575, 576 are mounted in enclosure platform assembly 578. Pegs 573, 574 are typically larger than the two-peg enclosure design shown in FIGS. 154-157. The one-peg enclosure design allows rotation of the display enclosures as shown in FIG. 167. Like the two-peg enclosure design, pegs 573, 574 are interchangeable in that peg 573 of primary enclosure 571 may be fitted into peg hole 576 of secondary enclosure 572 and peg 574 may be fitted into peg hole 575 of primary enclosure 571 in the dual screen mode as shown in FIG. 165 and FIG. 167. Dimension arrow 579 indicates the distance between the right side edge of enclosure platform assembly 578 and peg hole 575 essentially half the length of dimension arrow 577 or the distance between two peg holes. Dual screen apparatus 570 is in a single screen mode in which primary display 10 is available to the user as secondary display 20 is hidden behind primary enclosure 571.

FIG. 165 is partially exploded schematic front view of dual screen apparatus 570 of FIG. 164 as primary enclosure 571 and secondary enclosure 572 interchange positions to effect a dual screen mode. From the single screen mode, as shown in FIG. 164, the two display enclosures interchange positions with primary enclosure 571 lifted and moved towards the left to fit its peg 573 into peg hole 576 of secondary enclosure 572. Secondary enclosure 572 is then lifted and moved towards the right to fit its peg 574 into peg hole 575 of primary enclosure 571. The two display screens are essentially centered relative to base electronics housing 51 in a dual screen mode.

FIG. 166 is a schematic top view of dual screen apparatus 570 of FIG. 164. Secondary enclosure 572 is shown adjacent to the back of primary enclosure 571 as the latter protects secondary display screen 20 in a closed or stored position. Primary display screen 10 is available and faces the user in the single screen mode. Also shown are pegs 573, 574 in hidden outline which are fitted in their respective peg holes 575, 576 (not shown) respectively.

FIG. 167 is a schematic top view of dual screen apparatus of FIG. 165 showing rotation movements of the two display enclosures with pegs. From the single screen mode of FIG. 164 and FIG. 166, the two display enclosures are lifted and their positions are swapped to effect a dual screen mode with display screens 10, 20 facing the user. From this position, the two display enclosures may be rotated towards the user to adjust contrast and legibility. Primary enclosure 571 may be rotated towards the user to phantom line representation 581 as indicated by primary enclosure rotation direction arrow 585 and secondary enclosure 572 may be rotated towards the user to phantom line representation 584 as indicated by secondary enclosure rotation direction arrow 586. The user may maintain the dual screen mode by rotating phantom line representation 581 to essentially 180 degrees after which peg 573 of primary enclosure 571 is returned to its designated peg hole 575 to new phantom line representations at 583. Phantom line representation 584 is rotated to essentially 180 degrees after which peg 574 is returned to its designated peg hole 576 to new phantom line representation 582. The two display enclosures now face the rear at an angle. The second dual screen mode option, in which the two display screens face the rear, may be used in board room or classroom presentations where the audience may view the two display screens facing the rear. In this set up, the user for example, may do another activity as the presentation or educational DVD feature is going on. In both dual screen mode options, the display enclosures are angled to get a better view.

FIG. 168 is a partially exploded schematic front view of dual screen apparatus 610 showing an alternative example of pegs mounted on enclosure platform assembly 618 and peg holes mounted on the display enclosures in a single screen mode. Enclosure platform assembly 588 is shown with pegs 613 which receive peg holes 615 of primary enclosure 611 and pegs 614 which receive peg holes 616 of secondary enclosure 612. Peg holes 617, 618 are redundant set of holes since each display enclosure needs only two peg holes. The use of redundant peg holes 617, 618 are for added flexibility and rigidity such as in instances when the display enclosures are plugged into a stand or arranged into an array of monitors. Dimension arrow 607 indicates the distance between the two peg holes 616 that is of the same length as dimension arrows 619 and 609 (both shown in FIG. 169). This allows for fitting securely the two enclosures as they swap positions for the dual screen mode as shown in FIG. 169. In a single screen mode, as in FIG. 168, primary display screen 10 may be used by the user as a typical display screen while at its back is secondary display screen 20 in a closed or stored position.

FIG. 169 is a partially exploded schematic front view of dual screen apparatus 610 as primary enclosure 611 and secondary enclosure 612 are lifted and moved to a dual screen mode. From the single screen mode of FIG. 168, the two display enclosures interchange positions in that peg holes 615 of primary enclosure 611 are fitted into pegs 614 of secondary enclosure 612 and peg holes 616 of secondary enclosure 612 are fitted into pegs 613 of primary enclosure 611. Dimension arrows 619, 609 indicate distance of peg holes within the enclosure which are of the same length and which permit the two enclosures to interchange between their designated pegs. Display screens 10, 20 are essentially centered relative to base electronics housing 51 in a dual screen mode.

FIG. 170 is a schematic top view of dual screen apparatus 590 showing an example two display enclosures that are hinged, the first display enclosure with pegs fitted in peg holes and peg slot, and the second display enclosure with two display screens. Enclosure platform assembly 599 is shown with first display enclosure 591 connected to second display enclosure 592 via second display enclosure hinge 423 located at right side portion similar to that shown in FIGS. 114-115. Also shown are peg 594 which sits in peg hole 596 (shown in FIG. 171) and peg 593 which sits in its designated peg hole (not shown). At left side of enclosure platform assembly 599 is peg slot 595 that functions as a sliding slot to permit angling of first display enclosure 591 towards the user when in dual screen mode as in FIG. 171. Second display screen 427 and third display screen 33 are contained in second display enclosure 592. Second display screen 427 is the one facing the user in a single screen mode such as in FIG. 170 while third display screen 33 is closed and protected by first display enclosure 591. Alternatively, second display enclosure hinge 423 may be replaced by a swivel hinge similar to that shown in FIGS. 59-60, 62. A single swivel hinge may be sturdier and stronger than second display enclosure hinge 423. It may also have sufficient tension to hold first display enclosure 591 and prevent it from detached from the unit.

FIG. 171 is a schematic top view of dual screen apparatus 590 of FIG. 170 in a dual screen mode. The two display enclosures in FIG. 170 are picked up and moved towards the left side as peg 593 is at peg slot 595 and peg 594 goes to the peg hole vacated by peg 593, thus peg hole 596 becomes empty. Second display enclosure 592 is then rotated towards the right from phantom line representation 587 essentially along rotation direction arrow 598. In this position, third display screen 33 faces the user while second display screen 427 faces the rear. First display screen 426 may be adjusted for contrast and legibility by rotating first display enclosure 591 via peg 593 along peg slot 595 essentially at a limited angle towards the user essentially along angle direction arrow 597. In the dual screen mode such as in FIG. 171, the two display enclosures are angled facing the user and two display screens are facing the user and one display screen faces the rear.

FIGS. 172-184 show examples of dual screen apparatuses incorporating a pedestal suitable to a desktop stand but which may also be connected to a wall mount assembly attached to a platform via support arms such as that shown in FIGS. 148-153. The pedestal may also be connected to a platform via one or more hinges similar to that shown in FIGS. 1-18. Alternatively, in some examples, the secondary enclosure hinge that connects the secondary enclosure to the primary enclosure may be replaced by a swivel hinge similar to that shown in FIGS. 59-60, 62. FIG. 172 is a schematic top view example of dual screen pedestal apparatus 620 incorporating display enclosures 621, 622 that are hinged with two peg slots, 3 pegs and 1 peg hole in a single screen mode.

Accordingly, in FIG. 172, three pegs secure the two display enclosures in a single screen mode with primary enclosure 621 facing the user and secondary enclosure 622 facing the rear. Primary enclosure peg 627 and secondary enclosure peg 624 are received by center peg slot 626 while primary enclosure peg 625 is received by right peg slot 641. Secondary enclosure 622 is connected to primary enclosure 621 via secondary enclosure hinge 413 located at right side of enclosure platform assembly 628. Shown is an empty primary enclosure peg hole 629 located at left side of enclosure platform assembly 628.

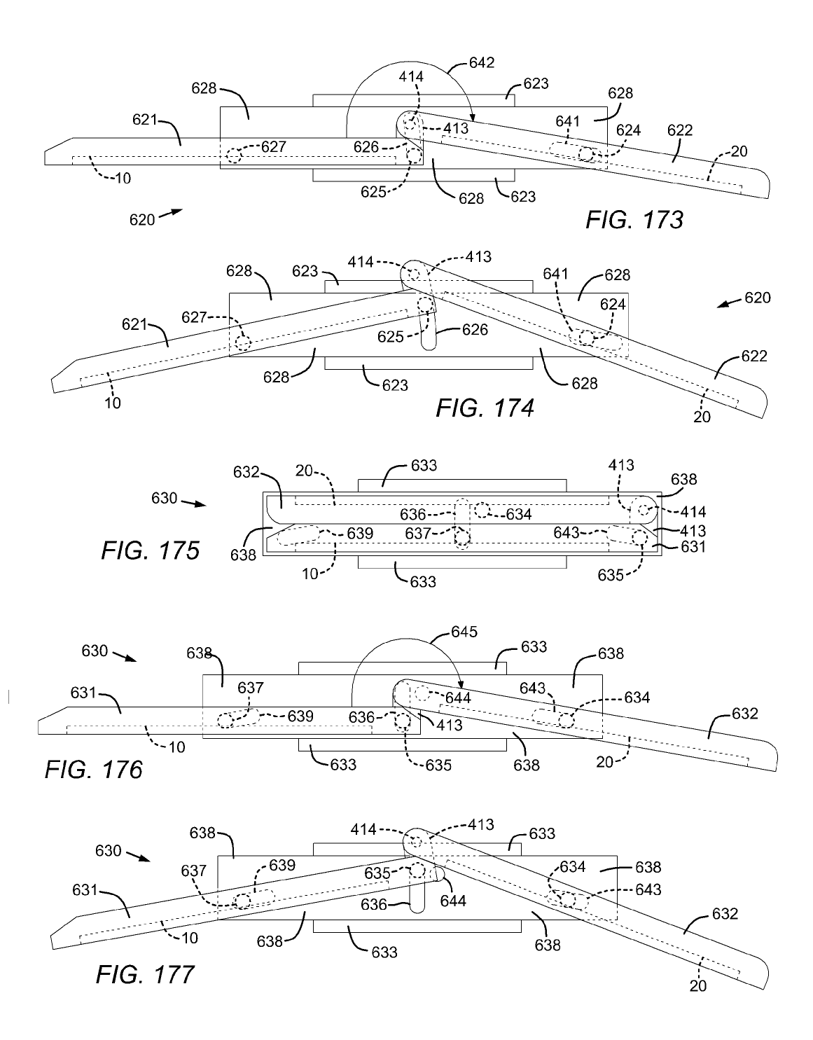

FIG. 173 is a schematic top view of dual screen pedestal apparatus 620 of FIG. 172 as display enclosures 621, 622 are lifted and moved in preparation for the dual screen mode. The two display enclosures are picked up and moved towards the center so that peg 625 is received by center peg slot 626 and peg 627 is fitted into peg hole 629 after which secondary enclosure 622 is flipped and rotated about secondary enclosure hinge 413 essentially 180 degrees to the right along rotation direction arrow 642 so that right peg slot 641 receives peg 624. In this position, display enclosures 621, 622 face towards the user with secondary enclosure 622 slightly angled while primary enclosure 621 is aligned and parallel with pedestal 623 and enclosure platform assembly 628. Primary enclosure 621 will have a rotating motion through primary enclosure peg 625 which may be moved at an axis parallel to center peg slot 626. The angle of the rotation is limited because of the short length of center peg slot 626. When primary enclosure 621 rotates to an angle as shown in FIG. 174, secondary enclosure 622 adjusts by moving through center peg slot 626. To adjust the angles, the force is applied more at center peg slot 626.

FIG. 174 is a schematic top view of dual screen pedestal apparatus 620 of FIG. 173 showing display enclosures 621, 622 fully angled towards the user in a dual screen mode. The three pegs shown in FIG. 173 remain on the same spots: peg 627 is in peg hole 629, peg 625 is in center peg slot 626, and peg 624 is in right peg slot 641. In FIG. 174, peg 625 has been pushed towards the rear of center peg slot 626 to orient the two display screens towards the user which then causes peg 624 to shift towards the center of right peg slot 641. When peg 625 is pushed, both display enclosures are at extreme angles and pivot towards the user. Dual screen apparatus 620 is in a dual screen mode in which the two display enclosures face the user at an angle.

FIG. 175 is a schematic top view alternative example of dual screen pedestal apparatus 630 incorporating two display enclosures that are hinged with three peg slots, 3 pegs and 1 peg hole in a single screen mode. Shown in hidden lines is center peg slot 636 which is straight going towards the back of the base plate. Secondary enclosure peg 634 is located off center at the right side of center peg slot 636. Slanted left peg slot 639 and slanted right peg slot 643 are located on opposite sides of enclosure platform assembly 638. In FIG. 175, the same display enclosure movements are essentially effected as in FIGS. 172-174, only the arrangement of pegs and number of peg slots have changed. Shown in FIG. 175 are three peg slots, three pegs, and one peg hole positioned as follows: secondary enclosure peg 634 received by peg hole 644, primary enclosure peg 637 received by center peg slot 636, primary enclosure peg 635 received by slanted right peg slot 643, and an empty slanted left peg slot 639. As mentioned, peg 634 sits in peg hole 644 and keeps the two display enclosures anchored in the single screen position in which secondary enclosure 632 faces the rear and primary enclosure 631 faces the user.

FIG. 176 is a schematic top view of dual screen pedestal apparatus 630 of FIG. 175 as display enclosures 631, 632 are lifted and moved in preparation for the dual screen mode. The two display enclosures are unfurled with primary enclosure 631 moved towards the left so that primary enclosure peg 637 is received by left peg slot 639 and primary enclosure peg 635 is placed towards front of center peg slot 636. Secondary enclosure 632 is flipped and rotated about secondary enclosure hinge 413 essentially 180 degrees to the right along rotation direction arrow 645 so that right peg slot 643 receives secondary enclosure peg 634. In FIG. 176, the three pegs go into each peg slot in preparation for the dual screen mode. In this position, display enclosures 631, 632 face towards the user. Primary enclosure 631 is aligned and parallel with pedestal 623 and enclosure platform assembly 638 while secondary enclosure 632 is angled towards the user.

FIG. 177 is a schematic top view of dual screen pedestal apparatus 630 of FIG. 176 display enclosures 631, 632 fully angled towards the user in a dual screen mode. Peg 635 is pushed towards the rear of center peg slot 636 for an angle to orient display enclosures 631, 632 towards the user. This causes peg 634 to move towards the center within right peg slot 643 and peg 637 to move slightly within left peg slot 639. Peg hole 644 is empty when in the dual screen mode as shown in FIG. 177 and left peg slot 639 is empty when in single screen mode as shown in FIG. 175.

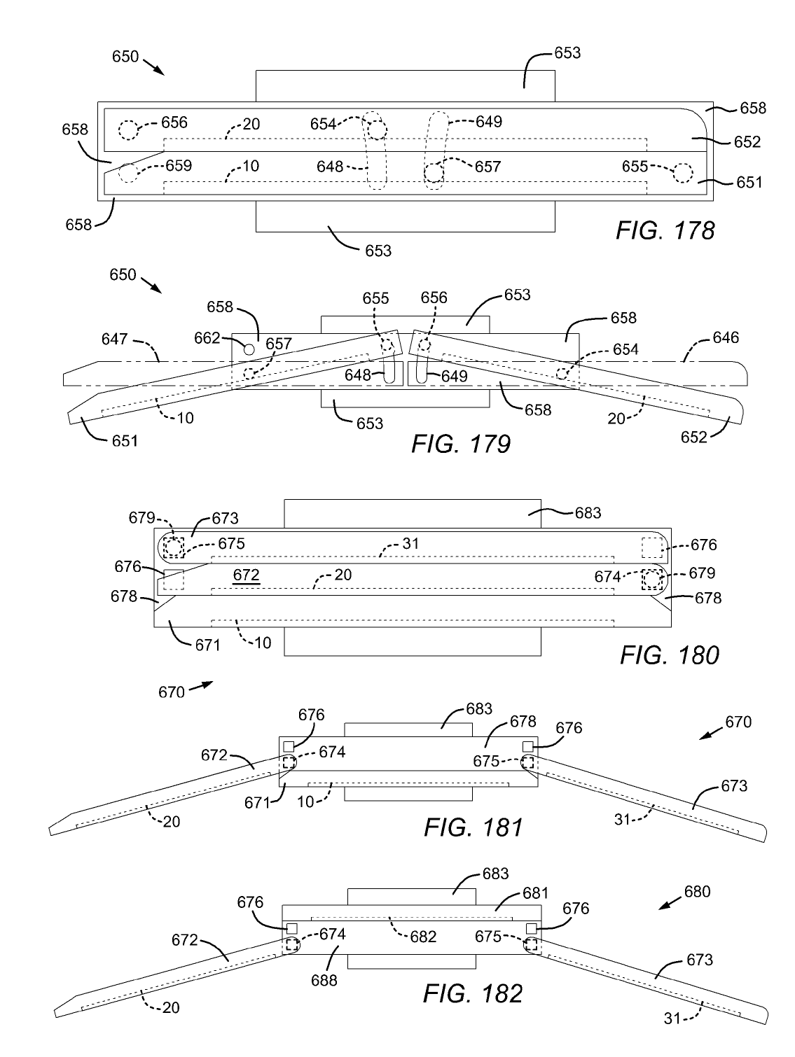

FIG. 178 is a schematic top view yet another alternative example of dual screen pedestal apparatus 650 showing two independent display enclosures with two curved center peg slots and round pegs in a single screen mode. Primary enclosure 651 and secondary enclosure 652 of dual screen pedestal apparatus 650 are not connected and contains two round pegs design in each enclosure similar to that shown in FIGS. 154-159. Unlike in FIGS. 154-159, the two enclosures may be lifted and moved to a dual screen mode via the pegs and the two center peg slots. Primary enclosure peg 655 is shown fitted in its designated hole at right side of enclosure platform assembly 658 while primary enclosure peg 657 is received by right center peg slot 649. Primary enclosure peg hole 659 at left side is shown empty. Secondary enclosure pegs 654, 656 are received by left center peg slot 648 along a nib and peg hole 662 respectively. The four enclosure pegs are shown aligned as they secure the two display enclosures in a single screen mode.

FIG. 179 is a schematic top view of dual screen pedestal apparatus 650 of FIG. 178 as display enclosures 651, 652 are moved to a dual screen mode. From the position of FIG. 178, display enclosures 651, 652 are lifted, after which peg 657 is fitted into peg hole 659 and peg 655 is transferred to left center peg slot 648 while peg 654 is received by the peg hole vacated by peg 655 and peg 656 is received by right center peg slot 649. Dual screen pedestal apparatus 650 is in a dual screen mode in which display enclosures 651, 652 are aligned and parallel to pedestal 653 and enclosure platform assembly 658 as depicted by phantom line representations at 647, 646 for primary enclosure 651 and secondary enclosure 652 respectively. From phantom line representations at 647, 646 the two display enclosures may be rotated towards the user for an angle by pushing pegs 655, 656 towards the rear of center peg slots 648, 649 respectively.

FIG. 180 is a schematic top view further alternative example of triple screen pedestal apparatus 670 incorporating secondary enclosure 672 and tertiary enclosure 673 mounted with square pegs and a stationary primary enclosure 671, in a single screen position. In FIG. 180, primary enclosure 671 is rigidly fixed and essentially centered relative to enclosure platform assembly 678 in an open position facing the user. Secondary enclosure 672 is in a closed position with its secondary enclosure peg 674 received by its allotted square peg hole. Tertiary enclosure 673 is also in a closed position with its tertiary enclosure peg 675 received by square peg hole 684. The square pegs contain a cylindrical enclosure hinge 679 that permits secondary enclosure 672 and tertiary enclosure 673 to be rotated about towards the user in the triple screen mode as shown in FIG. 181. Triple screen pedestal apparatus 670 is in a single screen mode in which primary display screen 10 of primary enclosure 671 is available to the user.

FIG. 181 is a schematic top view of triple screen pedestal apparatus 670 of FIG. 180 as secondary enclosure 672 and tertiary enclosure 673 are moved to a triple screen mode. To effect a triple screen mode from the single screen mode, secondary enclosure 672 is lifted and moved towards the left to fit its secondary enclosure peg 674 into its square peg hole 676, after which tertiary enclosure 673 is lifted and moved towards the right to fit its tertiary enclosure peg 675 into the square peg hole vacated by secondary enclosure peg 674. Secondary enclosure 672 and tertiary enclosure 673 may be angled towards the user for fine viewing by rotating the two display enclosures through enclosure hinge 679. Primary enclosure 671 has a slanted edge at the back of its left and right sides to accommodate the angling of secondary enclosure 672 and tertiary enclosure 673.

FIG. 182 is a schematic top view of triple screen pedestal apparatus 680, an alternative example of the triple screen apparatus shown in FIGS. 180-181, showing a primary enclosure 681 located at rear of enclosure platform assembly 688 in a triple screen mode. From its position in FIG. 181, primary enclosure 681 is positioned at the rear creating a space in the front of primary enclosure 681 which may be used to place manuscripts. Primary enclosure 681 is rigidly fixed to enclosure platform assembly 688 similar to that shown in FIG. 181. The position of secondary enclosure 672 and tertiary enclosure 673 in FIG. 181 is unchanged.

FIG. 183 is a schematic top view another example of dual screen pedestal apparatus 690 showing two independent display enclosures: primary enclosure 691 with pentagonal pegs 695 and secondary enclosure 692 with square pegs 694 in a single screen mode. Shown in FIG. 183 is primary enclosure 691 mounted with pentagonal pegs 695 that are received by pentagonal peg holes 699 (shown in FIG. 184) and empty pentagonal peg holes 697. Also shown is secondary enclosure 692 mounted with square pegs 694 that are received by square peg holes 664 and empty square peg holes 696. Dual screen pedestal apparatus 690 is in a single screen mode in which primary display screen 10 of primary enclosure 691 is available and faces the user while secondary display screen 20 of secondary enclosure 692 is not visible. Additional polygonal shapes may be used for the pegs and peg holes other than square, pentagon, or round shapes. How the shapes of the pegs are chosen may effect the orientation of the display enclosures, for example, if the display enclosures have pentagonal pegs then they may be positioned forward or backward. The shape of the pegs also restricts certain positions of the display enclosures such as to match signal path and power supply requirements where a matching receptacle requires a matching plug. The choice of a square peg, for example, may be suited for special type of display screens to match audio and video standards such as the square peg may require 5 volts and the pentagonal peg may require 12 volts. This is similar to an Internet jack plug and a telephone jack plug. The latter would not be received in the Internet jack socket. The requirements of each display enclosure technically differ such as for example, in the power needs, video standards, and signaling. The peg holes may be modified to suit a particular requirement of the enclosure such as for example, a particular peg hole may only fit the jack plug it is associated with.

FIG. 184 is a schematic top view of dual screen pedestal apparatus 690 of FIG. 183 in a dual screen mode. In the dual screen mode, primary enclosure 691 is lifted and moved towards the left to fit pentagonal pegs 695 into pentagonal peg holes 697, after which secondary enclosure 692 is lifted and moved towards the right to fit the two square pegs 694 into square peg holes 696. In this position, display enclosures 691, 692 are aligned and parallel with pedestal 693 and enclosure platform assembly 698. In FIG. 184, display enclosures 691, 692 may be flushed with enclosure platform assembly 698 that has been expanded for clarity.

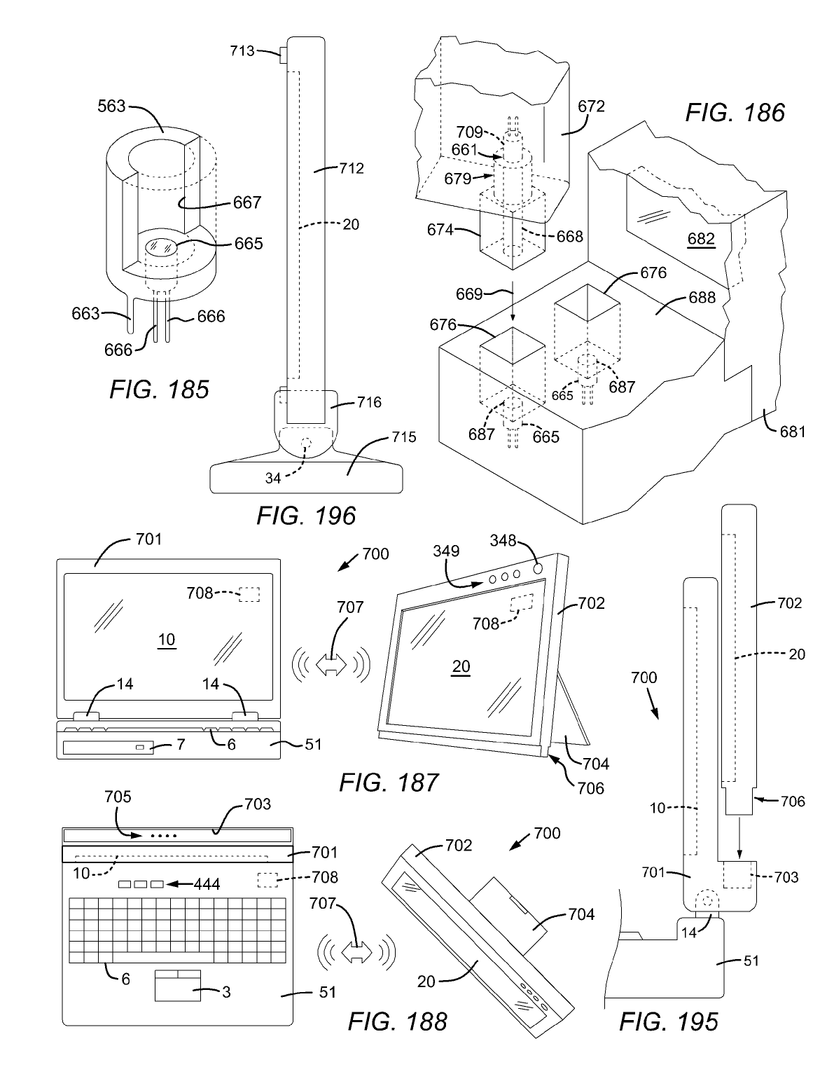

FIG. 185 is an enlarged schematic cutaway view of peg 563 as depicted in FIGS. 154-159. Connector wire 663 is associated with the metal casing of peg 563. The casing is typically metallic but may be made of glass or wrapped in metallic sleeve. The peg is removable in the sense that it is not fixed in the enclosure platform assembly but fixedly attached to the display enclosure. Electro-optical emitter device 665 is an LED (light emitting diode) similar to an optical device for transmitting or receiving signals to and from the optical detector or remitter. The electro-optical emitter device 665 detects signals coming from the enclosure platform assembly and permits connector receptacle to accommodate peg hole such as peg hole 565 and peg 563 to complete corresponding matching connectors. Audio and power signals may be completed or coupled. Optical waveguide outer surface 667 provides unobstructed path to the optical emitter. Fiber optic cables and rigid optical conduits may transfer optical signals to and from the primary enclosure and secondary enclosure. Device lead wires 666 are mounted and soldered on the circuit board. It is connected to the display electronics. Video signals may be modulated and any status information on power signals may be transmitted wirelessly via electro-optical emitter device 665 in lieu of an optical connector. The bottom of peg 563 as depicted in FIG. 185 receives electro-optical emitter device 665, the latter functions as a transmitter and receiver. The optical transmission may be in a single peg or adjacent peg or each of the adjacent pegs and that they may be made redundant Optical waveguide outer surface 667 (an empty hole) is located in center of peg or cavity lessens the weight of the peg by creating a space in the center. A cylindrical cavity is formed in center of peg 563 to accommodate electro-optical emitter device 665 to receive optical signals from corresponding optical emitter typically located at the peg hole.

FIG. 186 is an enlarged partial view left side of enclosure platform assembly 688 of triple screen pedestal apparatus 680 of FIG. 182 showing details of secondary enclosure peg 674 and square peg holes 676 Secondary enclosure peg 674 has similar characteristics with peg 563 as shown in FIG. 185 but shaped as a square. Square peg hole 676 clearly receives secondary enclosure peg 674 as shown by enclosure insertion enclosure insertion direction arrow 669 when secondary enclosure peg 674 is fitted to square peg hole 676. Optical waveguide outer surface 668 functions similarly to optical waveguide outer surface 667 as shown and described in FIG. 185. Emitter housing 687 protrudes or is fitted in a cavity so data signal, for example, video signal for display screen is supplied by electro-optical emitter device 665 fitted on or about emitter housing 687 to square peg hole 676 or to the mounted LED emitter (not shown). Optical waveguide outer surface 668 allows unobstructed path to electro-optical detector receiver device 709 mounted at the end of secondary enclosure peg 674 on or about the area of device housing 661. The circular shaft enables the display enclosures to rotate at angles, especially when the enclosure is a one peg design. The square shaft conducts with the square peg hole through light transmitted data which may be wired or wireless. The cylindrical portion indicated at enclosure hinge 679 represents portion of peg internal to secondary enclosure 672. It may be internally rotated since the peg is square and stationary. Rotating secondary enclosure 672 requires that peg enclosure hinge 679 be rotated with respect to secondary enclosure peg 674. This is accomplished by enclosure hinge 679 enclosed in rubber to cause some degree of tension to absorb or dampen the vibrations associated with the operating environment of triple screen pedestal apparatus 670.

FIGS. 187-192 illustrate a fifth preferred embodiment of the present invention in which the primary enclosure and the secondary enclosure are independent of each other with the secondary enclosure detachable or separated from the main unit. Either the primary enclosure or secondary enclosure of the dual screen display apparatus may contain a portable energy source to power the electronics should either one of the display enclosures be detached from the base assembly on a permanent or temporary basis. A wired or wireless connection to the base electronics housing enables the detached display enclosure to receive and transmit signals. Connection to any of the detached display enclosures may be done through an optical or radio frequency means. Similarly, such wireless means may also be used to provide and receive data from any display enclosure or display screen. When a display enclosure is detached, a power adapter may be used to supply a continuous or temporary source of power to the detached unit.

Accordingly, FIG. 187 is front view of dual screen apparatus 700 showing a detachable secondary enclosure 702. Dual screen apparatus 700 is similar to the earlier dual screen display apparatus depicted in FIGS. 126-134 in which primary enclosure hinge 14 is raised without a guiderail assembly. In FIG. 187, detachable secondary enclosure 702 is separated from the main unit communicating wirelessly with base electronics housing 51 via wireless communication link 707 through wireless communications module 708 located within the secondary enclosure and base electronics housing 51 for the main unit and within the secondary enclosure for the detached unit as shown in FIGS. 187-188. Primary display screen 10 of primary enclosure 701 may be used simultaneously with secondary display screen 20 of detachable secondary enclosure 702, secondary display screen 20 may be a special display screen. Power buttons 348 and status indicator lights 349 pertain specifically to detachable secondary enclosure 702. Power buttons 348 for example, conserve the built-in batteries and enable on and off mode of secondary display screen 20. The peripheral buttons enable the display screen to change orientation to either portrait or landscape, to communicate with base electronics housing 51, and to facilitate saver mode.

FIG. 188 is a top view of dual screen apparatus 700 of FIG. 187. Docking cavity 703 is an enclosure holder for detachable enclosure 702 fixedly attached to the base of primary enclosure 701 at the rear. The docking is by mechanical means. Detachable secondary enclosure 702 is docked at the rear of primary enclosure 701 with display screen 20 either facing outward to allow the unit to serve as a convertible PC tablet, or facing the rear (closed position) of primary enclosure 701. Docking cavity 703 functions as a recharger, for example, for the electrical connections and memory when detachable secondary enclosure 702 is docked. The independent display electronics of detachable secondary enclosure 702 and its wireless components such as wi-fi, Bluetooth, wi-max and the like, internal memory, RAM, mini hard drive, adapter or power drive are being recharged while in its docking stage. Detachable secondary enclosure 702 may be docked facing away from the unit or rotated about 180 degrees to face the keyboard. It may communicate with base electronics housing 51 at this stage. When detachable secondary enclosure 702 is in its docking stage and secondary display screen 20 is facing the rear, the display screen may be converted as its own slate style tablet PC which may download files in sync with its associated files. Docking cavity 703 receives lower ledge 706 (shown in FIG. 187) of detachable secondary enclosure 702 and may be secured to primary enclosure 701. Additional latches and hooks may be used to firmly secure detachable secondary enclosure 702. At the bottom of docking cavity 703 are electronics contacts 705 which facilitate bi-directional data flows to and from detachable secondary enclosure 702. They permit recharging of the portable power supply or portable battery (not shown). Detachable secondary enclosure 702 may have a rotatable stand 704 to facilitate orientation in both landscape and portrait.

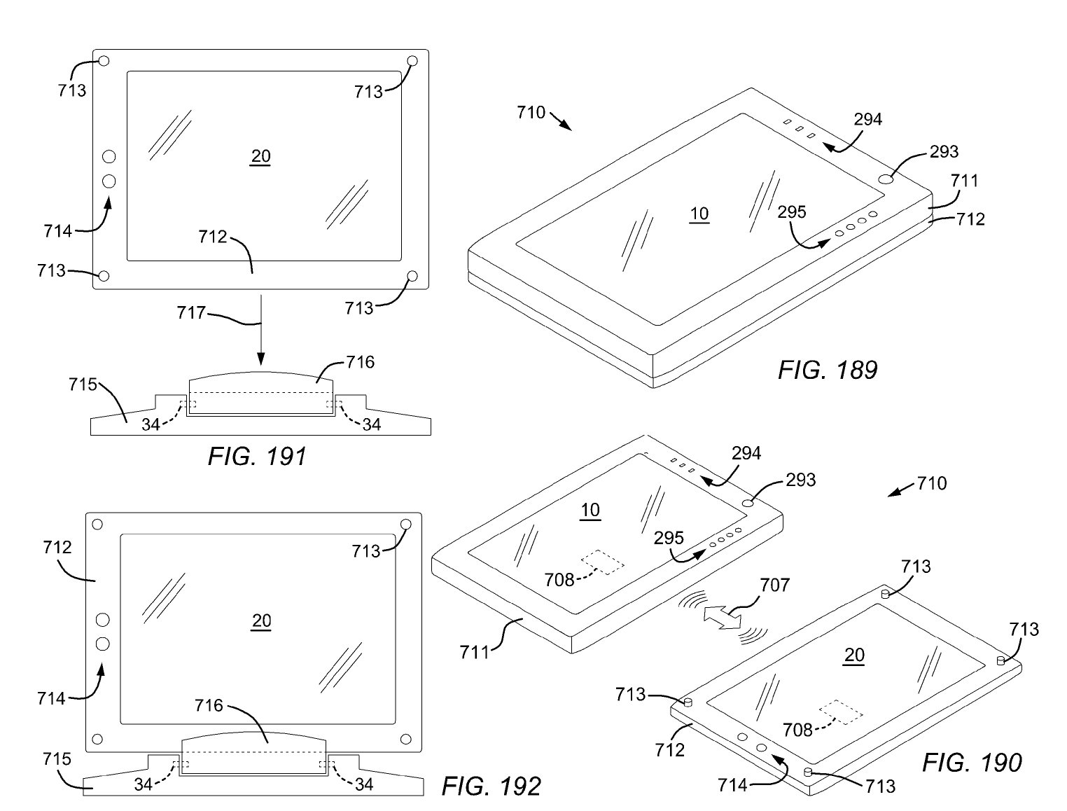

FIG. 189 is an isometric view example of dual screen slate style apparatus 710 with an integrated detachable secondary enclosure 712. Dual screen slate style apparatus 710 functions as a slate style tablet PC with an integrated detachable secondary enclosure 712 docked underneath primary enclosure 711. Shown in FIG. 189 are power button 293 to turn on or off detachable secondary enclosure 712, status lights 294 which indicate when the unit is charged and may also be used as a hard drive indicator, wireless indicator or diagnostic indicator; and function buttons 295 which handles the control aspects of the unit such as volume and brightness. Function buttons 295 also permit orienting the picture or rotating the display screen relative to the user, enable standby mode to conserve usage, and enable and disable communication to other peripheral devices.

FIG. 190 is an isometric view of dual screen slate style apparatus 710 of FIG. 189 showing detachable secondary enclosure 712 separated from primary enclosure 711. Pegs 713 secure detachable secondary enclosure 712 to back of primary enclosure 711. Pegs 713 may be metallic, friction fitted, and may be molded in the casing of primary enclosure 711. Its optical characteristics permit sharing data to and from the two display enclosures. It also assists in recharging batteries and conveying status information to detachable secondary enclosure 712. Additional latches or hooks may be used to transport the unit or to store it when not needed. Display enclosures 711, 712 may also be wirelessly connected. Detachable secondary enclosure 712 may communicate wirelessly with primary enclosure 711 via wireless communication link 707 through wireless communication modules 708 located each within the two display enclosures as shown in FIG. 190 to show file, communicate status information, and receive display information, among others. It may have a stand similar to that shown in FIG. 188 to enable upright orientation of detachable secondary enclosure 712.

FIG. 191 is a front view of detachable secondary enclosure 712 of FIG. 190 as it is about to be mounted to enclosure cradle 715. Detachable secondary enclosure 712 may have an integrated stand enclosure cradle 715 to provide greater stability to support the former in uneven surfaces. Swivel hinge 716, which may pivot or swivel left and right, permits detachable secondary enclosure 712 to be tilted forward and backward to optimize viewing angle. It may pivot backward and forward similar to, for example, the primary enclosure hinge depicted in FIG. 58. Detachable secondary enclosure 712 is inserted or mounted onto swivel hinge 716 as indicated by mounting direction arrow 717 to sit in swivel hinge 716 which has a recess cavity that accepts the width and shape of detachable secondary enclosure 712 in both landscape and portrait orientations.

FIG. 192 is a front view of detachable secondary enclosure 712 of FIG. 191 shown docked to enclosure cradle 715. Enclosures cradle 715 functions as a receiver for network connection such as Ethernet or ESP. It may also function as an AC/DC adapter to supply/recharge batteries of detachable secondary enclosure 712 when the unit is docked. A docking grip is applied so detachable secondary enclosure 712 cannot be separated. Additionally, detachable secondary enclosure 712 may need to be latched or hooked. As secondary enclosure 712 is slotted in enclosure cradle 715, it may be tilted forward and backward or rotated sideways via swivel hinge 716 to adjust secondary display screen 20 to the user's preference. Enclosure cradle 715 may be placed anywhere convenient to the user.

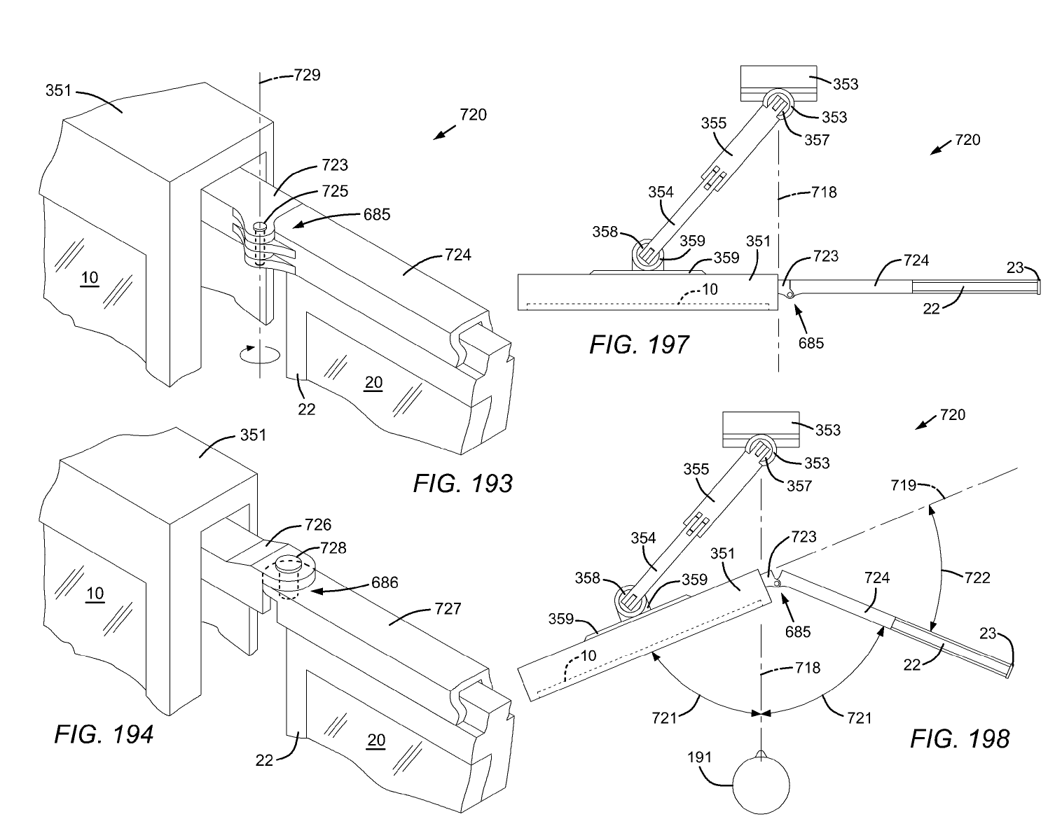

FIG. 193 is a partial isometric view of dual screen apparatus 720 showing a side mounted hinge 685 rotatably connected to first and second slider arm pieces 723, 724 respectively. Shown is secondary enclosure 22 extended out of primary enclosure 351 via first slider arm piece 723 which in turn is connected by a hinge mounted and fixed on the side to second slider arm piece 724. Second slider arm piece 724 holds secondary enclosure 22 and prevents it from becoming detached from the apparatus. The hinge connecting the two slider arm pieces permits secondary enclosure 22 to be pivoted towards the user about hinge Pin pivot axis 729 associated with slider arm hinge pin 725. Corresponding first and second slider arm pieces 723, 724 are also located in the lower slider arm (not shown).

FIG. 194 is a parital isometric view of dual screen apparatus 720 showing a top mounted hinge 686 rotatably connected to first and second slider arm pieces 726, 727 respectively. Slider arm hinge pin 728 functions similarly to that shown in FIG. 193 except that the hinge is mounted on top of first and second slider arm pieces 726, 727 respectively. The hinge permits secondary enclosure 22 to be pivoted forward or backward about slider arm hinge pin 728. Corresponding first and second slider arm pieces 726, 727 are also located in the lower slider arm (not shown).

FIG. 195 is a side view of dual screen apparatus 700 of FIGS. 187-188 as detachable secondary enclosure 702 docks to the back of primary enclosure 701. Detachable secondary enclosure 702 is shown faces the user or the keyboard. It may also be docked facing away from the unit by rotating essentially 180 degrees. Docking cavity 703 receives lower ledge 706 as shown by docking direction arrow. Docking cavity 703 functions as a recharger for the electrical connections, memory, or the portable battery of detachable secondary enclosure 702. As mentioned, additional latches and hooks (not shown) may be used to firmly secure detachable secondary enclosure 702 while in its docking stage.

FIG. 196 is a side view of the detachable secondary enclosure 712 of FIGS. 189-192 shown mounted to enclosure cradle 715. The latter functions as a receiver for network connections or as an AC/DC recharger for the enclosure's internal battery. Also shown are swivel hinge 716 which permits detachable secondary enclosure 712 with two degrees of freedom, and peg 713 which locks detachable secondary enclosure 712 at the back of primary enclosure 711 when in a storage position.

FIG. 197 is a schematic top view of dual screen wall mounted apparatus 720 showing slider arms 723, 724 connected by a side hinge as they extend secondary enclosure 22 in a dual screen mode. Dual screen wall mounted apparatus 720 is similar to that shown in FIG. 96 except that the slider arms in FIG. 197 is comprised of first slider arm piece 723 connected to second slider arm piece 724 via a side hinge as shown in FIG. 193. In the dual screen mode, such as that shown in FIG. 197, both display enclosures 351, 22 face the user and are essentially centered relative to wall bracket 353 and the user's visual orientation direction 718 which permits the user essentially the same angle while viewing the two display enclosures.

FIG. 198 is a schematic top view of dual screen 720 of FIG. 720 as display enclosures 351, 22 are rotated towards the user. Secondary enclosure 22 has been rotated towards the user from its position in FIG. 197 represented by slider arms reference axis 719 essentially along secondary enclosure rotation direction arrow 722. Secondary enclosure 22 may still be further rotated to the user's visual orientation direction 718 along the user's viewing angle 721. Primary enclosure 351 has been rotated towards the user via swivel hinge 358. It may still be further rotated to the user's visual orientation direction 718 along the user's viewing angle 721. In this position, the two display enclosures are angled and essentially centered on either side of the user.

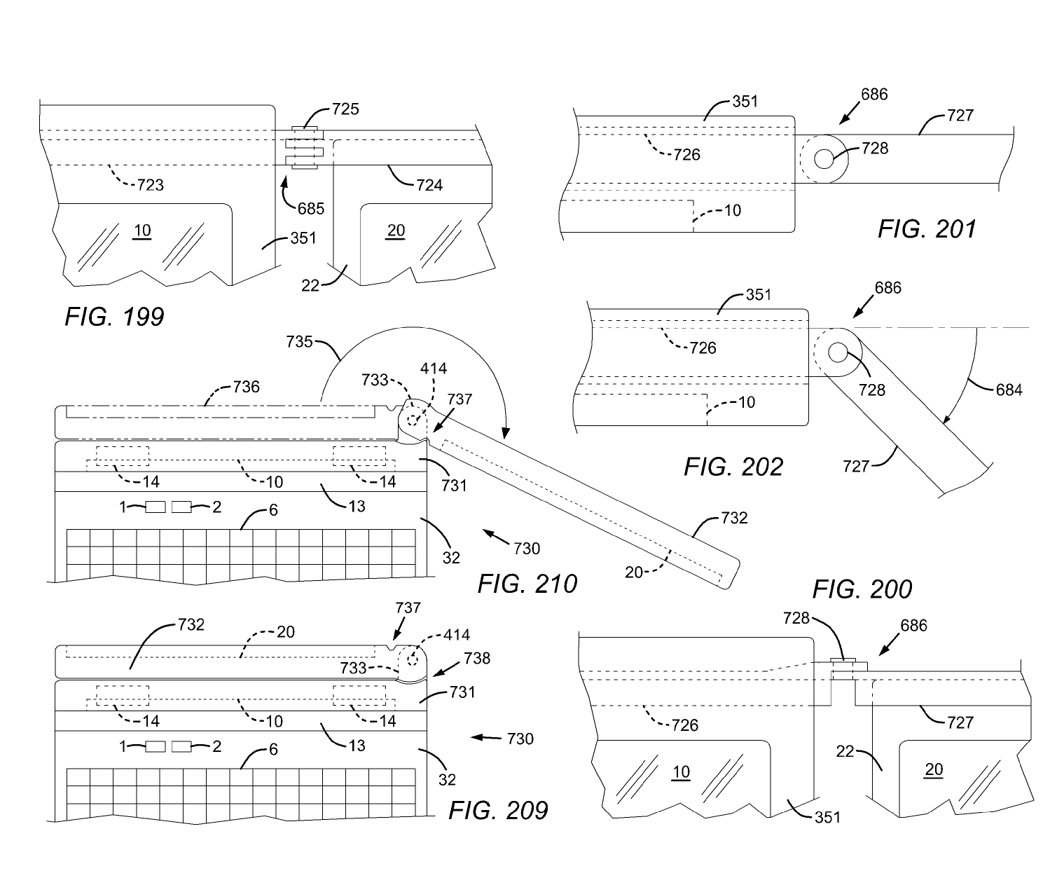

FIG. 199 is a partial front view of the side mounted hinge 685 area shown in FIGS. 193, and 197-198. Second slider arm piece 724 is shown rotatably connected to first slider arm piece 723 via slider arm hinge pin 725. Such an arrangement permits an extended secondary enclosure 22 and its associated display screen 20 to be pivoted toward the user for optimum viewing.

FIG. 200 is a partial front view of the top mounted hinge 686 area shown in FIG. 194. Second slider arm piece 727 is shown rotatably connected to first slider arm piece 726 via slider arm hinge pin 728 which also permits an extended secondary enclosure 22 to be pivoted forward or backward with respect to the user. The end of first slider arm piece 726 is shown overlapping the end of second slider arm piece 727 as they are connected creating an empty space between the two ends.

FIG. 201 is a partial top view of the top mounted hinge 686 shown in FIG. 200. A circular shape is formed that indicates the two circular ends of first slider arm piece 726 and second slider arm piece 727. The circular shapes of the two ends of slider arm pieces 726, 727 allow secondary enclosure 22 to be rotated a wide angle relative to the primary enclosure 351.

FIG. 202 is a partial top view of the top mounted hinge 686 shown in FIG. 201 when secondary enclosure 22 is rotated toward the user for optimum viewing. The rotation of the secondary enclosure 22 about slider arm hinge pin 728 is indicated by secondary enclosure rotation direction arrow 684.

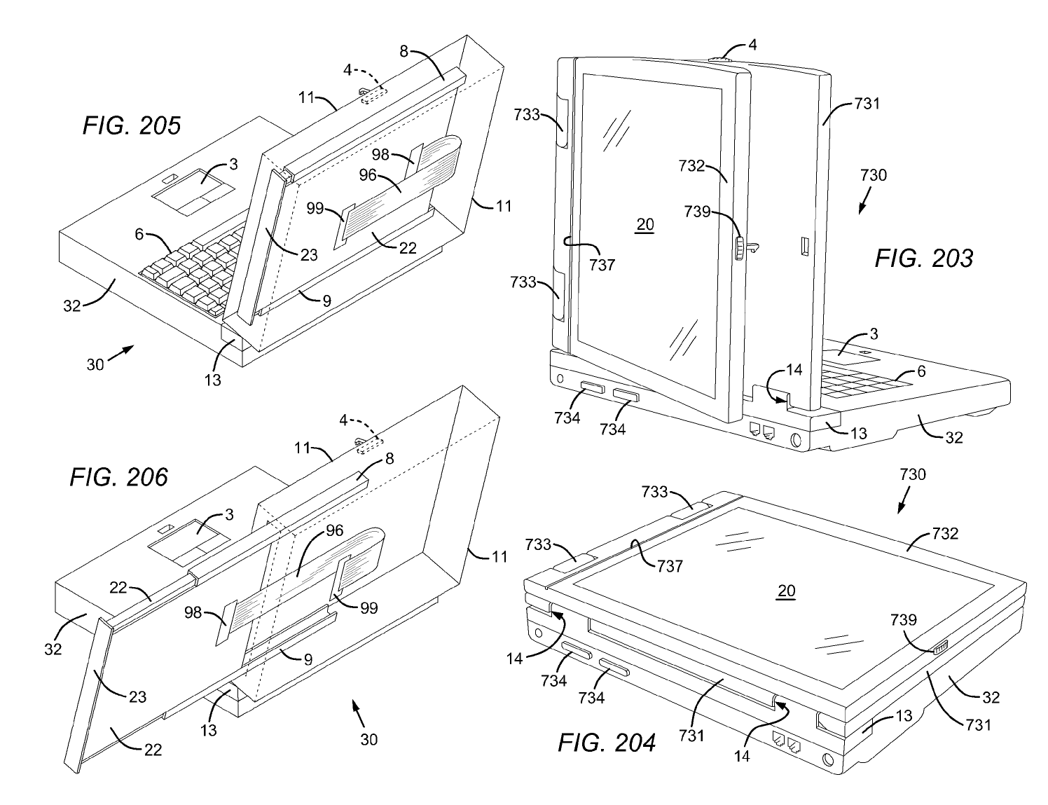

FIGS. 203-204 are perspective views of a dual screen apparatus 730 in a partially open and in a closed position respectively. A top view of dual screen apparatus 730 illustrating the function of secondary enclosure notch 737 is shown in FIGS. 209-210.

FIG. 203 shows a dual screen apparatus 730 having primary enclosure 731 in an upright position and secondary enclosure 732 partially extended from primary enclosure 731. When dual screen apparatus 730 is in single screen mode, secondary enclosure latch 739 secures the secondary enclosure 732 to the rear of the primary enclosure 731. The secondary enclosure 732 hinge arrangement of dual screen apparatus 730 is typical of the second preferred embodiment of the present invention. Video connectors 734 permit external video input to be displayed on the dual screen apparatus or video output from the apparatus to be displayed on an external monitor or made available to a peripheral device such as a video recorder.

FIG. 204 shows dual screen apparatus 730 in a closed position with both the primary and secondary enclosure folded and closed against the base electronics housing 32. If dual screen apparatus 730 is designed to function as a tablet PC, dual screen apparatus 730 may continue to operate in spite of being in a closed position. If this is the case, secondary display screen 20 will be a touch sensitive display screen to accommodate input from a stylus (not shown).

FIGS. 205-206 show an isometric view of an exemplary signal connection means from the base electronics housing 32 to the secondary enclosure 22 of dual screen apparatus 30. FIG. 205 shows the dual screen apparatus 30 of FIGS. 1-11 with its primary enclosure 11 shown in partially hidden outline to reveal the secondary enclosure 22 in its closed or retracted state. In FIG. 205 the dual screen apparatus 30 is in its single screen mode as the secondary enclosure and its associated display screen are retracted within the primary enclosure 11.

A ribbon data cable 96 is used to connect audio, video, power supply, and other data signals to and from the secondary enclosure 22 and its associated secondary display screen 20 (not shown in FIG. 205). Ribbon data cable 96 terminates inconspicuously at the rear of secondary enclosure 22 at secondary enclosure connector 98. The other end of ribbon data cable 96 terminates within the rear of primary enclosure cavity 19 (shown in cross section in FIG. 19) at primary enclosure connector 99. Although the ribbon cable typically terminates within the primary enclosure 11, the video, audio, power supply, and data signals continue from the primary enclosure 11 to the base electronics housing 32 or an external connection. The enclosure connectors 98, 99 are typically connected to a printed circuit board (not shown) or directly to the display electronics 21 (see FIG. 19) associated with the primary or secondary display screens.

FIG. 206 shows the dual screen apparatus 30 of FIGS. 1-11 with its primary enclosure 11 shown in partially hidden outline to reveal the secondary enclosure 22 in its open or extended state. The ribbon data cable 96 has been pulled along as the secondary enclosure connector 98 associated with the secondary enclosure 22 has moved to a position outside the primary enclosure cavity 19. The primary enclosure connector 99 however, has remained stationary with respect to the primary enclosure 11 as it is attached to the rear of the primary enclosure cavity 19 (not shown in FIGS. 205-206).

In FIG. 206 the dual screen apparatus 30 is in its dual screen mode as the secondary enclosure 22 and its associated display screen (not shown) are open or extended from primary enclosure 11 and available for the user to view additional visual content. In FIGS. 205-206, the guiderail assembly and its associated guiderail cover 13 are not extended and they are not required to do so for the dual screen apparatus to be in dual screen mode.

Typically, ribbon data cable 96 is flexible and does not crack or become intermittent as the secondary enclosure 22 is opened and closed repeatedly throughout the life of the apparatus. Furthermore, rather than terminating within the primary enclosure 11 as shown at primary enclosure connector 99, the cable may fold or rotate 90 degrees in a curved manner and proceed down the primary enclosure cavity 19 to the primary enclosure hinge 14 and guiderail assembly 5 area and onto the base electronics housing 32. Thus a reliable signal path to and from the secondary display is ensured.

FIG. 207 shows a partial schematic cross sectional view of a further variation of the guiderail assembly shown in FIG. 31. The guiderail assembly of FIG. 207 comprises guiderail cover 146, slide 147, and rail 148. The rail 148 is fixedly attached to base electronics housing 149 of a typical dual screen apparatus 145. To ensure a smooth back and forth guiderail motion of the slide 147 relative to the rail 148, components such as ball bearings, suspension systems, and anti-friction coatings or sleeves may be used within the guiderail assembly. Such components may be made of metallic, ceramic, or plastic materials such as Teflon™.

FIG. 208 shows a partial schematic cross sectional view of a further variation of the guiderail assembly and primary enclosure area shown in FIG. 37. In FIG. 208, slide 255 is shown encompassing rail 254 above primary enclosure hinge 14. Rail 254 is fixedly attached to second guiderail cover 256 while slide 255 is fixedly attached to first guiderail cover 252. Primary enclosure 251 is pivotably attached to first guiderail cover 252 via primary enclosure swivel hinge 253. Primary enclosure swivel hinge 253 permits primary enclosure 251 and its associated display screen 10 to be pivoted left or right for optimum viewing by the user of typical dual screen apparatus 250.

Typically, power, video signals, and the like are supplied to the hinged primary and secondary enclosures through wire conductors in the form of cable harnesses or ribbon cables. The wires are routed through the primary enclosure hinge 14 to facilitate the operation of the primary and secondary displays, and their associated display electronics 21 if necessary. It should be understood that the video signals and other data signals may also be communicated to the primary and secondary enclosure through other means such as optical means using fiber optic cables, light pipe conduits, waveguides, and the like, or wireless optical or RF means using a variety of wireless frequencies, modulation schemes, and specifications, for example IR, Bluetooth, and wireless USB.

Generally, each of the multiple displays of the present invention receives its video input signal from a video signal source in analog or digital format. This video signal source is typically generated by a multiple monitor video card within the base electronics housing 32, 42 of a typical dual screen apparatus dual screen apparatus 30, 40 respectively. The video signal may also be provided by a source external to the dual screen apparatus and input the apparatus through a suitable video connector typically located at the rear or sides of the multiple monitor apparatus. The video signal may also be provided wirelessly using an optical or RF signal. Furthermore, the apparatus, or one or more of its associated display enclosures, may encapsulate a RF video tuner to receive analog or digital television signal or a 3G video signal. When decoded and processed within the apparatus, the resulting video signal may be input directly to the display screen (or its associated electronics) without further processing by any PC related video card located within the multiple monitor apparatus.

FIGS. 209-210 are top views of a typical dual screen apparatus 730 with a hinge area different from the hinge area shown in FIGS. 110-111 respectively. FIG. 209 shows the secondary enclosure 732 in a closed or retracted position. The secondary enclosure 732 is rotatably attached to the primary enclosure 731 through secondary enclosure hinge 733 and its associated hinge pin 414. Also shown in FIG. 209 is a primary enclosure ridge 738 and a secondary enclosure notch 737 which are the basis of the modified hinge areas of FIGS. 209-210.

FIG. 210 shows the secondary enclosure 732 in an open or extended position. When the secondary enclosure 732 is rotated from its closed phantom line representation 736 to an open or extended position, as indicated by rotation direction arrow 735 in FIG. 210, the secondary enclosure notch 737 receives primary enclosure ridge 738. The use of secondary enclosure notch 737 and primary enclosure ridge 738 permit the secondary enclosure 732 to rotate several more degrees toward the user before the secondary enclosure 732 stops against primary enclosure 731.

A multiple monitor apparatus, typically presented in the form of a dual screen apparatus has been disclosed. In this description, the terms multiple monitor apparatus, multiple monitor display apparatus, dual screen display apparatus, dual screen apparatus, and the like may be used interchangeably. Furthermore, the terms dual screen apparatus may be used to describe a multiple monitor apparatus even in configurations where more than two display screens are present.

As will be apparent to those skilled in the art, the present invention may be embodied in other specific forms and variations without departing from the essential characteristics and true spirit thereof. Accordingly, the foregoing description is intended to be illustrative, but not limiting. The intended scope of the invention may thus include other embodiments that do not differ from the literal language of the claims. The scope of the present invention is accordingly defined as set forth in the following claims.

What is claimed is:

1. A multiple monitor display apparatus comprising a primary enclosure and its associated display screen, a secondary enclosure and its associated display screen, and a guiderail assembly for electively centering said primary enclosure and said secondary enclosure with respect to a user.

2. The multiple monitor display apparatus of claim 1 wherein said secondary enclosure is stored within said primary enclosure in single screen mode.

3. The multiple monitor display apparatus of claim 1 wherein said secondary enclosure extends from said primary enclosure in dual screen mode.

4. The multiple monitor display apparatus of claim 1 wherein said secondary enclosure is secured to said primary enclosure by one or more slider arms.

5. The multiple monitor display apparatus of claim 1 wherein said secondary enclosure is stored adjacent to said primary enclosure in single screen mode.

6. The multiple monitor display apparatus of claim 1 wherein said secondary enclosure is rotated about a secondary enclosure hinge in dual screen mode to face a user.

7. The multiple monitor display apparatus of claim 1 wherein said secondary enclosure and said primary enclosure move along adjacent guiderail assemblies to effect dual screen mode.

8. The multiple monitor display apparatus of claim 1 wherein said guiderail assembly is motorized.

9. A multiple monitor display apparatus comprising a primary enclosure and its associated display screen, a secondary enclosure and its associated display screen, and an enclosure platform assembly for electively centering said primary enclosure and said secondary enclosure with respect to a user.

10. The multiple monitor display apparatus of claim 9 wherein said enclosure platform assembly incorporates pegs, peg holes, or both.

11. The multiple monitor display apparatus of claim 10 wherein said pegs or peg holes provide electricity to said primary enclosure, said secondary enclosure, or both.

12. The multiple monitor display apparatus of claim 9 wherein said primary enclosure and said secondary enclosure receive their respective video signal by optical means, wireless means, or both.
